(19) United States
(12) Patent Application Publication
(10) Pub. No.: US 2009/0018969 A1
(43) Pub. Date: Jan. 15, 2009

(54) Systems and methods for providing investment strategies

(76) Inventors: Ian Ayres, New Haven, CT (US); Barry Nalebuff, New Haven, CT (US)

Correspondence Address: MORGAN LEWIS & BOCKIUS LLP, 1111 PENNSYLVANIA AVENUE NW, WASHINGTON, DC, 20004, US

(21) Appl. No.: 12/157,358

(22) Filed: Jun. 9, 2008

Related U.S. Application Data
(60) Provisional application No. 60/933,749, filed on Jun. 7, 2007.

(51) Int. Cl. G06Q 40/00

(52) U.S. Cl. 705/36 R

(57) ABSTRACT

In one aspect, the invention comprises a computer system comprising: (a) a computer component that receives data identifying a person's investing goals, current savings, and risk tolerance; (b) a database that stores the data identifying a person's investing goals, current savings, and risk tolerance and further stores data describing margin rates, stock returns, and bond returns; (c) a computer component that calculates a utility function and identifies a probability distribution of returns that is most optimal for the person, based on the data identifying the person's investing goals and risk tolerance; and (d) a computer component that calculates one or more investment targets for the person based on application of the utility function to the data describing margin rates, stock returns, and bond returns. Other aspects and embodiments of the invention comprise related methods and software.

### CROSS REFERENCE TO RELATED APPLICATIONS

This application claims priority to U.S. Provisional Patent Application No. 60/933,749, filed Jun. 7, 2007. The entire contents of that provisional application are incorporated herein by reference.

### INTRODUCTION

The typical person invests far too little in stocks when young. Since the young are also liquidity constrained, the only way to invest more is to buy stocks with leverage. While leveraged purchases of stock increase short-term risk, they reduce long-term risk by letting individuals achieve better diversification across time. To reduce retirement savings risk, people should move closer to investing equal dollar amounts in stock each year of their working life. One aspect of the present invention is based on a four-phase life-cycle strategy that allows optimal temporal diversification of retirement investments.

Using stock data going back to 1871, we show that buying stock on margin when young combined with more conservative investments when older stochastically dominates standard investment strategies—both traditional life-cycle investments and 100%-stock investments. The expected retirement wealth is 88% higher compared to life-cycle funds and 68% higher in certainty equivalent terms.

Another aspect comprises leveraged investing using a dollar-target strategy. In one example, the resulting mean, median, 10^{th} percentile, and certainty-equivalent retirement wealth produced by the single dollar-target strategy are all more than double the corresponding results from life-cycle funds and roughly 19% greater than an all-equity portfolio. Applying the 19% improvement, the expected gain from this improved asset allocation would allow workers to increase lifetime consumption by 6.5%, to retire almost six years earlier, or to extend their standard of living during retirement for an additional 27 years.

The typical decision of how to invest retirement savings is fundamentally flawed. This is a result of investors generally following the flawed advice of professionals. The standard (and wrong) advice is to hold stocks roughly in proportion to 110 minus one's age. Thus a twenty-year-old might be 90-10 in stocks versus bonds, while a sixty-year-old would be 50-50. This advice has been automated by life-cycle funds from Fidelity, Vanguard, and others that each year shift the portfolio from stocks into bonds.¹ Our results demonstrate that the early asset allocation is far too conservative. ¹ Both the Fidelity Freedom Funds and Vanguard's Target retirement funds start with 90% in stocks and 10% in bonds and gradually move to a 50-50% allocation at retirement. The initial ramp-down is slow (Vanguard stays at 90% through age 40).

We find that people should be holding much more stock when young. In fact, their allocation should be more than 100% in stocks. In their early working years, people should invest on a leveraged basis in a diversified portfolio of stocks. Over time, they should decrease their leverage and ultimately become unleveraged as they come closer to retirement. The lifetime impact of the misallocation is large. As we explain herein, the expected gain from this improved asset allocation would allow people to retire approximately seven years earlier or to retire at the same age (65) and yet maintain their standard of living through age 99.4 rather than age 85.

The recommendation from the Samuelson (1969) and Merton (1969, 1971) life-cycle investment models is to invest a constant fraction of wealth in stocks. The mistake in translating this theory into practice is that young people invest only a fraction of their current savings, not their expected lifetime savings. For someone in their thirties, investing even 100% of current savings is still likely to be less than 10% of their lifetime savings or less than one sixth of what that person should be holding in equities if their risk aversion led them to invest 60% of their lifetime savings.

In the Samuelson framework, all of a person's wealth for both consumption and saving was assumed to come at the beginning of the person's life. Of course that isn't the situation for a typical worker who starts with almost no savings. Thus, the advice to invest 60% of the present value of future savings in stocks would imply an investment well more than what would be currently available.

Part of our discovery is that investors should buy stocks on margin when young. The way to have more invested in the market when young is to borrow to buy stocks. This is the typical pattern with real estate where the young take out a mortgage and thereby buy a house on margin. We propose that people follow a similar model for equities.

This can be illustrated with a three-period example. Take the case where an individual works for three periods and earns 100, 110, and 121 sequentially. Further assume that the discount rate is 10%. This person has a present discounted value of lifetime wealth equal to $300. Assume further that the risk aversion parameters of the model call for the person to consume at a constant rate, so that the person would consume ⅓ of wealth initially, then ½ of what remains in the second period, and all that remains in the third. Thus, our investor is supposed to invest 200 and consume 100 in period 1. The 100 of consumption completely exhausts all of the liquid wealth. There remains an additional 200 in future earnings, which is effectively all in bonds. If the advice were to place 60% of investments in stocks, our test subject would have to borrow $120 against future income in order to invest that amount in stocks.

Practically speaking, people have limited ability to borrow against their future earnings. But they can buy stock on margin or gain leverage by buying futures contracts. If a young investor with $10,000 in savings and a lifetime wealth of $100,000 were to buy stock on a 2:1 margin, the resulting $20,000 investment would still leave her well short of the desired $60,000 in equities. Buying stocks on 3:1 margin would get her half way there. Both strategies are better than limiting the allocation in stocks to 90% or even 100% of the portfolio.

Another approach to gain leverage is to buy index option contracts that are well in the money. For example, a two-year call option with a strike price of 50 on an index at 100 will cost something close to 50. Thus for $50, the investor can buy exposure to $100 of the index return. The implied cost of such 2:1 leverage is quite low (about 50 basis points above the yield on a one-year Treasury note), which makes the strategy practical in current markets.

This strategy goes against conventional practice, but it is supported by the data. Following this strategy leads to higher returns with lower risks. This is demonstrated both for historical data and for Monte Carlo simulations.

We derive a four-phase allocation strategy with decreasing amounts of leverage in each phase. The core investment strategy in each phase is to invest a constant percentage of the present value of savings in stock, where the percentage is a declining function of risk-aversion. Because of the cost of borrowing on margin, the investment goal during the initial leveraged phases is lower than during the later unleveraged phases.

The success of this four-phase strategy relies on the existence of an equity premium over the margin rate. In our data (going back to 1871), we find that equities returned 9% in real terms, while the real cost of margin was 5%. This 4% premium was the source of the increased returns in our leveraged life-cycle strategy. As Barberis (2000) observes, this equity premium is based on relatively limited data and just one sample path—thus, investors should not count on the equity premium persisting at historical levels. Shiller (2005) goes further to suggest that the U.S. equity performance is unlikely to be repeated.² We show that even with the equity premium reduced by half (or the margin rate increased), there is still a gain from more leverage for the young. ² The high equity premium may also be an artifact of survivorship bias (see Brown, Goetzmann, and Ross (1995)).

Our focus is on investment allocation during working years—on the allocation between stocks and bonds, taking the savings rate as given. For a typical vector of saving contributions, our investment strategy, in various aspects, first-order stochastically dominates the returns of traditional investment strategies.

Of course, borrowing on margin creates a risk that the savings will be entirely lost. That risk is related to the extent of leverage. If portfolios were leveraged 20 to 1, as is done with real estate, this risk would be substantial. We propose a maximum leverage of 2:1, employed at an early stage of life (or, at least, an early stage of one's investing phase). Thus, investors only face the risk of wiping out their current investments when they are still young and will have a chance to rebuild. Present savings might be extinguished, but the present value of future savings is not. Our simulations account for this possibility and even so, we find that the minimum return would have been substantially higher under the strategy that has initially leveraged positions compared to the minimum under traditional investment strategies.

Our recommendation is conservative in that there are features of the market that suggest the person should invest even more in equities when young. To the extent that there is mean reversion or negative correlation over the long run in the market, this will reduce the risk of early investments (which have a longer exposure to the market). This leads us to derive an alternative strategy that turns on a single dollar target (instead of a percentage target). With negative correlation, the dollar target takes some advantage of market timing in that investments rise following a decline and fall after a rise. As a result, dollar targets produce particularly impressive results using our historic data.

The cost of mis-investing one's retirement portfolio when young is not small. Our analysis suggests that if people had followed this advice historically they would have retired with portfolios worth 45% more on average compared to all stock and 122% more when compared to the life-cycle strategy.

The increased returns also have less risk. The margin purchases lead to a first-order stochastic dominant set of returns. For all risk preferences, the results are better. This suggests a general strategy that will lead to better outcomes: whatever savings young people have, they should leverage them up.

However, there are legal, psychological, and economic barriers to taking on leverage. The law prohibits the leveraging of retirement accounts and sharply limits the amount of leverage in stock (relative to the amount of leverage in housing) that can be taken on.

Psychologically, the public thinks of leverage investments as having the goal of short-term speculation instead of long-term diversification. And, until recently, the high margin rates associated with leveraged borrowing made this strategy impractical for most retail customers. While the wholesale interest rate that banks lend to brokers has historically averaged just 20 basis points above corporate bonds, the retail cost of leverage has been prohibitive to small investors. For example, in 2007, Fidelity charged more than 11 percent interest on margin loans below $10,000. But the advent of stock index futures and leveraged mutual funds now allows small investors to create leveraged positions at low cost. We estimate that stock index futures have implicit borrowing rates that average less than half a percent above short-term treasury rates.

Samuelson (1969) and Merton (1969) asserted that the allocation between equities and bonds should be constant over the life cycle, and that the allocation depends only on the degree of risk aversion and the return on equities, not age.

Samuelson was responding to the view that young investors should take more risks because they had more years with which to gamble. This was the “intuition” that supported investment advice such as the “110—Age” rule.

It is easy to become confused about whether an investment when young or old is riskier. An investment when young gets amplified by the returns of all subsequent years. An investment when old multiplies all of the previous returns. This vantage suggests that the two investment periods contribute the same amount of risk towards consumption in retirement.

To see this, consider the two-period allocation problem where zᵢ is the return in period i and λ is the allocation of assets to equities. The investor (i.e., software performing on the investor's data) chooses λ₁ and λ₂ to maximize:

EU[W*(λ₁z₁+(1−λ₁)(1+r))*(λ₂*z₂+(1−λ₂)(1+r))].

Assume that the investor must make both allocation decisions prior to observing the returns.³ In practice, of course, the person observes the first-period returns before making the second-period allocation. ³ While people are able to observe first-period returns prior to making the second-period allocation, they may not take advantage of this flexibility in practice. Employees in a 401(k) plan simply allocate their savings to 80% stocks and 20% bonds, for example, and then don't adjust the allocation based on market performance, except perhaps in the event of a crash or a bubble.

Note the symmetry of the problem. The results of the first period are amplified by what happens in the second period. Thus if we expect that the second-period returns will be 10%, then it is as if the person is taking a 10% bigger gamble in the initial period. At the same time, the investor expects that wealth will be bigger in the second period, also by 10%. Thus the second-period investment is made on a larger wealth base. The investment decisions are symmetric. The investment in each period is amplified by the returns in all of the other periods.

The fact that investors can observe the results of previous investments allows some additional flexibility. However, in the case of constant relative risk aversion, there is no advantage from this extra information. The investor would choose the same allocation for all income levels and thus can make the decision without knowing the initial returns.

Moving outside the world of constant relative risk aversion offers a motivation for changing the equity allocation over time. The later period allocations can respond to changes in wealth. The early allocation might then respond to the fact that later allocations can adjust. This flexibility increases the attractiveness of investing, but whether it increases the marginal attractiveness when young is less clear.

A separate recommendation from the Samuelson model is that investments should be made as a fraction of lifetime wealth. In contrast, the life-cycle funds base investments on current savings, not on lifetime wealth. This is the most significant departure of practice from theory. For young workers, lifetime wealth is likely to be a large multiple of current savings. Thus the only way to follow the Samuelson prescription is to invest using leverage.

In Samuelson, this issue is almost hidden as wealth is given exogenously up front. There is a large literature that considers how to translate future earnings into the initial wealth and the impact that has on current investment; see Bodie, Merton, and Samuelson (1992); Heaton and Lucas (1997); Viceira (2001); Campbell and Viceira (2002); Benzoni, Collin-Dufresne, and Goldstein (2004); and Lynch and Tan (2004).⁴ To the extent that human capital is correlated with equity returns, young workers might already be heavily invested in the equity markets. This also suggests that life-cycle funds should be different by profession, reflecting the different indirect exposure to equities via human capital. ⁴ In our model, we assume that retirement savings are exogenous and thus the only question is what discount rate to use—the margin rate or the bond rate. In the appendix, we show that the solution makes use of a fixed-point argument. Consider how much the person would want to invest when using the lower rate. If the person has that much to invest without leverage, then the lower interest rate is the right choice. Otherwise, this ends up being a target for when the investor has saved enough to reach this point without leverage.

To evaluate an allocation rule, we can look at its historical performance along with the results from Monte Carlo simulation. Poterba, Rauh, Venti, and Wise (2005a,b) (“PRVW”) examine the performance of different portfolio allocation strategies over the life cycle. Their basic finding is that maintaining a constant percentage in equities leads to similar retirement wealth compared to typical life-cycle strategies, holding the average equity allocation constant across strategies. In the empirical section, we compare our results to the equivalent constant percent strategy. Unlike PRVW we find that the leveraged investment strategy leads to substantially lower risk than the equivalent constant-equity percentage strategy. The constant equity percentage (combined with exogenous savings) leads to an investment portfolio that grows something like $100, $200, $300, and more to the extent stock returns are positive. Our leveraged portfolio brings the investor closer to $200, $200, $200 and thus reduces overall risk.

The puzzle is why the traditional life-cycle strategies didn't outperform the constant equity percentage. The answer is that the traditional life-cycle portfolios don't really change their allocation. Although they nominally move from 88% to 30% in the PRVW sample, since invested assets are so low during the early phase, the weighted average of 53% is much like the allocation between ages 50 to 60 when the bulk of savings are made. In contrast, our phased strategy starts at 200%, holds there ten years (see Table 4), and then ramps down to 50%. Our strategy has a range of variation that cannot be replicated with a constant percentage. The equity allocation is designed to counterbalance the size of the savings and this leads to a more even and thus less risky lifetime portfolio.

Shiller (2005) considers a conservative life-cycle strategy, such as might be used for private social security accounts. The allocation to equities starts at 85% and falls down to 15% at retirement age. This is much less exposure to equities than Vanguard and Fidelity life-cycle funds, which only fall to 50% equities at retirement. Shiller finds that investing 100% of current savings in stock throughout working life produces higher expected payoffs and even higher minimum payoffs than his conservative life-cycle strategy.

The prior literature establishes the equivalence of life-cycle to age-invariant asset allocation and the dominance of 100% allocations over a conservative life-cycle fund. Going beyond 100% equities further improves expected utility and that the gain is substantial: a single percentage target strategy yields a 20% increase in expected retirement wealth compared to the 100%-equity strategy and a 84% increase compared to the typical Vanguard or Fidelity life-cycle fund.

Others have recognized the potential value of leverage. Viceira (2001) considers the investment allocation in a model where consumption and investment are both optimally chosen. His approach is based on finding a steady-state allocation. Thus a “young” worker is one who has a small (but constant) chance of retiring each period. The allocation for older workers is the steady-state solution where the retirement probability is increased. The steady-state solution avoids the issue of workers having to build up savings from zero (which is the focus of our results). In Viceira's framework, the margin rate equals the bond rate. In a calibrated example where wages and equities are uncorrelated, he finds that “young” workers with low risk aversion (Constant Relative Risk Aversion (CRRA)=2) will want to invest 292% of their wealth in equities. This falls to 200% when the worker only has an expected 22 years left in the workforce or if risk aversion were to rise to almost 3. When the correlation between wages and equities rises to 25 percent, the young worker's allocation to equities falls by about 13%.

Willen and Kubler (2006) quantify the potential gain from investing retirement savings on a leveraged basis. Using similar parameters, they find that leveraging investment leads to only a 1.2% gain in certainty equivalent. This is with a 2:1 maximum leverage on margin accounts, and a 4% equity premium for stocks over the margin rate. See Willen and Kubler (2006, Table 8).

Willen and Kubler were looking at the present discounted value of lifetime consumption. For comparison, our expected 50% gain in the certainty equivalent of retirement wealth translates into a 6.5% gain in lifetime wealth. The improvement is smaller because the gain is only during the years of retirement and the gains are delayed until the future, which is discounted. Since retirement is only 30% of the lifespan (from the perspective of a 21-year-old), the gain in retirement wealth is much smaller when spread out over the entire life. Taking into account discounting (at 2%) and employing a CRRA=2 leads to an increase in lifetime certainty equivalent of 6.5%.

Our 6.5% gain is five times larger than the estimates of Willen and Kubler. Willen and Kubler emphasize the value of smoothing lifetime consumption. The high cost of borrowing against future income for consumption (10% in their model) means that most people consume too little when young. As a result, their investors do not begin to save for retirement until their early 50s, and this reduced period of investing substantially shrinks the gains from leverage. The timing of equity investments depends on the margin rule; see Willen and Kubler (2006, Table 3). Here, we continue to use the 50% margin requirement.

Whether optimal or not, many people do save when young, even though their present consumption is low relative to the future. They put money into retirement accounts because of tax advantages and employer matches. These savings would do significantly better if leveraged. A second difference is that the 6.5% gain comes from the single-dollar target strategy. This strategy increases investment following a market decline and decreases investment after a rise and thus takes some advantage of the negative correlation in stock returns found in the historical data. For the percentage targets, the gain is 3% in lifetime wealth.

With the dollar-target strategy, the increased retirement wealth could be used to retire approximately seven years earlier. If retirement age is held constant, this expected gain in retirement wealth would allow people to maintain their standard of living for an additional 14.4 years of retirement or to age 99.4 (rather than 85). With the percentage target strategy, the corresponding gains are about half as large.

Willen and Kubler provide an answer to the equity participation puzzle. Given the large historical premium on equities, it would appear that people should hold significantly more equities. Their answer is that due to the high cost of unsecured borrowing to finance consumption, people would do better to consume more rather than save when young. See also Constantinides, Donaldson, and Mehra (2002).

In one aspect, the present invention comprises an automated system for asset allocation that temporally diversifies an investment portfolio. Aspects of the invention comprise computer systems, software, and methods for providing investment advice regarding and/or automatically investing an optimally adjusted portfolio over time.

In at least one aspect, the invention comprises software implementing an investment algorithm that optimally diversifies investment risk across time. In this algorithm, it is optimal for investor to buy stock on margin (i.e., with borrowed money) when they are young. Our software takes into account cost of borrowing and a host of other factors to produce, in at least one embodiment, a four-phase strategy.

The dollar amounts preferably invested in stock can be summarized succinctly: in the first-phase, you invest two times your current savings in stocks; in the second phase, you invest a fixed percentage (called “the leveraged target percentage”) multiplied by the present value of current and future wealth (discounted at the margin rate of interest); in phase three, you invest 100% of current savings in stock; and in phase four, you invest a higher fixed percentage (“the unleveraged target percentage”) multiplied by the present value of current and future wealth (discounted at the risk-free rate).

This 4-phase strategy is depicted in FIG. 1, which illustrates an example in which the leverage target percentage is 40% and the unleveraged target percentage is 70%. The top panel of FIG. 1 displays the proportion of current wealth invested in the stock market. In the first phase, 200% of current wealth (the largest legal amount) is invested in stock. In the second phase, the amount of leverage decreases. In the third phase, the worker invests 100% of current wealth in stocks and in the fourth phase the worker invests less than 100% in stock (and the remainder in government and corporate bonds). The top panel of FIG. 1 shows that like traditional life-cycle strategies, the proportion of current assets invested in clock declines, but ours is believed to be the first strategy that optimally diversifies and the first that starts from a leveraged position.

The bottom panel of FIG. 1 depicts the same phases but as a percentage of the present value of current and future retirement savings. Even with leverage, the worker initially invests only a small proportion of total savings in the stock (because the legal cap keeps the worker from borrowing against most of the savings that come in the future). In phase 2, the worker achieves the initial leveraged percent target. In phase 3 the percent of present and future savings increases (while the worker is investing 100% of present savings in stock). This increase continues until in phase 4 the worker achieves the second, higher percentage target.

The algorithms and software used in certain embodiments provide optimal percentage targets as well as optimal crossover points.

The present invention comprises at least four embodiments, each based on a separate investment strategy.

1. Dual-Percentage Target (Four-Phase) Strategy. This is the strategy briefly described above.

2. Dual-Dollar Target (Four-Phase) Strategy. This is an analogous four-phase strategy where the investor targets investing a fixed present value dollar amount in stock each year. As with the dual percentage target strategy, this strategy has an initial (leveraged) dollar target which is lower than a subsequent (unleveraged) dollar target. Because the targeted amount is expressed in present value, the nominal amount invested in stock rises at a fixed percentage. This strategy is superior to the dual-percent target strategy if one believes that the stock market tends to be mean-reverting.

3. Single-Percentage Target (Three-Phase) Strategy. Under this strategy, the investor strives to invest a constant percentage of the present value of present and future saving contributions in stock. In early years, the worker invests her initial savings on a fully leveraged basis of 200% and remains fully leveraged until doing so would create stock investments exceeding the target percentage amount. From then on the worker invests on a partially leveraged or unleveraged basis. This 3-phase strategy would produce a stylized figure similar to FIG. 1, except there would be no phase 3. If the worker's unleveraged portfolio value exceeds the target percentage, the target amount is invested in stock and the excess amount in government bonds. The percentage of the portfolio that is invested in stock is contingent on the realized returns in prior years as they impact the current portfolio value. A cohort of workers who realize abnormally high (low) stock returns in early years may utilize to more (less) leverage in the future.

4. Single Dollar Target (Three-Phase) Strategy. Under this strategy, the investor seeks to invest a constant present value amount in stock. As discussed above, the nominal target amount rises each year by a fixed rate. This three-phase strategy, like the single percentage target, also has a fully leveraged, a partially leveraged, and an unleveraged phase of investment. But in contrast to the single percentage target, abnormally high (low) stock returns in early years may lead to less (more) leverage in the future. This strategy thus affords a kind of market timing to exploit possible mean-reversion in stock returns. The single target (three phase) strategies arc superior to dual target (four phase) strategies, when the margin interest rate is close to the risk-free rate on government bonds.

Preferably, the algorithms and software in these embodiments accept at least the following investor-related inputs: age, current income, and current net savings, and produce an amount that the investor should invest in stock that year and every succeeding year of his life. The automated investing software implements this advice on an ongoing basis, taking into account subsequent stock market returns and any updated investor information.

In one aspect, the invention comprises a computer system comprising: (a) a computer component that receives data identifying a person's investing goals, current savings, and risk tolerance; (b) a database that stores the data identifying a person's investing goals, current savings, and risk tolerance and further stores data describing margin rates, stock returns, and bond returns; (c) a computer component that calculates a utility function and identifies a probability distribution of returns that is most optimal for the person, based on the data identifying the person's investing goals and risk tolerance; and (d) a computer component that calculates one or more investment targets for the person based on application of the utility function to the data describing margin rates, stock returns, and bond returns.

In various embodiments: (1) the one or more investment targets comprises a percentage target that specifies a proportion of current and future discounted savings contributions that the person should strive to invest in stock; (2) the computer component that calculates one or more investment targets does so based on maximization of the utility function; (3) the computer component that calculates one or more investment targets calculates a low target and a high target; (4) the computer component that calculates one or more investment targets calculates a low percentage target and a high percentage target; (5) the high target is set equal to the low target; (6) at least one of the one or more investment targets is expressed as a dollar amount to be invested in stock after, before, or during a specified period of time; (7) the computer component that calculates one or more investment targets calculates a low dollar target and a high dollar target; (8) the system further comprises a computer component that receives data identifying the person's future saving prospects, and a computer component operable to calculate a present value of current and future savings for the person based on the data identifying the person's future saving prospects and the data identifying the person's current savings; (9) the one or more investment targets comprise four phases; (10) the four phases are as follows: (i) a first phase wherein all liquid wealth of the person is invested at maximum leverage, (ii) a second phase wherein the person deleverages investments from maximum leverage to no leverage, (iii) a third phase wherein all liquid wealth of the person is invested in equities, and (iv) a fourth phase wherein the person maintains investments at an optimal allocation based on the person's wealth and the available risk-free rate of return; (11) the utility function is proportional to

$$\frac{E [ {R}^{1 - γ} ]}{1 - γ} ,$$

where R is resulting blended return and γ is relative risk aversion of the person; (12) at least one of the one or more investment targets is calculated based on minimizing risk while holding expected return constant; (13) least one of the one or more investment targets is calculated based on maximizing certainty equivalent; (14) at least one of the one or more investment targets is calculated based on setting an initial equity percentage target at a lower percentage during periods of leveraged investment than during periods of unleveraged investment; (15) at least one of the one or more investment targets is calculated based on setting an equity percentage target at a constant percentage of discounted savings of the person; (16) at least one of the one or more investment targets is calculated based on maintaining investments on a fully leveraged basis until stock investments exceed the equity percentage target; (17) after the stock investments exceed the equity percentage target, the person is advised to invest on a partially leveraged or unleveraged basis; (18) at least one of the one or more investment targets is calculated based on a constant present value dollar amount of stock investment; (19) the system further comprises: a computer component that receives data identifying the person's future saving prospects; and a computer component operable to calculate a present value of current and future savings for the person based on the data identifying the person's future saving prospects and the data identifying the person's current savings; and (20) the system further comprises a computer component that calculates a dollar amount to be invested during a specified period of time based the multiplicative product of the percentage target and the present value of current and future savings.

In other aspects, the invention comprises methods and software performed by the system aspects described above. Such systems, methods, and software are described in more detail below.

### BRIEF DESCRIPTION OF THE DRAWINGS

FIG. 1 depicts an exemplary embodiment.

FIG. 2 depicts summary statistics for nominal financial returns.

FIGS. 3 and 38 depict flow of savings contributions along with present value of future contributions.

FIG. 4 depicts results of maximization of single-period expected utility.

FIGS. 5 and 39 depict average present value invested in stock.

FIG. 6 depicts distribution of retirement wealth under five investment strategies.

FIG. 7 depicts median length of different investment phases in an embodiment.

FIGS. 8 and 40 illustrate the stochastic dominance of the single-percentage and single-dollar strategies.

FIG. 9 depicts a sign test for the single and dual percentage accumulations.

FIGS. 10 and 41 depict histograms of retirement savings comparing percent and dollar strategies.

FIG. 11 depicts an analysis of margin calls.

FIG. 12 depicts a histogram of the differential in retirement accumulations.

FIG. 13 depicts prevalence of negative monthly returns.

FIG. 14 depicts impact of higher margin caps on leveraged investment strategies.

FIG. 15 depicts implicit margin rate for S&P 500 futures.

FIG. 16 shows impact of increasing the historic margin rates.

FIG. 17 depicts results of reducing nominal annual stock return by various percentage points.

FIG. 18 depicts results of Monte Carlo simulations.

FIG. 19 depicts certainty equivalents for single percent target strategies re-optimized for particular degrees of risk aversion.

FIG. 20 shows that mean, median, and minimum accumulations are substantially higher than 100% stock accumulations in each 20-year period of retirement cohorts.

FIGS. 21 and 22 depict flowcharts showing steps of method embodiments.

FIGS. 23-27 illustrate an exemplary implementation of a single target strategy.

FIGS. 28-37 depict tables related to additional embodiments.

### DETAILED DESCRIPTION OF EXEMPLARY EMBODIMENTS

An exemplary four-phase investment strategy embodiment takes into account margin interest and the fact that investors do not start with all of their wealth upfront. We assume that the investor's utility period function has constant relative risk aversion,

$$U ( x ) = \frac{{x}^{1 - γ}}{1 - γ}$$

(where γ>0 so that the individual is risk averse).⁵ With these preferences, the optimal portfolio choice is independent of wealth. In addition, the optimal allocation can be calculated without knowing the consumption rule, assuming only that consumption is chosen optimally (or independently of retirement savings). ⁵ Note that for γ=1, the utility is defined as U(x)=ln(x).

Most investors do not have all of their wealth upfront and thus may be liquidity constrained when young. For simplicity, future income is assumed to be non-stochastic and that unleveraged equity investment is limited by liquid savings. When investors are using leverage, the relevant forgone interest is the margin rate (as the investor could have paid down the debt); when investors invest without leverage, then the relevant foregone interest is the bond rate.

Consider a two-asset world where the risky asset can be thought of as stocks and the safe asset as bonds. The extension to investing on margin is straightforward. We consider two interest rates: rₘ_{ᵢ}, the real margin rate in period i, and the real risk-free rate, r_{f}_{ᵢ}≦rₘ_{ᵢ}. (We assume that the distribution of real stock and bond returns are independent and identically distributed (i.i.d.) over time and henceforth drop the i subscript.) Associated with each interest rate is a target allocation rate, λ(rₘ) and λ(r_{f}), respectively.

If wealth were allocated all upfront, then only one rate, r_{f}, would be relevant for most investors (as typical risk preferences and market returns lead to equity allocations below 100%). However, most individuals only build up savings over time and thus are liquidity constrained when young. To the extent that they want to invest in equities beyond their liquid savings, this will lead them to evaluate portfolio allocations where the margin rate is the opportunity cost of capital.

Even when leverage is possible, margin coverage will limit the extent of leverage and thus may prevent an investor from reaching her optimal allocation. In that case, it is best to take the maximum leverage possible.

Note that expected utility (EU) is increasing in λ for λ<λ(r). This follows from the general concavity of the maximization problem. Thus if the optimal allocation rule is 64% to equities, the investor does better with 40% than with 30%.

The investor's liquid savings are represented by S, and the person's PDV of future saving contributions is represented by W. The margin collateral rule requires that the investor put up $m of collateral for each dollar of equity. Thus the person with S of liquid assets is limited to buying S/m dollars of equities.

We assume that S is initially zero. The investor starts out with no savings. Savings are built up from the 4% of income that is allocated to savings each period. Thus, initially, the investor will be constrained by the margin rule. The person will invest the maximum possible, S/m.

Over time, the investor will build up savings so that more of the person's wealth is liquid. At some point, the person will be able to reach the desired level allocation of wealth into equities. This is first done from a leveraged position and then done with diminished leverage as liquid assets continue to grow.

For example, under the historical returns (assuming CRRA=2), the optimal single period allocation is 88% to equities and 12% to bonds. Thus the investor works to build up to the point where 88% of S+W, his combined liquid savings plus the present value of future earnings, is invested in equities. This will be possible once 0.88*(S+W)<S/m.

This investment strategy is the translation of Samuelson and Merton, but it is no longer optimal in our framework. The reason is that the utility function is no longer multiplicative in wealth. Specifically, the margin constraint is not multiplicative in S+W. If the person's total wealth is doubled, but the liquid assets remain constant, then the person will not be able to double her investment in equities. Another way of seeing this is that if the stock return is very negative, the person may end up liquidity constrained in the next period. Thus the investment choice tomorrow is no longer independent of the decision made today.

When there are two interest rates, one for lending (r_{f}) and one for borrowing on margin (rₘ), our investment rule becomes a 4-phase path. Initially, the investor would like to be at λ(rₘ), but is unable to reach this allocation due to limits on the maximum leverage ratio. Thus the investor employs maximum leverage until λ(rₘ) is achieved (phase 1). The investor then deleverages her position while maintaining the λ(rₘ) allocation (phase 2). Once fully deleveraged, the new target is λ(r_{f}). The investor allocates all of her available wealth in equities until this target is reached (phase 3). Finally, the investor maintains the λ(r_{f}) allocation, adjusting the portfolio based on changes in wealth. There is a closed-form solution to the optimal equity allocation.

As we explain in greater detail in the appendix below, under constant relative risk aversion, a constant investment opportunity set, and a constraint on leverage, the optimal equity allocation used in at least one embodiment comprises four phases:

In phase 1: λ<λ(rₘ). All liquid wealth is invested at maximum leverage.

In phase 2: λ=λ(rₘ). The investor deleverages until λ=λ(rₘ) is achieved without leverage.

In phase 3: λ(rₘ)<λ<λ(r_{f}). The investor puts all liquid wealth into equities.

In phase 4: λ=λ(r_{f}). The investor maintains the optimal Samuelson-Merton allocation.

One complication lies in accounting for margin loans and leverage constraints and then determining the appropriate interest rate to use in discounting future income. The discount rate determines both the current value of wealth (S+W), and the leverage target. The product of these two variables in turn determines the amount to invest in equities, which determines whether the investor is liquidity constrained or not.

This 4-phase strategy has the advantage that it is characterized by just two percentage targets, λ(rₘ) and λ(r_{f}). Furthermore, an investor can get started on the optimal path even without knowing the initial target. A young investor who starts with little liquid assets will take several years to reach the first target, even when investing all liquid assets fully leveraged. In our simulations, we find that a person who saves 4% of her income will generally reach the first target at somewhere between ages 28 and 38 (95% confidence interval; see Table 4, depicted in FIG. 7). Thus she can start down the optimal path even without knowing the destination.

In our simulations, we have explored the consequences of applying different parameters for each of these goals. The goals will vary with changes in the real interest rate, the margin premium, and the equity premium. In our simulations, we held these parameters constant over the investor's life.

The level of the margin rate relative to the risk-free rate and the expected stock return has a large impact on the optimal investment strategy. If the margin rate equals the risk-free rate (i.e., if investors could borrow at the risk-free rate), λ(rₘ)=λ(r_{f}) and the third phase vanishes. Investors maintain a constant percentage of wealth in stocks as soon as λ(rₘ) is reached. This single-target, three-phase strategy is relevant because, as an empirical matter, current margin rates are close to the risk-free rates and thus the two targets are also close. The simpler three-phase strategy performs almost as well as the four-phase approach and well enough to dominate life-cycle portfolio allocations as well as 100% equities.

To calculate the optimal consumption amount in each period would be an even more complicated problem. But our interest is in the optimal investment allocation. Given that consumption is chosen optimally, then the allocation of assets between stocks and bonds does not depend on the level of wealth (and hence doesn't depend on the amount of savings left over after consumption) and only depends on the relevant interest rate and the share of wealth that is liquid.

Extension to Exogenous Saving Contributions

The Samuelson framework was developed in a context where consumption was chosen optimally in each period. We can equally well apply this framework to a model where consumption is exogenously chosen during worklife and the individual is saving for retirement. All of the portfolio risk is shifted to the retirement phase, so that consumption during retirement varies with the portfolio returns. While this is not optimal risk allocation, the assumptions exogenous consumption during worklife may fit the stylized facts for many workers with 401(k) plans. In these plans, the individual simply puts aside a certain fraction of her salary. While that fraction can be adjusted up or down depending on historical market returns, such adjustments are rare. Thus the worker doesn't adjust the allocation between current consumption and retirement consumption based on returns.

The four-phase strategy remains essentially the same, except that the consumption decisions, cᵢ, and hence savings decisions are now exogenously given. Thus the relevant wealth to invest is the value of the current portfolio plus the discounted sum of all future savings. The goal is to maximize the expected utility of consumption during retirement. The returns enter multiplicatively and thus with constant relative risk aversion, the optimal portfolio allocation depends only on the relevant interest rate and not prior returns.

The timing of the four phases may differ based on realized returns, but the two targets and the basic four phases remain unchanged. It is this model of exogenous saving contributions that formed the basis of our core simulations.

Data and Methods

We simulated the returns from alternative investment strategies using long-term historical market data covering the years 1871-2004 collected by Robert Shiller (see Shiller (1989, 2005a,b) and updated through 2006 using Global Financial Data. In order to include the returns to leveraged investment strategies, we add historical data on margin rates to the Shiller tables. For 1871-1970 margin rates, we use the “call money rates.” For 1971-2006, we use the Federal Reserves “prime loan rate.” See also Global Financial Data. The call money rate (also called the “broker call rate”) is the interest rate that banks charge to brokers to finance margin loans to investors.

For most of the analysis, we assume that the maximum leverage on stocks is 2:1, pursuant to Federal Reserve Regulation T. The law independently limits the ability of individuals to invest savings on a leveraged basis. Mutual funds offered inside and outside of defined contribution plans are limited in their ability to purchase stock on margin. Under the Investment Company Act, mutual funds registered as investment companies are prohibited to purchase “any security on margin, except such short-term credits as are necessary for the clearance of transactions.” See 15 U.S.C. § 801-12(a)(1).

For the margin rates, we use the broker “call money” rates.⁶ This assumption may be controversial because many major brokers currently charge margin rates that are substantially higher than the current call money rate. For example, in May 2006, low-cost brokers such as Vanguard and Fidelity charged margin rates of more than 9.5% on small-balance margin loans, a rate that far exceeds their cost of funds.⁷ The markups are independent of the degree of leverage and are instead tailored to the amount of the loan with substantial premiums for loans under $25,000. The corresponding margin rate at E*trade for loans over $1,000,000 was 6.74%, and Fidelity offered its active investors a rate of 5.5% on loans balances over $500,000. ⁶ According to Fortune (2000), the broker call money rate is commonly used as the base lending rate. See Global Financial Data monthly series for the call money rate series.⁷ Rates are as of May 1, 2006.

However, stock derivatives have allowed investors to take on the equivalent of leveraged positions at implicit interest rates that are below the call money rate. Index futures, for example, are a more cost-effective means for most investors to take on a leveraged position. By placing 8% down as a non-interest bearing performance bond, an investor can purchase exposure to the non-dividend returns of all the major stock indexes.

The standard equation relating the forward price to the spot price is F=Se^{rT}−d, where F is the forward price to be paid at time T, S is the spot price, d is any dividend of the underlying stocks, and r is the risk-free interest rate. Using this equation (and accounting for the lost interest on the 8% performance bond), it is possible to back out an estimate of the implicit interest rate for constructing a leveraged position via stock index futures. Using forward and spot market data from 2000-2005, the implicit margin rate for the S&P 500 futures has averaged only 4.08%.⁸ The implicit cost of borrowing is just 94 basis points above the average 1-month LIBOR rate for the same time period and is 174 basis points below the margin rates for the same time periods used in our simulations. This is an underestimate in that we have not increased the performance bond as would be required when stocks fall. Doubling the performance bond to 16% would increase the implied margin cost to 4.56%—still well below the call money rate at the time. ⁸ The implicit interest rate may also be understated because owners of future indexes are subjected to less favorable tax treatment than owners of leveraged stock. Capital gains on future contracts are realized quarterly while realizations on stock investments may be deferred until a stock sale. IRS rules mitigate this difference by allowing holders of future contracts to attribute 60% of income as long-term gains and 40% as short-term gains.

The UltraBull mutual fund employs a combination of options and futures to provide investors with twice the returns of the S&P 500 (i.e., a beta of 2). We calculate the implied margin rate as the difference between twice the return on the S&P and the return on the UltraBull fund. For example, between Sep. 3, 2002 and Aug. 20, 2003, the S&P returned 13.93% while the UltraBull returned 22.89%; thus the implicit margin cost is 4.97%, the difference between double the S&P (27.86%) and the UltraBull return. Similarly, from Jan. 3, 2001 to Dec. 25, 2001, the S&P lost 15.06% while the UltraBull lost 34.99%, leading to an implied margin cost of 4.87%. Using returns data between 2000 through 2003, we find that the implicit interest is 5.09% or 1.6% above LIBOR, which is substantially cheaper than the rates offered by most retail brokers.

At present, the simplest and least expensive route to obtain leverage is via the purchase of deep-in-the-money LEAP call options. For example, on Jul. 6, 2005, when the S&P 500 Index was trading at $1,194.94, a one-year LEAP call option on the S&P index with a strike price of $600 was priced at $596.40. This contract provides almost 2:1 leverage. It allows the investor, in effect, to borrow $598.54 (as this is the savings compared to buying the actual S&P index). At the end of the contract, the investor has to pay $600 to exercise the contract. Compared to buying an S&P mutual fund, the index holder will have also sacrificed $22.44 in foregone dividends (for holding the index rather than the stocks). Thus the true cost of buying the index is $622.44. The total cost of paying $622.44 almost a year after borrowing $598.54 produces an implied interest of 3.78% which is 25 basis points over the contemporaneous one-year yield on a Treasury note.

We find that the implied interest for deep-in-the-money call options that produce effective leverage between 200 and 300% averaged less than one percent above the contemporaneous 1-year Treasury note. Moreover, the implicit interest rate on these calls was 160 basis points below the average contemporaneous call money rate. LEAPs also have the advantage that there is no potential for a margin call.

Given the low cost of leverage and the absence of margin calls, it might appear that young investors should consider taking on even greater amounts of leverage. However, the implied interest increases with the degree of leverage. The implied marginal interest rate associated with additional leverage rapidly approaches (and then exceeds) the return on equity.⁹ The marginal interest rate associated with the incremental borrowing required to move from 3:1 to 4:1 leverage is 6.6% and substantially higher than the 4.02% implied interest at 2:1 leverage and below. The marginal cost of increasing leverage rises sufficiently fast that it is unlikely that it would be cost effective to invest at leverage of more than 3:1 via option contracts. ⁹ The marginal interest rate=(New Borrowing Amount*New Implied Interest Rate−Old Borrowing Amount*Old Implied Interest Rate)/(New Borrowing Amount−Old Borrowing Amount). Consider the move from 3:1 to 4:1 leverage. With 3:1 leverage, the investor puts up $1,000 and borrows $2,000 at a cost of 1.761% over the Treasury rate (assumed to be 4%) for a cost of $15.2. With 4:1 leverage, the investor puts up $1,000 and borrows $3,000 at a cost of 2.727% over Treasury or $201.8. Thus the marginal interest cost to borrow the additional $1,000 is ($201.8-$115.2)=$86.6 or 8.66%.

The more important lesson is that the derivative markets have made it inexpensive to invest 200% or even 300% of current saving accumulations in the stock market. Whether or not investors had ready access to the broker call money rate in the past, our assumption of low-cost money going forward is particularly reasonable given the advent of options to implicitly borrow through derivative markets.

Table 1 (depicted in FIG. 2) shows summary statistics for the nominal financial returns. Stocks over this period had an average nominal return of 9 percent. The maximum positive return was 54.9% in 1933 shortly after the maximum negative return of −42.9% in 1931. Note that our simulations have been based on real returns and real interest rates. However, when we considered the potential impact of margin calls, we employed nominal returns, since margin calls depend on the nominal change in equity prices.

Using Shiller's data on stock and bond returns from 1871-2004, updated to 2006, we construct 93 separate draws of a worker's 44-year experience in the markets. Each of the draws represents a cohort of workers who are assumed to begin to work at age 21 and retire at 65. For example, the first cohort relates to workers born in 1850 who start to work in 1871 and retire in 1914.

To perform the simulations, we take a representative worker and imagine that individual has an equal chance of experiencing any of the 93 different return histories. (Later, we also allow the worker to randomly experience returns from any 44 years out of the 136 in our total sample.) We assumed that workers save a fixed percentage of their income. In our simulations, we use 4%. Thus the saving accumulations depend only on the history of 4% contributions and prior-year returns.

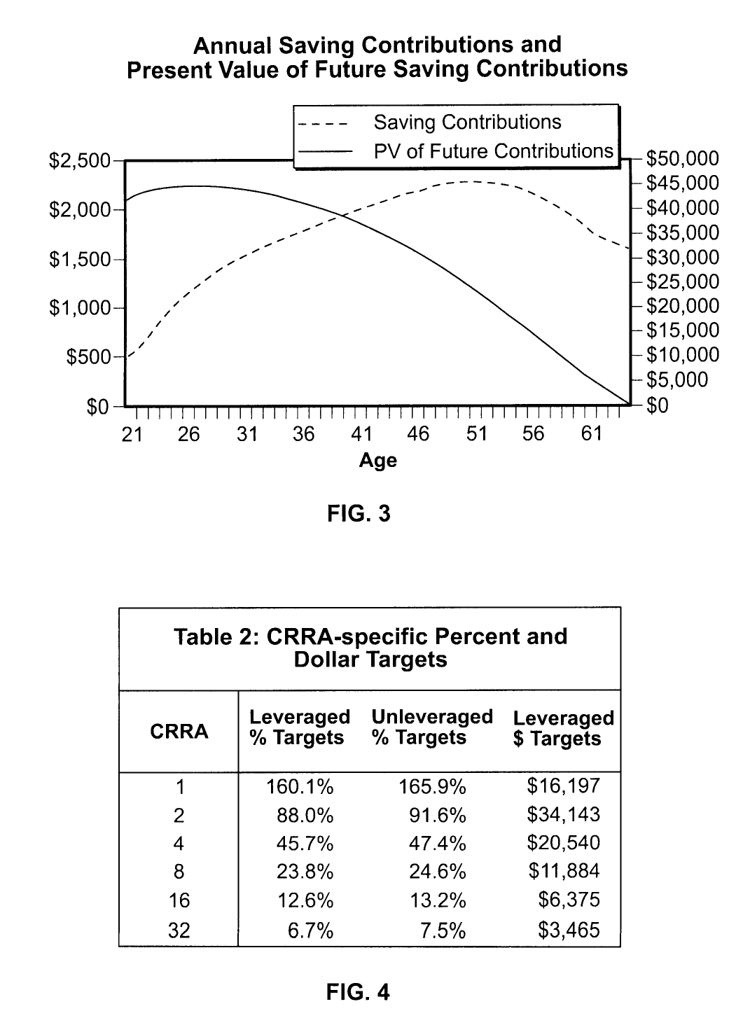

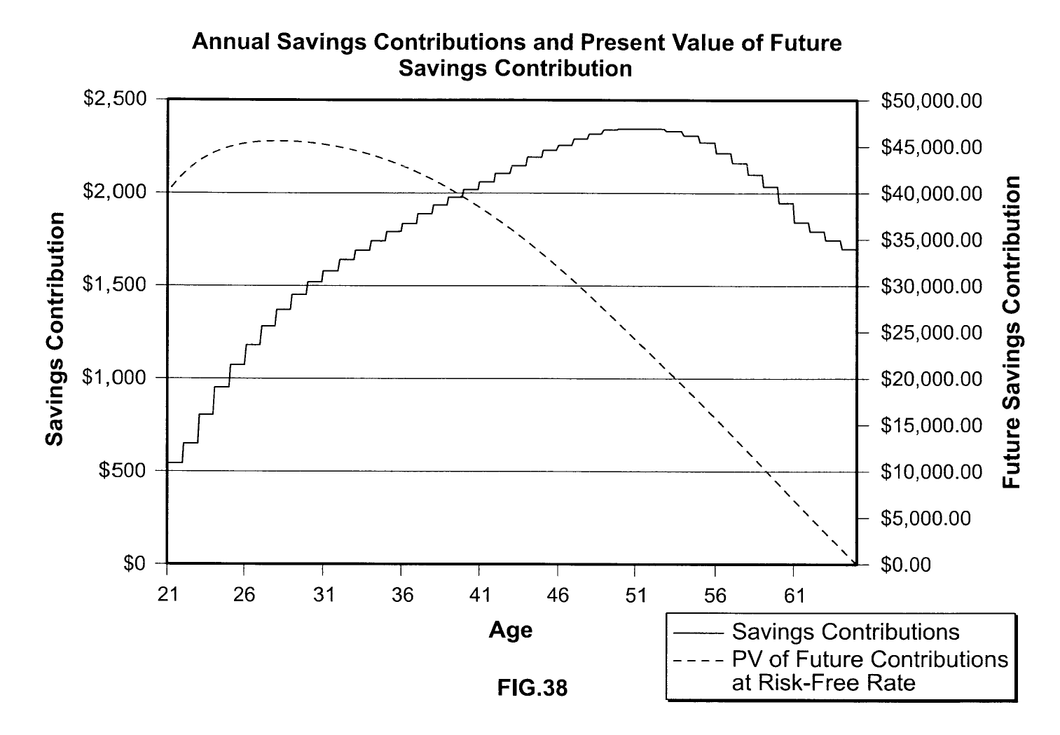

Although the percent is constant, the actual contributions depend on the wage profile. We assume a hump-shaped vector of annual earnings taken from the Social Security Administration's “scaled medium earner.” Wages rise to a maximum of $58,782 at age 51 and then fall off in succeeding years.¹⁰ For a new worker at age 21, the future saving stream has a present value of $44,837 (when discounted at a real risk-free rate of 2.7%). The humped flow of savings contributions along with the present value of future contributions are shown in FIG. 3 (see also FIG. 38). Given this flow of saving contributions, the simulation assesses how different investment strategies fare in producing retirement wealth. In performing these calculations, we assume an annual administration/transaction fees equal to 30 basis points of the net portfolio value. ¹⁰ See Shiller (2005a), Clingman and Nichols (2004).

Using Simulations to Complete the Model

To complete the model, we need to derive the percentage targets for specific levels of constant relative risk aversion (γ). To do this, we first find the dual-percentage targets—a leveraged (λₐ) and unleveraged (λ_{b})—that maximize single-period expected utility using the sample 136 returns as the actual distribution of returns.

Because the utility function is multiplicative in returns, maximizing single-period expected utility is equivalent to choosing the equity allocation to maximize

$$\frac{E [ {R}^{1 - γ} ]}{1 - γ} ,$$

where R is the resulting blended return. In the case of the leveraged target, we use the margin rate as the opportunity cost of capital; in the case of the unleveraged target, we use the bond rate. The general formula for R is provided in the appendix, Equation 1. The equity allocations preferably are selected to maximize single-period expected utilities according to the historical distribution of returns.

The results from this maximization are shown in Table 2, depicted in FIG. 4. For CRRA=2, the optimal leveraged and unleveraged percentage targets are 88.0% and 91.6% respectively. These percentages form the core example that we evaluate in our simulation of the dual-percentage strategy.

While we expect the unleveraged percentage target to be higher than the leveraged percentage, these two percentage targets are very close. This is because, as shown in Table 1/FIG. 2, the average margin rate in our data is only slightly higher than the average risk-free rate, 5 percent versus 4.8 percent. This leads us to evaluate a single-target (three-phase) strategy, which invests a constant 88.0% of wealth, subject only to maximum leverage constraints.

In addition to the percentage targets, we calculate a single-dollar present value that is meant to be analogous to the single-percent counterpart. Instead of aiming to invest 88% of wealth in equities, the person tries to reach a dollar total. Just as total investments grow with wealth, we have the target grow with the expected portfolio return.

The dollar target strategy is of interest because it provides a rule of thumb for adapting a percentage target to a world with negative correlation in stock returns. If stock returns are mean reverting, investors should engage in market timing. But there are not well-accepted investment rules that trade off temporal diversification with market timing goals. The dollar target strategy does just this. The dollar and percentage strategies respond differently to an unexpected negative return. The percentage strategy responds by reducing the absolute dollar amount invested in stock the subsequent year. Because a negative return reduces the investor's wealth, the investment next year will fall. To the extent that market fall reduces liquid wealth to the point of creating a liquidity constraint, investment will fall even more as now the investor will use the margin rate as the opportunity cost.

The dollar-target strategy, in contrast, responds to a fall in the stock market by increasing the amount invested in stocks the next year, as the constant present value increases nominally at the rate of the expected portfolio return. The dollar-target strategy responds to an unexpected low (high) stock return by increasing (decreasing) leverage-which is one way to try to capitalize on mean reversion.

To find the dollar target, we looked across the 93 cohorts to find the average current savings at the point where the investor just achieved the 88% target without leverage. The present value of this amount is $34,143.¹¹ We use this amount as our core example of a single-dollar target strategy. ¹¹ The discount rate used is 6.3%, which equals the expected return on a portfolio that is 88% stock and 12% bonds.

Our simulations compare three different temporally diversified strategies to traditional investment strategies. Specifically, our simulations compare:
1. Dual-Percentage Target (Four-Phase) Strategy. This strategy sets the initial equity percentage target at a lower percentage (88.0%) during the first and second phases of leveraged investment and at a higher percentage (91.6%) for the third and fourth phases of unleveraged investments.
2. Single-Percentage Target (Three-Phase) Strategy. This strategy sets the equity percentage target at a constant percentage (88.0%) of discounted savings. Initially, the worker invests her entire liquid savings on a fully leveraged basis of 200% and remains fully leveraged until doing so would create stock investments exceeding the target percentage. From then on the worker invests on a partially leveraged or unleveraged basis. If the unleveraged portfolio value exceeds the target percentage, then stocks are sold and the excess amount is invested in government bonds. The percent of the portfolio invested in stock is contingent on the prior year' realized returns as this impacts the current portfolio value.
3. Single Dollar Target (Three-Phase) Strategy. Under this strategy, the investor seeks to invest a constant present value amount in stock of $34,143. As discussed above, the target amount rises each year by the blended interest rate of 6.3%. This three-phase strategy, like the single percentage target, also has a fully leveraged, a partially leveraged, and an unleveraged phase of investment. Because this strategy seeks to maintain a constant (discounted) exposure to the market, assets are bought following a decline and sold following a run up, which creates a kind of market timing that exploits possible mean-reversion in stock returns.
4. 100% Stock. Under this benchmark strategy, the worker invests a constant 100% of her liquid savings in stock.
5. 90%/50% Life-Cycle. Under this benchmark strategy (based on the Fidelity Freedom fund allocation) the worker invests 90% of portfolio value in stock at age 21 and the percentage invested in stock falls slowly to 82% by age 44 and then falls more rapidly to 50% by age 65.

Results of the Cohort Simulation

a. Deviations from Optimal Diversification

From a diversification perspective, there are two problems with traditional investment strategies. The front-end problem is that the strategies don't expose the worker to sufficient stock market risk—thus throwing away the potential for additional years of diversification. The back-end problem is that strategies tend to expose the worker to either too much risk (when using the 100% rule) or too little market risk (when using the 90/50 rule).

To provide some heuristic evidence about the size of the front-end and back-end failures to diversify, we estimate the average amount invested in stock for the benchmark strategies. A temporally diversified strategy would maintain a constant percent of retirement wealth in equities. Since retirement wealth grows at the blended return, if all wealth were available upfront, we would also expect to see equity investments growing at the blended return rate, here 6.28% assuming that CRRA=2. Of course, the optimal temporal diversification will also depend on liquidity constraints, the cost of margin borrowing and on the realized returns in prior years.

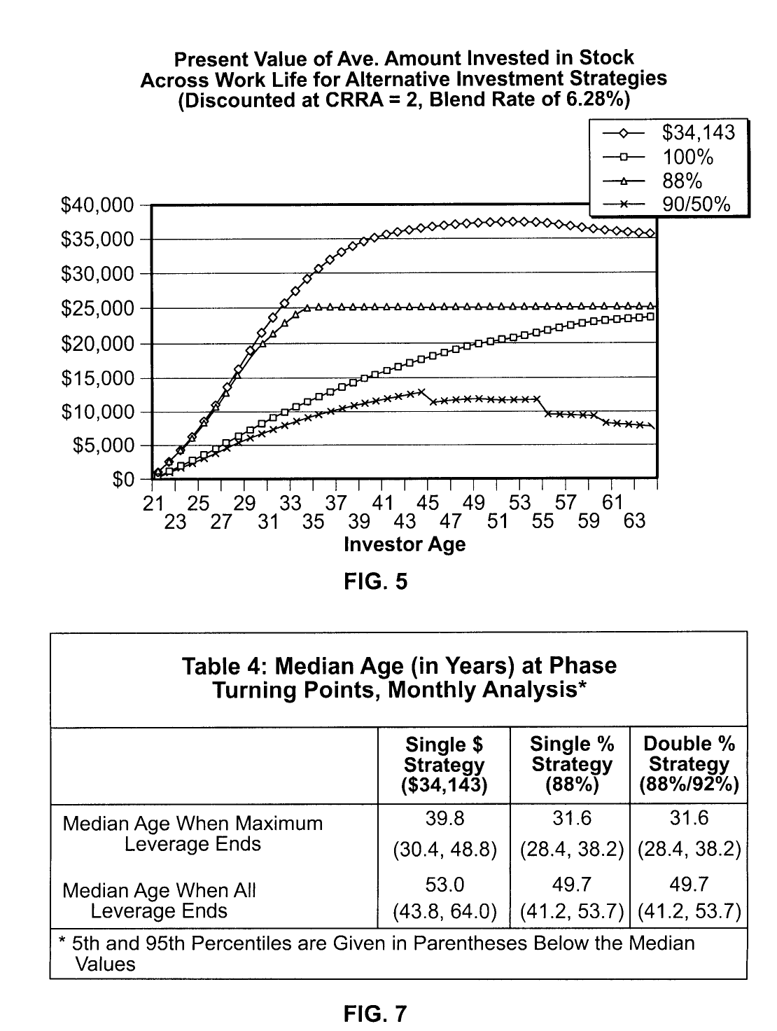

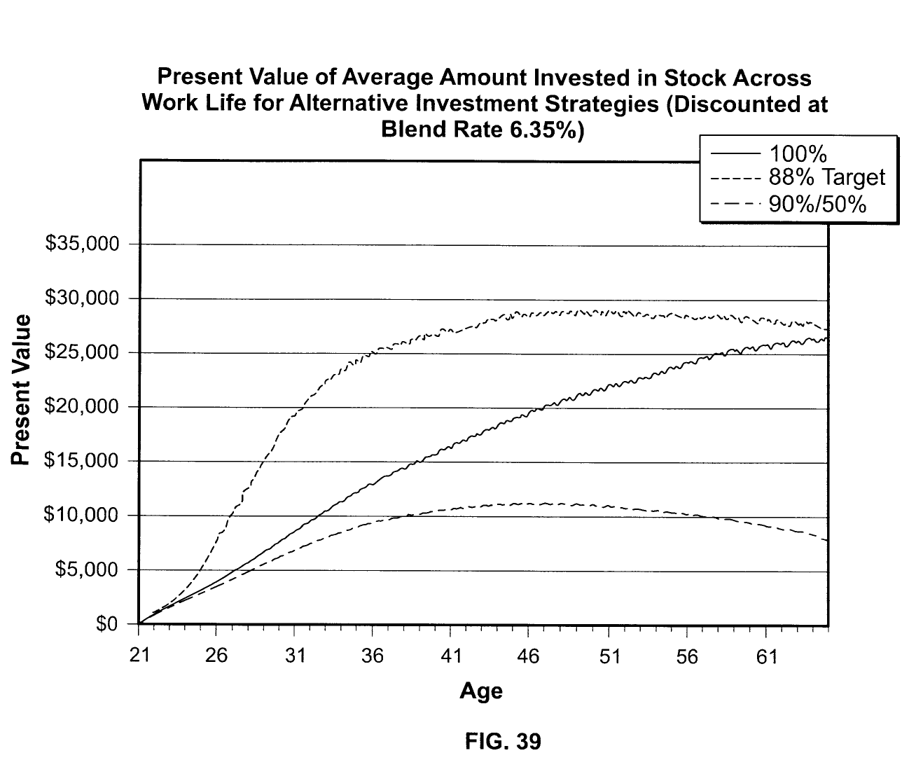

FIG. 5 shows for the 93 worker cohorts the average present value invested in stock in each year of the investor's working years (also see FIG. 39)

Both the 90/50 and the 100% strategies fail to invest substantial amounts in stock in the first 25% of the investor's working life—effectively discarding these years as a means to diversify stock market risk. The leveraged diversification strategies respond directly to this problem by investing more in stock and thus putting the initial investor on a much steeper slope of investments. The back-end problems are even more pronounced. The 100% investment has the expected result of exponentially increasing the amounts invested in stock so that the returns in just the few final years will disproportionately impact the investors' retirement wealth.

The 90/50 life-cycle exhibits the alternative back-end problem of not investing enough in stock in the last working years. Overall, the 90/50 strategy achieves a relatively flat real exposure to the market from age 45 onwards. This is done at a cost of too little overall exposure. The life-cycle fund only has a 65% average exposure to the market. Our two target strategies achieve a little over 100% exposure, but mitigate risk by achieving better diversification across time.¹² ¹² The initial 200% exposure which ramps down to 88% still averages 100% because of the greater size of the portfolio in later years.

We also can assess the extent of diversification by measuring the concentration of each strategy's exposure to stock market risk. The reciprocal of the Herfindahl-Hirshman Index (HHI) is a heuristic measure of the effective number of diversification years. Just as the inverse of the HHI in antitrust indicates the effective number of equally-sized investors in an industry (Ayres (1989)), the inverse of the HHI here indicates the amount of diversification that could be achieved by investing an equal dollar amount in separate years. HHI estimates indicate that the average worker using the 100%-investment rule effectively takes advantage of only about 27.8 of her 44 investment years (63.3%). In contrast, the single dollar target strategy effectively takes advantage of 31.7 investment years (72.1%) and the single percentage target strategy takes advantage of 33.1 years (75.2%). As seen in FIG. 5, under the 90/50 rule, the worker's exposure to stock market risk is more evenly distributed across years—and the inverse HHI in turn increases to 33.9 years (77.7%). But this increase in effective diversification is achieved by generally limiting exposure to the stock market. Investing nothing in stocks each year also would be fully diversified.

b. Comparing the Five Investment Strategies

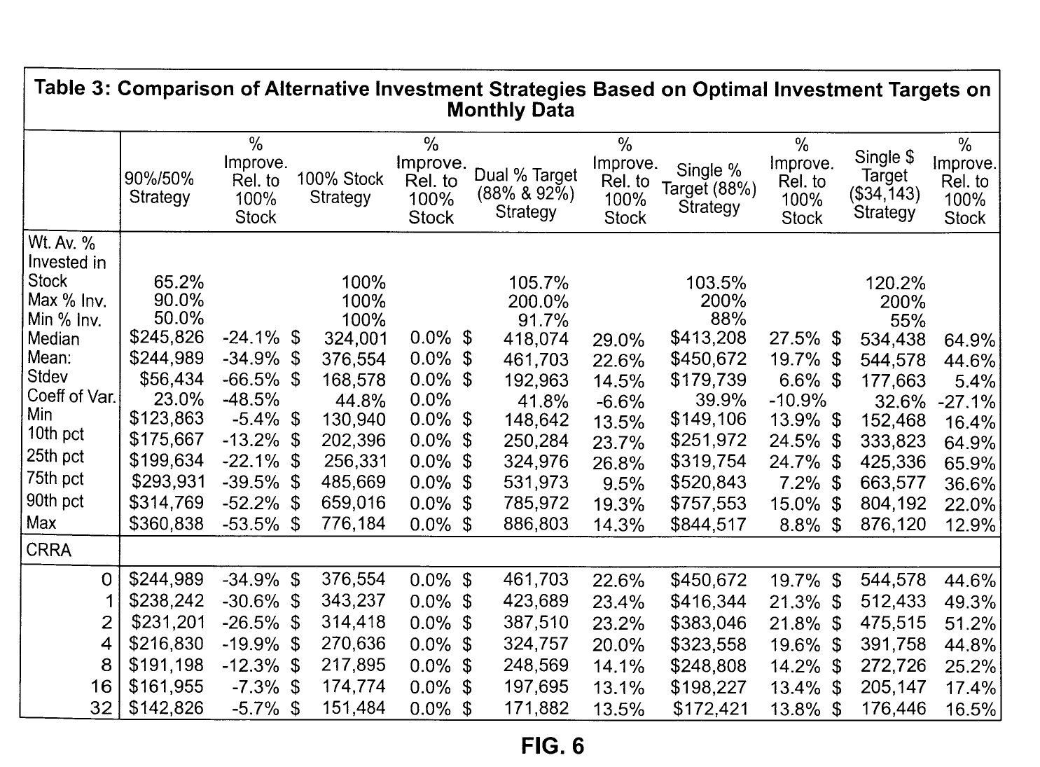

Table 3 (depicted in FIG. 6) shows core results of an embodiment. In it, one can see the distribution of retirement wealth for the 93 worker cohorts under the five investment strategies. The first two columns replicate the basic findings of Shiller (2005a) and PRVW (2005) in showing that a simple strategy of investing 100% of accumulated savings in stock dominates the life-cycle strategy of investing 90% in stock when young ramping down to 50% at 65. Average retirement wealth among the 93 cohorts is more than 53% larger with the 100% strategy ($376,554) than with the 90%/50% strategy ($244,989) and the certainty-equivalent dollar amounts are uniformly higher for all reasonable relative risk aversion measures.

The surprise is how well the leveraged strategies fare relative to the 100% strategy. The dual-percentage targets produce a median retirement wealth that is 29% higher than the 100%-stock strategy and an increase in the mean return of 22.6%.¹³ ¹³ Workers using this strategy would not immediately invest the targeted amount in stock because they would be constrained by the 200% legal leveraging limit. Table 3/FIG. 6 indicates that the average amount of leverage over the course of the working life (weighted by the amount invested in stock) was 105.7.

The higher returns of leverage do not, however, translate into higher retirement risk. The minimum retirement wealth under the dual-percentage target strategy was 13.5% higher than the minimum return of under the 100% stock strategy—and the 10^{th} percentile was 23.7% higher. Table 3/FIG. 6 shows that the mean, median, minimum, maximum, 10^{th}, 25^{th}, 75^{th}, and 90^{th} percentiles for both the dual and the single-target strategies are all higher than those of the 100% stock strategy. Moreover, the lower panel of Table 3/FIG. 6 shows that the certainty-equivalent dollar values for retirement wealth are 13% to 23% larger for the dual-percentage strategy than for the 100% stock strategy.

Table 3/FIG. 6 also shows that a single-percentage target produces substantially similar results as the dual-percentage target. Although dual-target strategies will theoretically do better when margin costs are important, empirically most of the benefits of temporal diversification can be achieved with a single target. As a result, the remainder of this description focuses on the single-percentage and single-dollar strategies. However, those skilled in the art will recognize that the invention is not limited to those strategies, and that other, related strategies (e.g., dual-target strategies) also fall within the scope of the present invention.

The single dollar strategy—targeting a constant present value of $34,143 in stock each year—produces substantially higher gains than any other strategy. The mean and median returns for the strategy were 45 and 65 percent higher than those for the traditional 100% investment strategy. The worst cohort accumulation ($152,468) was more than 16% higher than the worst cohort accumulation under the traditional 100% stock strategy ($130,940) and more than 23% higher than the worst cohort for traditional 90/50 life-cycle strategy ($123,863). The certainty equivalent for any plausible CRRA is at least 25% and typically 45% higher than the certainty equivalents for the simple 100% stock strategy. The single-dollar target produces better results than the single percentage target because it takes advantage of mean reversion in stock returns.

Table 4 (depicted in FIG. 7) shows the median length of the different phases. For the single-percentage strategy, the investor in the median cohort is maximally leveraged until age 32 and continues to have some degree of leverage until age 50. The single-dollar target strategy produces an even longer period of maximal leverage—with phase 1 ending at a median age of 40. The dollar-target strategy also has more heterogeneity in leverage with a higher average amount of leverage than the percent target (120.2% versus 103.5%), but a lower minimum amount of leverage (55% versus 88%).

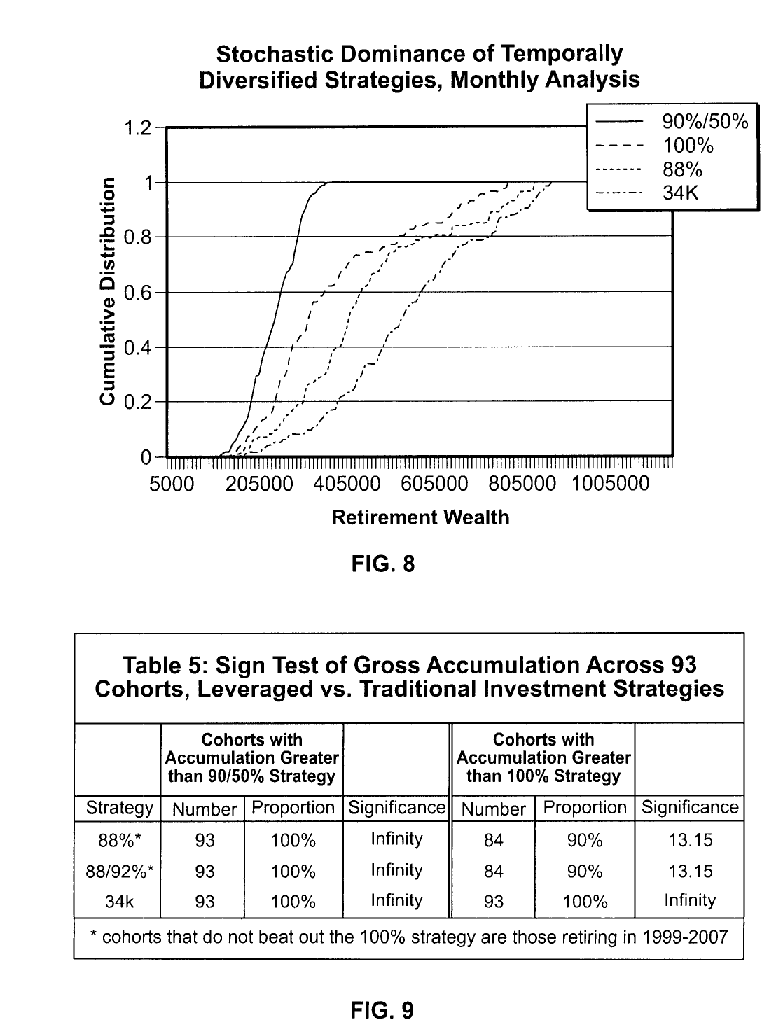

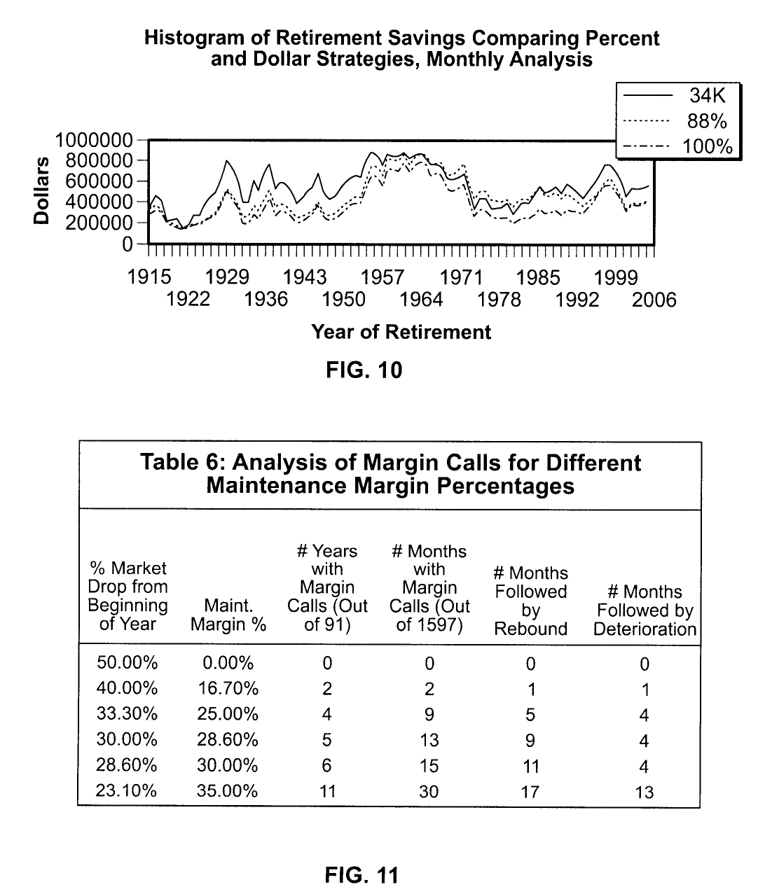

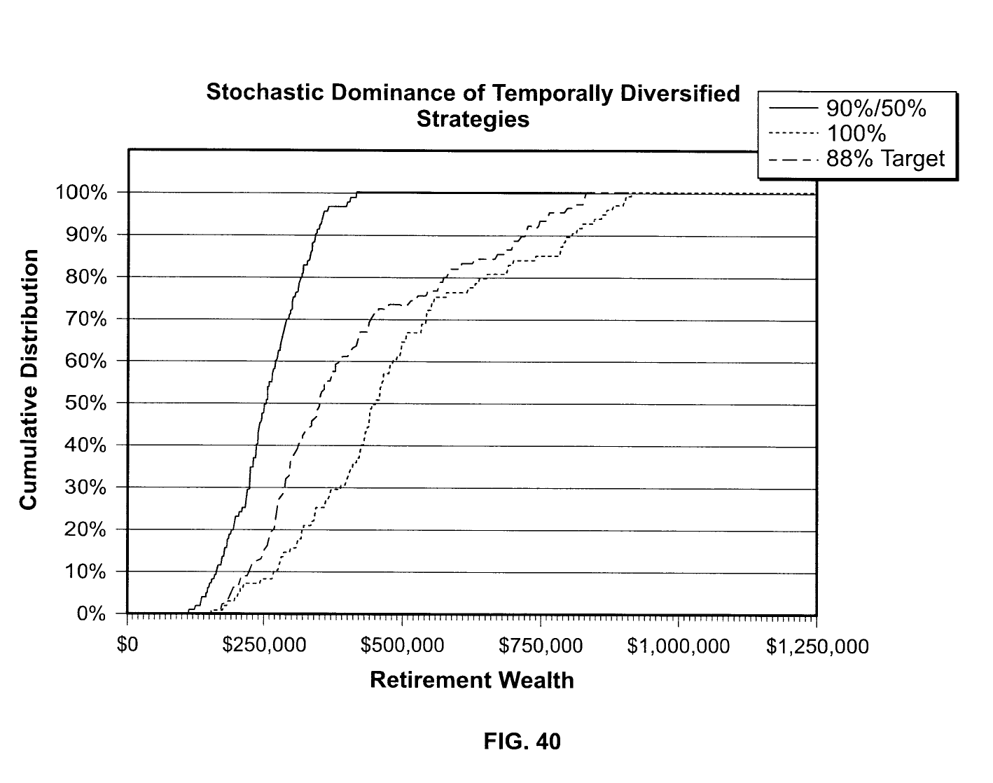

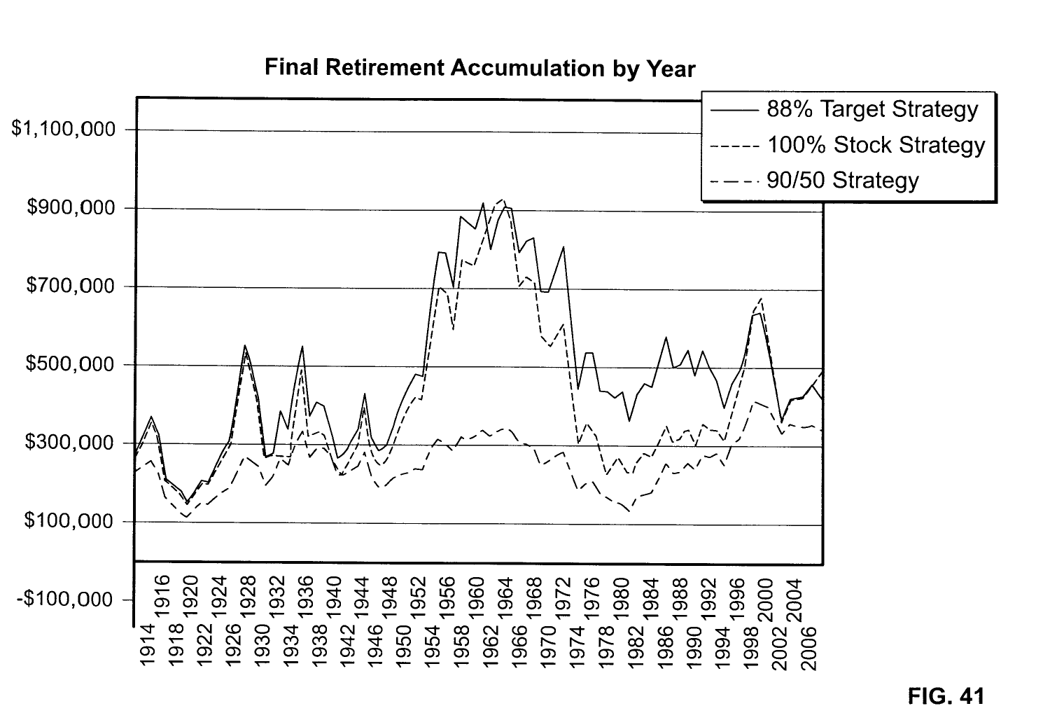

The diversifying advantages of the single-percentage and single-dollar strategies are most easily seen in FIG. 8 (see also FIG. 40). Both the single-percentage and single-dollar target strategies stochastically dominate the return of the conventional investment strategies. First-order stochastic dominance can be seen by the fact that the cumulative distribution functions for the 93 investing cohorts are everywhere to the right. Indeed, the mean and median accumulations under the single-dollar target strategy are greater than more than 80 percent of the cohort accumulations under the 100% strategy. The comparison with the traditional life-cycle strategy is even more extreme—the 10^{th} percentile accumulation under the single-dollar target is greater than the 90th percentile achieved by the 90/50% strategy.

A paired cohort-by-cohort comparison of temporally diversified and traditional investment strategies was conducted. In each of the 93 cohorts, we find that the single-dollar target strategy produced a higher accumulation than would have been produced by either of the traditional investment strategies. Table 5 (depicted in FIG. 9) shows that the single- and dual-percentage accumulations were higher than the 90/50% strategy in all 93 cohorts and better than the 100% stock strategy in 90.3% (84 out of 93) of the cohorts. A sign test finds these proportions to be statistically different from 50% (p≦0001).

The 9 cohorts where the 100% strategy beats the single-percent target strategy all occurred for the most recent retiring cohorts (1999-2007). The recent single-percentage target results suggests that its accumulation fell behind the 100% strategy because the single percent investors did not invest as aggressively in the stock market during the historic run up in the 1990s (for example, a nominal 32% increase in 1991). The 100% dominated the 88% single-target strategy because the latter was more conservative in the investors' latter years.¹⁴ However, the relative shortfall of the single-target strategy was not an absolute shortfall. For example, the retiring cohort in 2000 displayed the greatest relative shortfall ($65,058). Even so, they would have accumulated $566,539 following the single-target strategy. All nine cohorts in which the 100% strategy exceeded the single-percent strategy are cohorts where the single percent strategy produced above-average accumulations—just not quite as high as the 100% strategy because of the ramp down in stock allocation during the last phase before retirement. ¹⁴ In 2000-2003, the market declined annually 5.5, 13.1, and 20.0 percent, respectively. For investors retiring just after these years it was good not to be so invested and accordingly the shortfall in accumulations narrows.

Buying stock on margin initially increases short-term risk. But using leveraged purchases also allows for a more even allocation across time and thus substantially reduces the coefficient of variation for the single percentage and dollar targets (27% relative to the 100% stock strategy). Better diversifying across time can ultimately reduce risk with regard to retirement accumulations.

c. Margin Calls and Wipeouts

The analysis underlying Table 3/FIG. 6 did not allow for interim margin calls that would occur if there was a substantial decline in the market. Our estimation in this example assumed that all leveraged positions were closed at the end of each month and, if the strategy ordained, releveraged up in the next month. The major stock exchanges (per NYSE Rule 431 and NASD Rule 2520) require a maintenance margin on long positions of 25%. Some brokers require an even higher maintenance margin of 30 or 35 percent (Fortune (2000)).

If there were no maintenance margin requirement, the stock market would have to drop 50% before the net value in a fully (200%) levered portfolio was extinguished. But with a maintenance margin requirement of 25%, margin calls would force investors to start selling their positions if the market lost a third of its value. ¹⁵ Margin calls do not greatly affect our analysis. They merely force the investor to deleverage the portfolio by selling some of their stock and retiring some of their debt. Being forced to deleverage in June can reduce your returns if the market rebounds by the end of the year. But being forced to deleverage can also increase your returns if the market further deteriorates. Table 6 (depicted in FIG. 11) shows that months with margin calls are followed by a mixture of rebounds and deteriorations. Hence, not adjusting estimates for margin calls caused by stock swings within particular months, while a departure from reality, should not bias or even greatly impact the results. ¹⁵ Imagine that the investor buys $200 of stock using $100 of capital. Were the market to drop by 33.3%, then the portfolio would be worth $133 and the equity behind it would be $33.3 or 25%.

Even without margin maintenance requirements, the prevalence of substantial market declines has a potentially devastating impact on strategies that incorporate leveraged stock purchases. A natural reality check is look at the results for worker cohorts who lived through the Great Depression. The real stock returns on the S&P 500 in 1929, 1930, and 1931 were −8.8%, −16.0%, and −36.5%. ¹⁶ How can it be that investors following leveraged strategies did as well as reported in Table 3/FIG. 6? The basic answer is that workers who retired just after the crash were not severely hurt because the targeted strategy had already eliminated their leverage. For example, workers retiring in 1932 following the single-dollar target strategy would have had just 65% of their portfolio invested in the market when the market lost more than a third of its value. Because of the success of their investments in previous years, they would still have a retirement wealth of $479,970, substantially above the average result reported in Table 3 for the more conventional investment strategies. ¹⁶ The stock market “crash” in October 1929 had been preceded by sizable increases so that the year-end nominal loss was only 8.8%.

Individuals who began working just before the depression and adopted the single-target strategy would have done even better. Those who entered the labor force in 1931 immediately experienced an 86.5% loss in their first investment year. But this is a large percentage of a small amount, and the target strategy responds by keeping these workers fully leveraged until they hit the target. By the time of their retirement in 1975, these workers following the single-dollar target strategy would (in 2006 dollars) have accumulated $348,486, which is still above the median return for the 100% stock strategy.

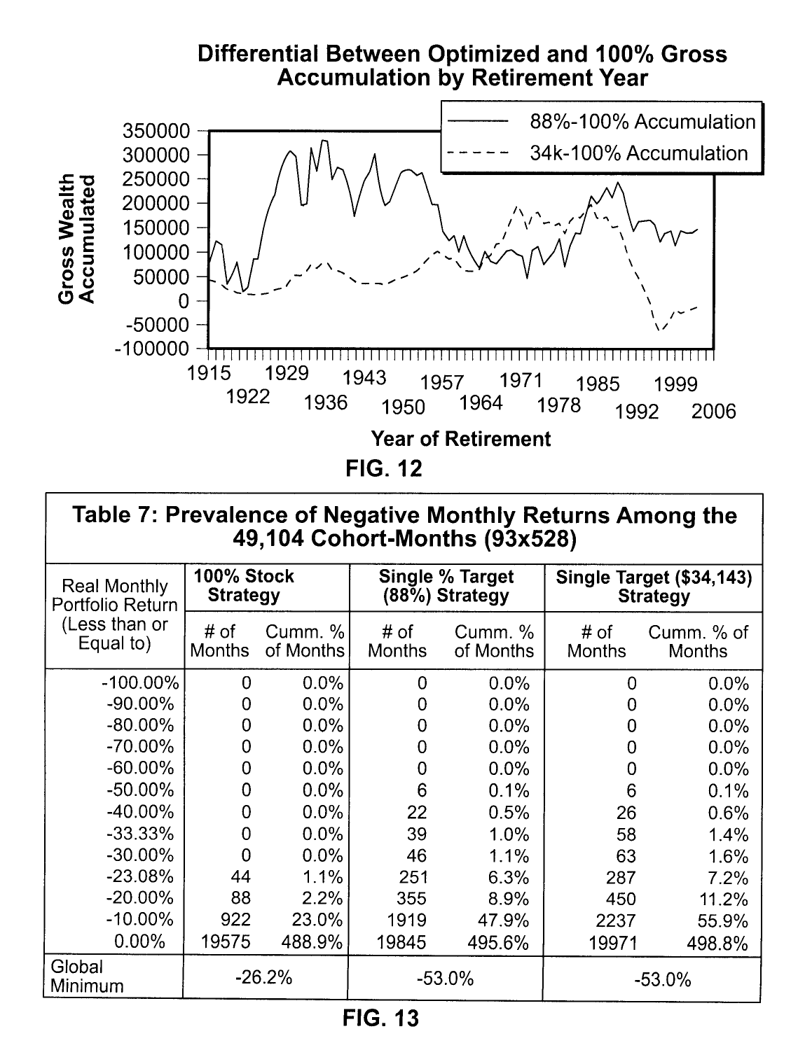

FIG. 12 depicts a histogram of the retirement accumulations for all 93 cohorts following the traditional 100% strategy and the single-target strategies. As it turns out, workers retiring in 1921 produced the lowest accumulations under either the single-dollar or single-percentage targets ($152,490 and $149,106 respectively). For these workers, enduring the double digit market declines in 1893, 1903, 1907, 1917, and 1920 was more limiting than the more severe but compact declines of the depression that others experienced.

As an empirical matter, the stock market in our monthly data has never declined sufficiently to wipe out the preexisting investments of any cohort adopting any of the temporally diversified (single- or dual-target) strategies. Table 7 (depicted in FIG. 13) details the prevalence of negative monthly returns for the 93 cohorts over their 528 months of investment. Both of the leveraged strategies produce negative returns of 58.9% in October of 1929 when young investors are fully (200%) leveraged. The leveraged strategies expose workers to a much larger probability of incurring a substantial negative monthly return sometime during their working life. Roughly one-third of the cohorts (28 out of 93) would have lost over 40% in one month. Table 3/FIG. 6 shows, however, that exposure to a substantial risk of a substantial monthly loss does not mean exposure to a substantial risk of loss to accumulated retirement savings.

d. Alternative Margin Caps

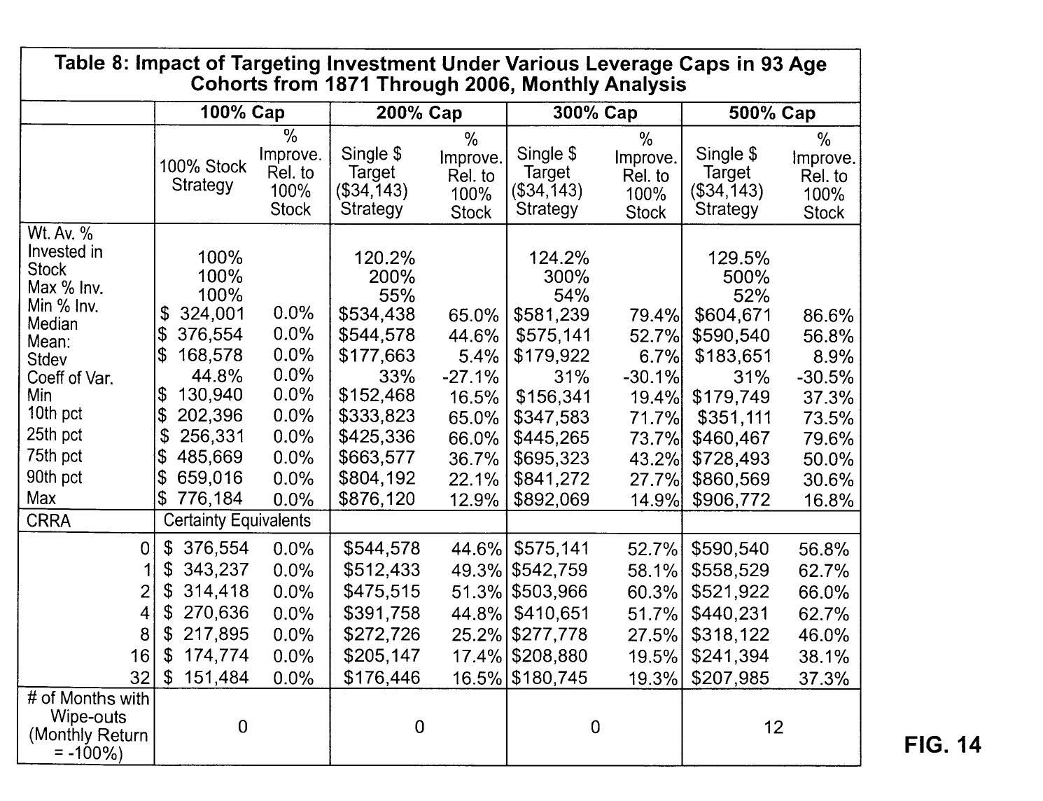

While Regulation T prohibits investing more than 200% of portfolio value in stock, absent this regulation lenders might agree to higher degrees of leverage. In fact, current stock index future contracts require only about an 8% “performance bond” and thereby allow qualified individuals to invest on the order of 1,250% of their equity value. Table 8 (depicted in FIG. 14) shows the impact of higher margin caps on the leveraged investment strategies. The two left-hand columns report as benchmarks the accumulations from the more traditional 100% stock strategy as well as single-dollar target strategy for a 200% margin cap.

If leverage caps were increased to 300% or 500%, the single-dollar target strategy would be even more successful. Mean, median, and minimum accumulations are higher for the 500% cap than for the 200% cap. For example, the mean retirement accumulation is $590,540 under the 500% cap instead of $544,578 under the 200% cap. Moreover, the certainty equivalents for the 500% cap are substantially higher than for lower caps. The CRRA=2 certainty equivalent is $521,922 for an investment strategy with a 500% cap but only $475,515 for investments with a 200% cap. This is true even though the 500% strategy in 12 separate cohort months (out of 49,104 cohort months) produces annual returns of −100% which completely extinguish the cohort's preexisting retirement accumulation.¹⁷ The take-home lesson of Tables 7 and 8 (FIGS. 13 and 14) is that the existence of substantial short term risk—even the risk of losing everything—does not undermine the expected gain from a disciplined, leveraged investment strategy. ¹⁷ Ten of the wipeouts were associated with cohorts where youthful investors were fully leveraged in March 1932 (where the S&P 500 fell 23%) and two wipeouts were associated with cohorts where youthful investors were fully leveraged in October 1929 (where the S&P 500 fell 26%). Even with a 500% cap, October 1929 did not effect more cohorts because the high returns in roaring 20's had already reduced investors leverage heading into the Great Crash.

Robustness

This section considers alternative assumptions to test the robustness of the advantages to leveraged investing. We consider higher administrative costs, higher margin costs, and lower stock returns. We consider simulations based on stock returns restricted to subperiods of the data along with using Monte Carlo simulations with and without replacement. The consistent message is that our results are robust to a variety of assumptions. This is foreshadowed by our first results in Table 1/FIG. 2. From 1871 to 2006, the average premium on stocks over the margin rate was 4 percent—9% vs. 5%. As long as the expected return on stock exceeds the net cost of maintaining a margin position, it will be optimal to employ leverage early in life. As the premium narrows, the scale and value of leverage declines.

A. Higher Administrative Fees

The previous results were based on an assumption that the investor pays annual administrative fees equal to 30 basis points of the net portfolio value. With leveraged portfolios, it might be more appropriate to assume that administrative fees are based on the greater of net portfolio value or the amount invested in the stock market. To the extent that administrative fees are charged on the amount of leveraged stock, this is equivalent to paying an extra 30 basis point fee for the margin loan (since all the margin loan is used to buy stock). As we see in the next subsection, a small increase in the margin rate will have very little impact on the results.

B. Higher Margin Rates

Higher margin rates narrow the equity premium when buying stock on margin and thus reduce the value of leverage. We have assumed the margin rate averaged just 20 basis points above the return on corporate bonds (5.0% vs. 4.8%, as shown in Table 1/FIG. 2). This assumption may be controversial because such margin rates do not seem to be available from brokers. For example, in May 2006, low-cost brokers such as Vanguard and Fidelity charged margin rates of more than 9.5% on small-balance margin loans, a rate that far exceeds their cost of funds.¹⁸ The markups are independent of the degree of leverage and are instead tailored to the amount of the loan with substantial premiums for loans under $25,000 dollars. The corresponding margin rate at E*Trade for loans over $1,000,000 was 6.74%, and Fidelity offered its active investors a rate of 5.5% on loans balances over $500,000. Several commentators (Fortune (2000); Willen and Kubler (2006)) have noted the puzzlingly high prices for small loan balances which more resemble credit-card rates than asset-backed loans. ¹⁸ Rates are as of May 1, 2006.

Index futures are a more cost-effective means for most investors to take on a leveraged position. By placing 8% down as a non-interest bearing performance bond, an investor can purchase exposure to the non-dividend returns of all the major stock indexes. The standard equation relating the forward price to the spot price is:

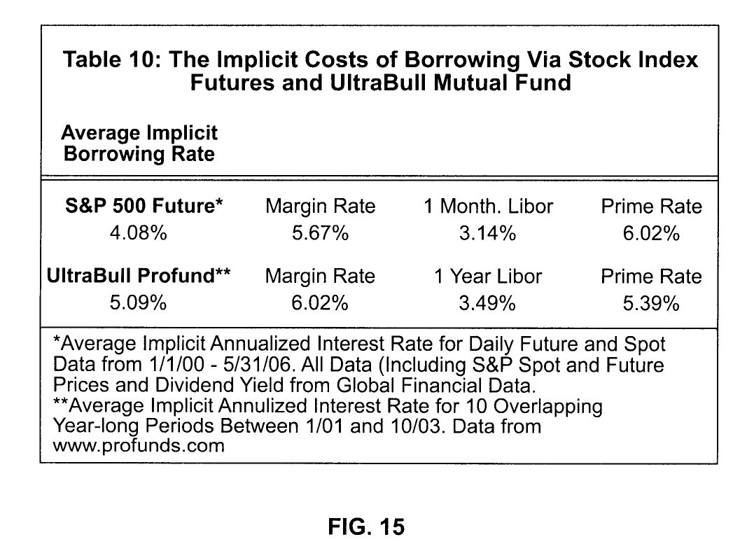

F=S·e^{rT}−d,

where F is the forward price to be paid at time T, S is the spot price, d is any dividend of the underlying stocks, and r is the risk-free interest rate (Fortune, 2000). Using this equation (and accounting for the lost interest on the 8% performance bond), it is possible to back out an estimate of the implicit interest rate for constructing a leveraged position via stock index futures. Using forward and spot market data from 2000 to 2005, the implicit margin rate for the S&P 500 futures has averaged only 4.08%; see Table 10 (depicted in FIG. 15).¹⁹ ¹⁹ The implicit interest rate may also be understated because owners of future indexes are subjected to less favorable tax treatment than owners of leveraged stock. Capital gains on future contracts are realized quarterly while realizations on stock investments may be deferred until a stock sale. IRS rules mitigate this difference by allowing holders of future contracts to attribute 60% of income as long-term gains and 40% as short-term gains.

The implicit cost of borrowing is just 94 basis points above the average 1-month Libor rate for the same time period and is 159 basis points below the margin rates for the same time periods used in our simulations. This is an underestimate in that we have not increased the performance bond as would be required when stocks fall. Doubling the performance bond to 16% would increase the implied margin cost to 4.56%. The current ability to implicitly borrow at such low effective interest rates gives us confidence in the reasonableness of our margin rates underlying Table 3/FIG. 6 and the foregoing estimates.

Table 10/FIG. 15 also backs out an implicit interest rate for the UltraBull mutual fund. This fund employs a combination of options and futures to provide investors with twice the returns of the S&P 500 (i.e., a beta of 2). We calculate the implicit margin rate as the difference between twice the return on the S&P and the return on the UltraBull fund. For example, between Sep. 3, 2002 and Aug. 20, 2003, the S&P returned 13.93% while the UltraBull returned 22.89%; thus the implicit margin cost is 4.97%, the difference between double the S&P (27.86%) and the UltraBull return. Similarly, from Jan. 3, 2001 to Dec. 25, 2001, the S&P lost 15.06% while the UltraBull lost 34.99%, leading to an implied margin cost of 4.87%. Using returns data between 2000 through 2003, we find that the implicit interest is 5.09% or 1.6% above Libor, which is substantially cheaper than the rates offered by most retail brokers.

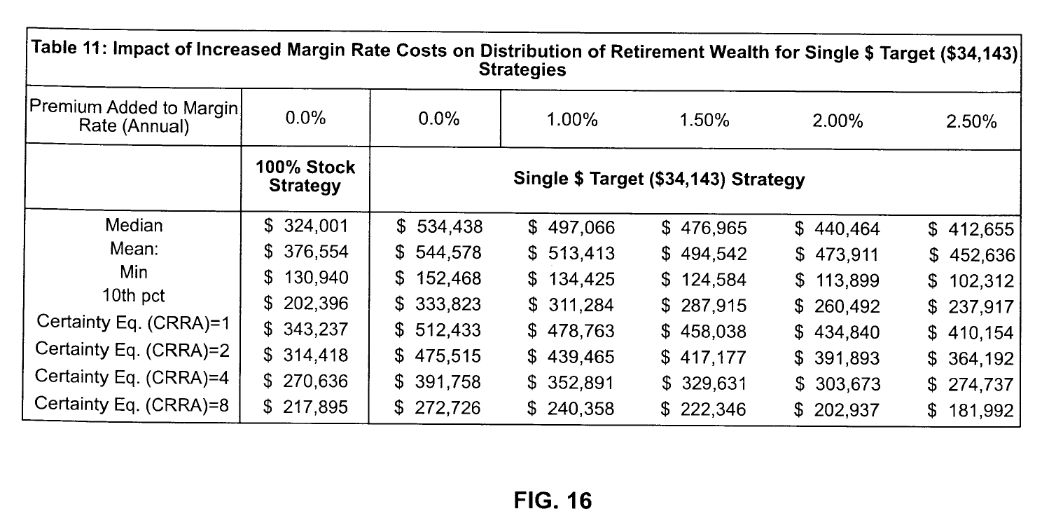

Table 11 (depicted in FIG. 16) shows the impact of simply increasing the historic margin rates. The two left-hand columns of Table 11/FIG. 16 report the benchmark accumulations accruing to the 100% and single-dollar strategies. The next four columns report the statistics for the single-target strategy where the margin loan rate is raised between 1% and 2.5%.

Table 11/FIG. 16 shows that the median and mean returns increase substantially even with 250 basis points added to the historic margin rates used in Table 3/FIG. 6. Thus, even without adjusting down the dollar target to account for the higher cost of leverage, it is still possible to produce superior accumulations. However, as the margin rates increase by 200 basis points, the $34 k strategy becomes riskier and produces fewer benefits relative to the unleveraged 100% stock strategy for very risk-averse investors (CRRA above 4).

The diversification advantage of leveraged investment strategies is contingent on the cost of borrowing. Given the advent of E-mini stock-index contracts, the cost of borrowing is lower than our historic margin rates (which were averaging 20 basis points above the corporate bond rate). Table 11/FIG. 16 suggests that the single-target strategies dominate the 100% stock strategy for margin rates up to 220 basis points above the corporate bond rate. The effective cost of leveraging through stock index contracts is far below this cutoff.

C. Lower Stock Returns

Leveraged strategies will also be less attractive in environments where the expected return on stocks is lower. Shiller (2005) has suggested several reasons why we the success of U.S. stocks in the 20^{th} century will not be replicated in the 21^{st}. He shows that the returns on stock in other countries has been 2.2% points lower than the stock returns in the U.S. Jorion and Goetzmann (1999) find an even larger shortfall. Moreover, a 2005 Wall St. Journal survey of prominent economists at Wall Street brokerages reports an expected real stock return of just 4.6%, which is 2.2% lower than the return found in the historic (1871-2006) data.

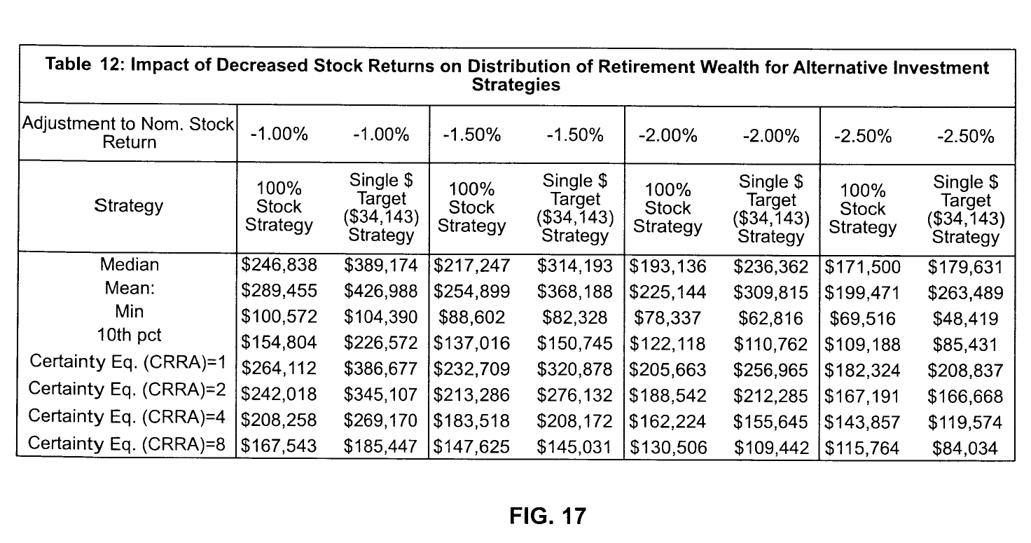

Unlike higher margin costs which just impact the expected return of leveraged strategies, the possibility of lower stock returns also impacts the expected accumulation of unleveraged investment strategies. Table 12 (depicted in FIG. 17) shows the results of reducing the nominal annual stock return by various percentage points for both the 100% stock strategy and single-target strategy of $34,143.

Table 12/FIG. 17 shows that the 34 k target strategy produces higher means and medians even with lower stock returns. With 1.5 percentage points subtracted from stock returns, the median retirement accumulation is 44.6% higher ($314,193 vs. $217,247) and even with a 2.5 percentage point reduction, the median accumulation is 4.7% higher ($179,631 vs. $171,500). But Table 12/FIG. 17 also shows that the $34 k target strategy produces lower minimum returns than the 100% stock strategy when more than 100 basis points are subtracted from the annual stock returns and hence lower certainty equivalents for sufficiently large CRRAs. However, for a relative risk aversion of 2, the certainty equivalent for the 34 k strategy is still 12.6% higher than that for the 100% strategy—even when 200 basis points is subtracted from the stock returns. Thus the leveraged investment strategy is robust to a substantial fall in the equity premium.²⁰ ²⁰ Note further that our targets were not adjusted to reflect the reduced equity premium. With reoptimized targets, the strategy would perform even better.

D. Monte Carlo Simulations

An advantage of the cohort simulations is that they tell what actual investors might have achieved in the past if they had pursued our proposed investment strategies. But the 93 cohorts that we have estimated are clearly not independent of each other. The returns of any two adjacent cohorts massively overlap—so that our effective number of independent observations is much closer to 3 [≈(2006-1871)/44]. An alternative approach to estimation pursued by PRVW (2005a,b) is to use the historic returns as the basis for a Monte Carlo simulation in which workers draw returns randomly from an urn of the yearly returns. We estimate the distribution of returns from 1,000 trials, each time picking 44 years at random from Shiller's annual data with replacement.²¹ This approach produces returns that are independent and identically distributed. But it not clear that the stock returns are in fact independently distributed across time (Poterba and Summers (1988)). One thing is clear: leveraged strategies no longer produce first-order stochastic dominance. The reason is that with a large enough sample, some workers will draw the 1931 return 44 years in a row and it is clear that unleveraged strategies will do better when this occurs. ²¹ Monte Carlo with replacement subjects investors to riskier i.i.d. returns. Like the cohort analysis, the draws from these Monte Carlo simulations without replacement are not i.i.d. Once an investor has drawn 1929, she never has to worry about hitting it again. The annual data in the cohort analysis produced results that were quite similar to the monthly data.

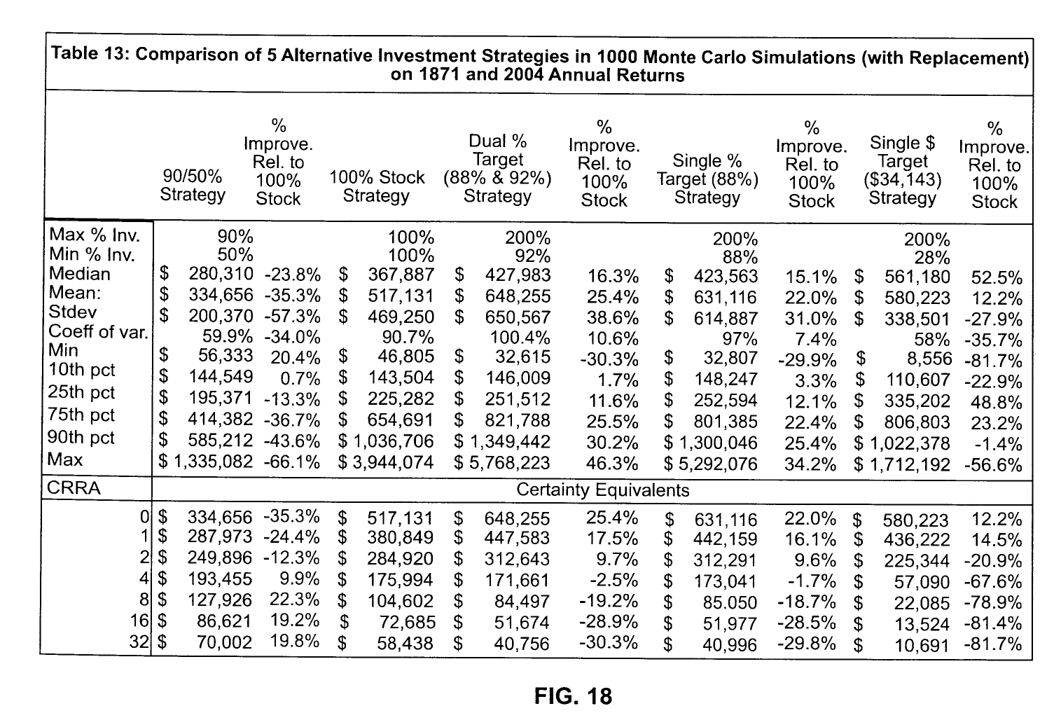

The results of the Monte Carlo simulations are reported in Table 13 (depicted in FIG. 18). The single-target strategies continue to produce higher mean and median returns than either of the traditional investment strategies. But for CRRA above 1, the single dollar target strategy produces certainty equivalents that are inferior to those of the single percentage strategy. This is expected because the dollar target is designed to capitalize on historic mean reversion in stock returns, while the percent target is derived from a model like the Monte Carlo simulation in which stock returns are i.i.d.²² ²² Indeed, with i.i.d. returns, and constant relative risk aversion, we know that the two-tiered percent targets maximized expected utility.

Table 13/FIG. 18 also shows that the dominance of the certainty equivalents for the fixed target strategies is less robust to alternative CRRAs. The 88% and 34 k strategies were optimized for an investor CRRA equal to 2. Table 3/FIG. 6 showed that for the historical data these invariant strategies produced higher certainty equivalents than the traditional investment strategies, even for very high levels of risk aversion. In contrast, Table 13/FIG. 18 shows that under Monte Carlo simulation, the certainty equivalents for invariant targets are substantially lower than the traditional strategies when risk aversion rises. Investors with higher levels of risk aversion should pursue leveraged strategies with lower targets.

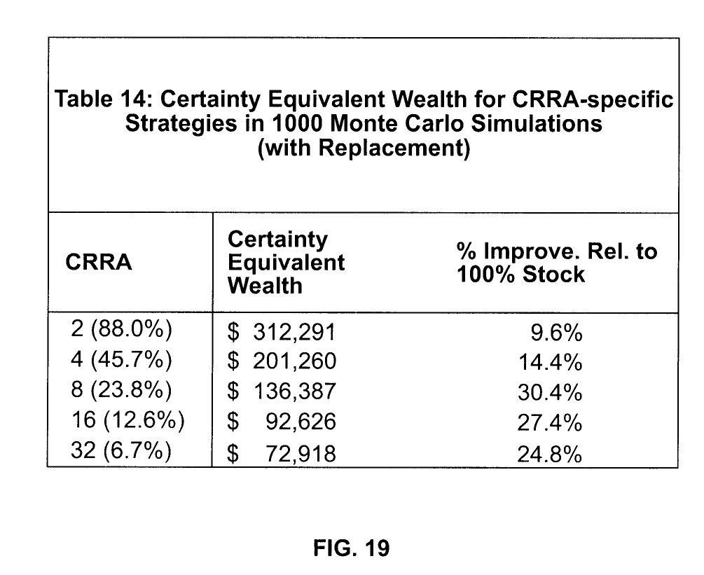

Table 14 (depicted in FIG. 19) shows the certainty equivalents for the single percent target strategies that are re-optimized for particular degrees of risk aversion. We see that for CRRA=2, the optimal single percent target remains at 88.0%. But, for higher levels of risk-aversion, the optimal percent target decreases. Table 14/FIG. 19 shows that using CRRA-specific targets once again produces certainty equivalents that substantially exceed the 100% target. In the historic data (with mean reversion), the benefits of temporal diversification were so great that the invariant targets were sufficient to generate gains. With Monte Carlo simulations, temporal diversification still produces benefits but CRRA-specific targets must be used.

E. Different Years

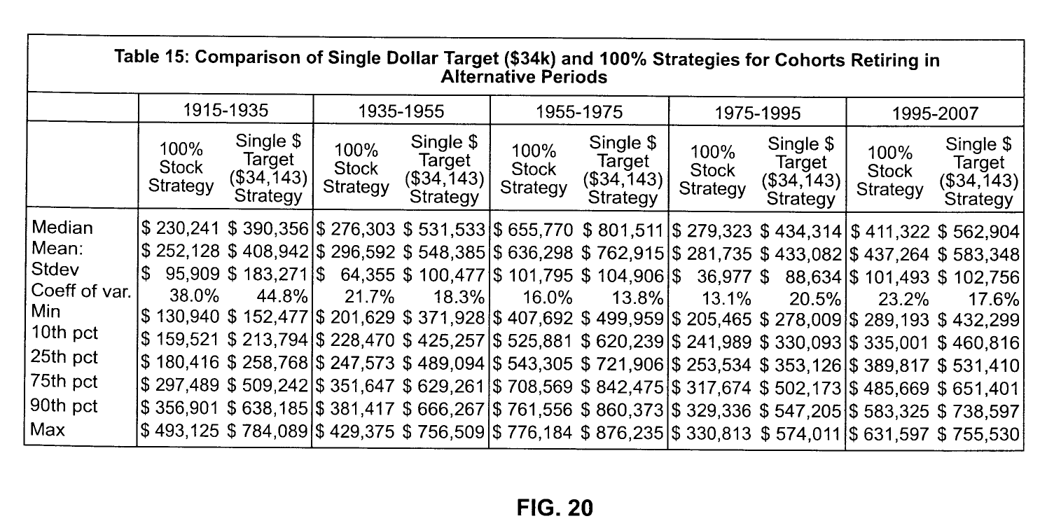

Finally, rerunning the analysis on the alternative years does not affect the substance of our results. Table 15 (depicted in FIG. 20) shows that mean, median, and minimum accumulations are substantially higher than the 100% stock accumulations in each 20-year period of retirement cohorts. The diversifying advantage of targeted investment strategies is not an artifact of the particular years chosen for analysis.

This description shows that it is possible for people to retire with substantially larger and safer retirement accumulations. They can do this without having to save more. All they have to do is invest using leverage while young. Most people resist the idea of investing on margin because it seems too risky. (Such perceptions only apply to stocks, not houses.) These perceptions are wrong. From a dynamic perspective, investing on margin reduces risk because it allows the investor to better diversify risk across time.

The recommended investment strategy for this example is straightforward to implement. An investor who targets a single percentage or a single present dollar value follows three phases of investment. The worker begins by investing 200% of current savings in stock until a target level of investment is achieved. In the second phase, the worker maintains the target level of equity investment while deleveraging the portfolio and then maintains that target level as an unleveraged position in the third and final phase.

The expected gains from such leveraged savings are striking. With increased longevity, people need to save more for their retirement. The expected gains in retirement accumulations allow someone to finance an extra 14.4 years of retirement (almost to age 100) or to retire at age 57 and still finance retirement through age 85. Or, to the extent that current savings are inadequate to maintain pre-retirement standards of living, this can boost retirement consumption by 50%.

Our results depend on historical factors that may not repeat. Most importantly, our results depend on the equity premium. For typical levels of risk aversion, the advantages of a leveraged strategy are reduced but continue to hold even if the equity premium were to fall by 150 to 200 basis points.

Finally, our results have significant implications for legal reform. The natural places to engage in leveraged purchases are IRA and 401(k) accounts. Yet, with the curious exception of the index options, leveraged and derivative investments inside these accounts are prohibited. An employer who offered workers the option of following the single-dollar or single-percentage target strategies or the option to invest in a leveraged mutual fund might risk losing their statutory safe harbor. Approximately two thirds of 401(k) plans allow employees to borrow against their plan balances to fund present consumption; in stark contrast, employees are not allowed to borrow to fund leveraged investments in their future. Young workers with non-tax deferred retirement savings can leverage their net retirement portfolio with the use of stock index futures, but even here the law intrudes limiting future accounts to investors who are “sophisticated” (i.e., sufficiently wealthy).

Lifetime Target Investment Strategy

At least one aspect of the invention comprises calculation of a lifetime investment target, or target strategy. The target strategy is, in one embodiment, the result of a method of transforming answers from investors about their basic financial circumstances and deriving an optimal portfolio allocation across an investor's lifetime to maximize effective diversification across time. In an embodiment, it comprises three parts:
1. Deriving a “Lifetime Percentage Target” based on a person's investing goals and risk tolerance. This percentage is the proportion of current and future (discounted) savings contributions that the individual should strive to invest in stock. The percentage of current savings invested in stock can be greater than 100%, because the investors can borrow (up to some pre-specified cap) to buy stock. If the percentage of current savings invested in stock is less than 100%, the remainder is allocated to government bonds.
2. Deriving the “Present Value of Current and Future Savings,” based on a person's description of the current savings and their future saving prospects.
3. Deriving the dollar amount that is targeted to be invested in stock each period. (The period, by default, is one month—but can be however often the investor chooses to regularly rebalance.) The dollar amount targeted for stock is simply the “Lifetime Percentage Target” (from 1) multiplied by the “Present Value of Current and Future Savings” (from 2).

Lifetime Percentage Targets

The Lifetime Percentage Target is a function of a person's risk tolerance. A questionnaire, either online, on a local computer, or even in paper form, is preferably used to establish the individual's preference for risk reduction vs. reward increase. The information gleaned from the questionnaire is used to estimate a utility function for the investor—an equation that rates how desirable any particular probability distribution of returns is to the individual based on his or her responses.

This utility function is then applied to historical stock returns to derive a Lifetime Percentage Target. The Lifetime Percentage Target is the strategy that maximizes the individual's utility function based on an assumption of constant relative risk aversion.

Under the Target Investment Strategy each investor has two lifetime percentage targets. The first, “low” target is the percentage that maximizes well-being (i.e., maximizes the utility function) if the portfolio is split between stock and an investment at the margin borrowing rate. The second, “high” target maximizes well-being if the portfolio is split between stock and bonds. This reflects that when an investor is buying stocks on margin, the opportunity cost of an additional unit of stock depends on the margin rate rather than the bond rate.

In a simpler embodiment, the second “high” percentage target is simply set equal to the first “low” percentage target. For most investors these numbers differ little and there is only a small reduction in efficacy.

Monthly Portfolio Allocation

In at least one exemplary embodiment, each period the strategy uses the two lifetime percentage targets to generate two period-specific dollar goals. These dollar goals are then used to generate a single period-specific portfolio allocation for the individual.

For each lifetime percentage target the corresponding period-specific dollar goal is equal to:

(% Target)*(Current Portfolio Value+Discounted Value of Anticipated Contributions)

The discounted value of anticipated wages is by default calculated by fitting the lifetime wage profile of the Social Security Administration's median earner to the individual's current income and age and then applying a constant contribution rate to each year's income. This amount is then discounted to the present at the average historical bond rate. The formula can be adapted to adjust for a wage profile specific to the investor's education level, or to adjust for the individual's particular savings plans over his or her lifetime.

The two period-specific dollar goals are used to calculate a portfolio allocation for the month preferably using this algorithm:

If the first (“low”) target is greater than 2 times the current portfolio value then borrow stock at margin to achieve a portfolio with stock value equal to 2 times the current portfolio value.

If the above fails to be true, and if the first (“low”) target is greater than the current portfolio value, then borrow stock at the margin to achieve a portfolio with stock value equal to the first (“low”) target.

If all the above conditions fail to be true, and if the second (“high”) target is greater than the current portfolio value, then invest 100% of the portfolio in stock and do not borrow at the margin to invest any more.

If all the above conditions fail to be true then the second (“high”) target is less than the current portfolio value. Invest the amount of the second (“high”) dollar target in stock and the remainder in bonds.

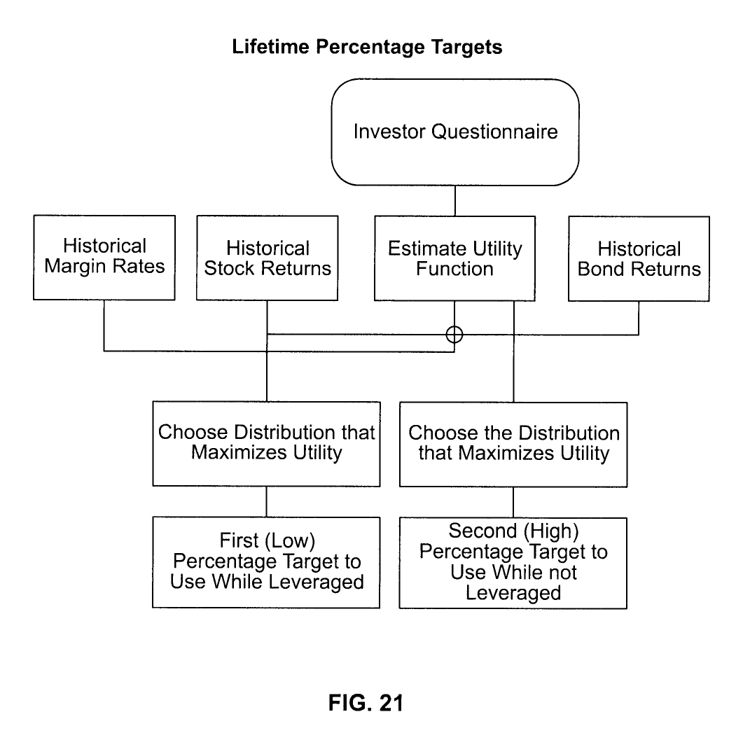

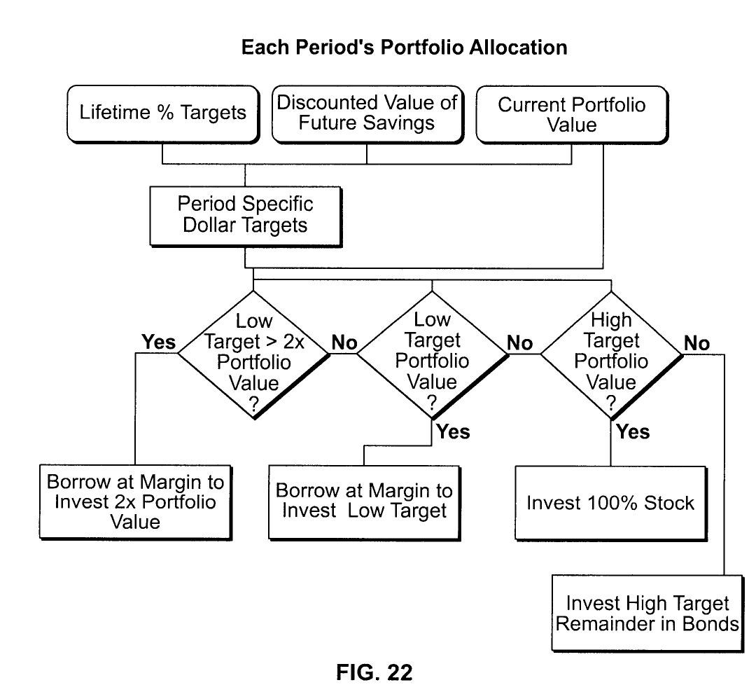

These processes are depicted in the flowcharts of FIGS. 21 and 22.

### Additional Embodiments

Those skilled in the art will recognize that the data described above is exemplary only, and the invention is not limited to that particular data. The additional embodiments discussed below further illustrate aspects of the invention.

As discussed above, stock index derivatives have allowed investors to take on the equivalent of leveraged positions at implicit interest rates that are below the call money rate. Index futures, for example, are a more cost-effective means for most investors to take on a leveraged position. By placing 8% down as a non-interest bearing performance bond, an investor can purchase exposure to the non-dividend returns of all the major stock indexes.

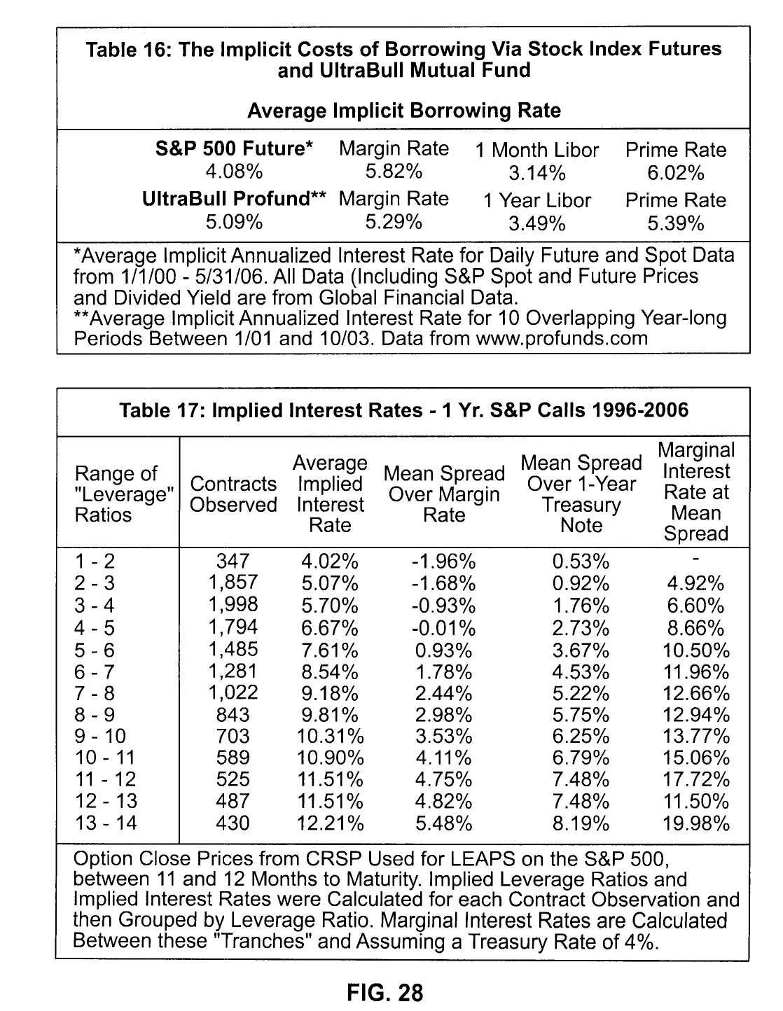

Again, the standard equation relating the forward price to the spot price is F=Se^{rT}−d, where F is the forward price to be paid at time T, S is the spot price, d is any dividend of the underlying stocks, and r is the risk-free interest rate. Using this equation (and accounting for the lost interest on the 8% performance bond), it is possible to back out an estimate of the implicit interest rate for constructing a leveraged position via stock index futures. Using forward and spot market data from 2000 to 2005, the implicit margin rate for the S&P 500 futures has averaged only 4.08%; see Table 16 (FIG. 28).²³The implicit cost of borrowing is just 94 basis points above the average 1-month LIBOR rate for the same time period and is 174 basis points below the margin rates for the same time periods used in our simulations. This is an underestimate in that we have not increased the performance bond as would be required when stocks fall. Doubling the performance bond to 16% would increase the implied margin cost to 4.56%—still well below the call money rate at the time. ²³ The implicit interest rate may also be understated because owners of future indexes are subjected to less favorable tax treatment than owners of leveraged stock. Capital gains on future contracts are realized quarterly while realizations on stock investments may be deferred until a stock sale. IRS rules mitigate this difference by allowing holders of future contracts to attribute 60% of income as long-term gains and 40% as short-term gains.

Table 16 also backs out an implicit interest rate for the UltraBull mutual fund. This fund employs a combination of options and futures to provide investors with twice the returns of the S&P 500 (i.e., a beta of 2). We calculate the implied margin rate as the difference between twice the return on the S&P and the return on the UltraBull fund. For example, between Sep. 3, 2002 and Aug. 20, 2003, the S&P returned 13.93% while the UltraBull returned 22.89%; thus the implicit margin cost is 4.97%, the difference between double the S&P (27.86%) and the UltraBull return. Similarly, from Jan. 3, 2001 to Dec. 25, 2001, the S&P lost 15.06% while the UltraBull lost 34.99%, leading to an implied margin cost of 4.87%. Using returns data between 2000 through 2003, we find that the implicit interest is 5.09% or 1.6% above LIBOR, which is substantially cheaper than the rates offered by most retail brokers.

At present, an inexpensive route to obtain leverage is via the purchase of deep-in-the-money LEAP call options. For example, on Jul. 6, 2005, when the S&P 500 Index was trading at $1,194.94, a one-year LEAP call option on the S&P index with a strike price of $600 was priced at $596.40. This contract provides almost 2:1 leverage. It allows the investor, in effect, to borrow $598.54 (as this is the savings compared to buying the actual S&P index). At the end of the contract, the investor has to pay $600 to exercise the contract. Compared to buying an S&P mutual fund, the index holder will have also sacrificed $22.44 in foregone dividends (for holding the index rather than the stocks). Thus the true cost of buying the index is $622.44. The total cost of paying $622.44 almost a year after borrowing $598.54 produces an implied interest of 3.78% which is 25 basis points over the contemporaneous one-year yield on a Treasury note. Table 17 (FIG. 28) derives the implied interest of thousands of LEAP call options for ten years of option data.

We find that the implied interest for deep-in-the-money call options that produce effective leverage between 200 and 300% averaged less than one percent above the contemporaneous 1-year Treasury note. Moreover, the implicit interest rate on these calls was 160 basis points below the average contemporaneous call money rate. LEAPs also have the advantage that there is no potential for a margin call.

Given the low cost of leverage and the absence of margin calls, it might appear that young investors should consider taking on even greater amounts of leverage. However, Table 17 also shows that the implied interest increases with the degree of leverage. As can be seen in the far-right column, the implied marginal interest rate associated with additional leverage rapidly approaches (and then exceeds) the return on equity.²⁴ The marginal interest rate associated with the incremental borrowing required to move from 3:1 to 4:1 leverage is 6.6% and substantially higher than the 4.02% implied interest at 2:1 leverage and below. The marginal cost of increasing leverage rises sufficiently fast that it is unlikely that it would be cost effective to invest at leverage of more than 3:1 via option contracts. ²⁴ The marginal interest rate=(New Borrowing Amount*New Implied Interest Rate−Old Borrowing Amount*Old Implied Interest Rate)/(New Borrowing Amount−Old Borrowing Amount). Consider the move from 3:1 to 4:1 leverage. With 3:1 leverage, the investor puts up $1,000 and borrows $2,000 at a cost of 1.761% over the Treasury rate (assumed to be 4%) for a cost of $115.2. With 4:1 leverage, the investor puts up $1,000 and borrows $3,000 at a cost of 2.727% over Treasury or $201.8. Thus the marginal interest cost to borrow the additional $1,000 is ($201.8−$115.2)=$86.6 or 8.66%.

The more important lesson of Tables 16 and 17 is that the derivative markets have made it inexpensive to invest 200% or even 300% of current saving accumulations in the stock market. Whether or not investors had ready access to the broker call money rate in the past, our assumption of low-cost money going forward is particularly reasonable given the advent of options to implicitly borrow through derivative markets.

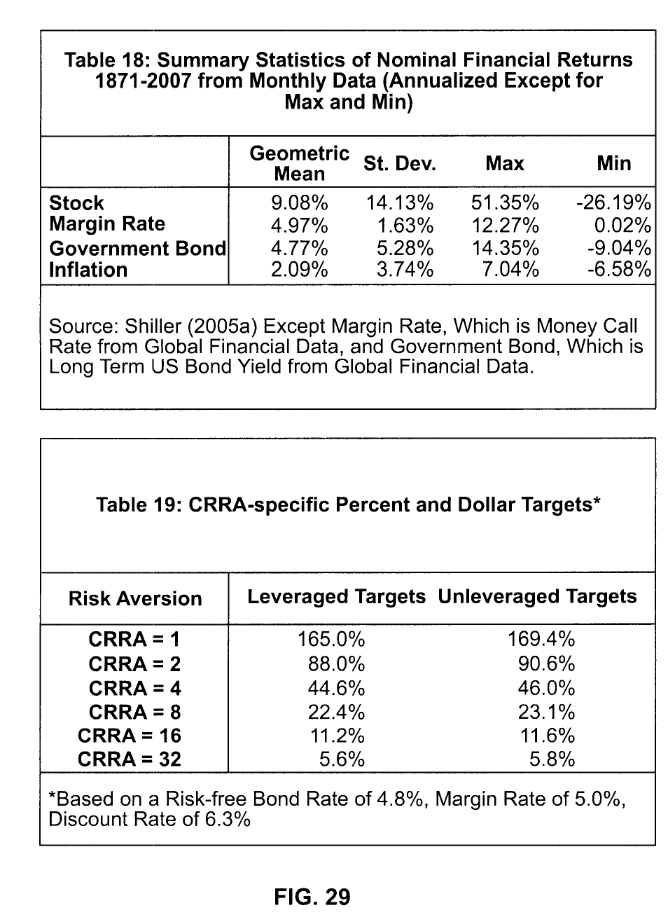

Table 18 (FIG. 29) shows summary statistics for the nominal financial returns. Stocks over this period had an average nominal return of 9 percent. On a monthly basis, the maximum positive return was 51.4% in 1933 shortly after the maximum negative return of −26.2% in 1931.²⁵ ²⁵ Our simulations are based on real returns and real interest rates. However, when we consider the potential impact of margin calls, we employ nominal returns as margin calls depend on the nominal change in equity prices.

Using Shiller's monthly data on stock and bond returns from 1871-2004, updated to 2007, we construct 94 separate draws of a worker's 44-year experience in the markets. Each of the draws represents a cohort of workers who are assumed to begin working at age 21 and retire at 65. For example, the first cohort relates to workers born in 1850 who start to work in 1871 and retire in 1914.

To perform the simulations, we take a representative worker and imagine that individual has an equal chance of experiencing any of the 94 different return histories. (Later, we also allow the worker to randomly experience returns from any 44 years out of the 137 in our total sample.) Following PRVW (2005b) and Shiller (2005a), we assume that workers save a fixed percentage of their income. In our simulations, we use Shiller's 4% number. Thus the saving accumulations depend only on the history of 4% contributions and prior-year returns.

Although the percent is constant, the actual contributions depend on the wage profile. We assume a hump-shaped vector of annual earnings taken from the Social Security Administration's scaled median earner. Wages rise to a maximum of $58,782 at age 51 (generating a saving contribution in that year of $2,351) and then fall off in succeeding years.²⁶ For a new worker at age 21, the future saving stream has a present value of $44,020 (when discounted at a real risk-free rate of 2.63%). Given this flow of saving contributions, the simulation assesses how different investment strategies fare in producing retirement wealth. In performing these calculations, we assume an annual administration/transaction fees equal to 30 basis points of the net portfolio value. ²⁶ See Shiller (2005a), Clingman and Nichols (2004).

Using Simulations to Complete the Model

To complete the model, we need to derive the percentage targets for specific levels of constant relative risk aversion (γ). To do this, we first find the dual-targets—leveraged (λₐ) and unleveraged (λ_{b})—that maximize single-period expected utility using the sample 137 returns as the actual distribution of returns.

Because the utility function is multiplicative in returns, maximizing single-period expected utility is equivalent to choosing the equity allocation to maximize

$$E \frac{{R}^{1 - γ}}{1 - γ} ,$$

where R is the resulting blended return. In the case of the leveraged target, we use the margin rate as the opportunity cost of capital; in the case of the unleveraged target, we use the government bond rate. (The general formula for R is provided in the appendix, Equation 1.) We chose the equity allocations to maximize single-period expected utilities according to the historical distribution of returns; we did not choose the allocations so as to maximize the ex-post lifetime utilities of the 94 cohorts.

The results from this maximization are shown in Table 19 (FIG. 29). For CRRA=2, the optimal leveraged and unleveraged percentage targets are 88.0% and 90.6% respectively. These percentages form the core example that we evaluate in our simulation of the dual-target strategy.

While we expect the unleveraged percentage target to be higher than the leveraged percentage, these two percentage targets are very close. This is because (as seen in Table 18) the average margin rate in our data is only slightly higher than the average bond rate, 5 percent versus 4.8 percent. This leads us to evaluate a single-target (three-phase) strategy, which invests a constant 88.0% of wealth, subject only to maximum leverage constraints.

We focus our attention on two different temporally diversified strategies and compare them with the two traditional investment strategies. Specifically, our simulations compare:
1. Dual-Target (Four-Phase) Strategy. This strategy sets the initial equity percentage target at a lower percentage (88.0%) during the first and second phases of leveraged investment and at a higher percentage (90.6%) for the third and fourth phase of unleveraged investments.
2. Single-Target (Three-Phase) Strategy. This strategy sets the equity percentage target at a constant percentage (88.0%) of discounted savings. Initially, the worker invests her entire liquid savings on a fully leveraged basis of 2:1 and remains fully leveraged until doing so would create stock investments exceeding the target percentage. From then on the worker invests on a partially leveraged or unleveraged basis. If the unleveraged portfolio value exceeds the target percentage, then stocks are sold and the excess amount is invested in government bonds. The percent of the portfolio invested in stock is contingent on the prior-year realized returns as this impacts the current portfolio value.
3. 100% Stock. Under this benchmark strategy, the worker invests a constant 100% of her liquid savings in stock.
4. 90%/50% Life-Cycle. Under this benchmark strategy the worker invests 90% of portfolio value in stock at age 21 and the percentage invested in stock falls linearly to 50% by age 65.

We limit our comparison set to these two traditional investment strategies in order to conserve space. PRVW (2005b) and Shiller (2005a) have simulated the risk and return of more than a dozen traditional investment strategies—included 100% TIPS, 100% bonds, (110—Age) % in stocks and a variety of alternative life-cycle strategies.

Results of the Cohort Simulation

A. Deviations from Optimal Diversification

From a diversification perspective, there are two problems with traditional investment strategies. The front-end problem is that the strategies don't expose the worker to sufficient stock market risk—thus throwing away the potential for additional years of diversification. The back-end problem is that strategies tend to expose the worker to either too much risk (under the 100% rule) or too little market risk (under the 90/50 rule).

To provide some heuristic evidence about the size of the front-end and back-end failures to diversify, we estimate the average amount invested in stock for the four benchmark strategies. A temporally diversified strategy would maintain a constant percent of retirement wealth in equities. Since retirement wealth grows at the blended return, if all wealth were available up front, we would also expect to see retirement wealth growing at the blended real return rate, here 6.35%, assuming that CRRA=2.²⁷ ²⁷ With a CRRA of 2, 88% of retirement wealth is invested in equities and 12% in bonds, leading to a blended real return of 6.35%.

Of course, the optimal temporal diversification will also depend on liquidity constraints, the cost of margin borrowing and on the realized returns in prior years, but it is valuable, heuristically, to see how close traditional strategies come to the Samuelson ideal.

Both the 90/50 and the 100% strategies fail to invest substantial amounts in stock in the first quarter of the investor's working life—effectively discarding these years as a means to diversify stock market risk. The leveraged diversification strategies respond directly to this problem by investing more in stock and thus putting the initial investor on a much steeper slope of investments. The back-end problems are even more pronounced. The 100% investment has the expected result of exponentially increasing the amounts invested in stock so that the returns in the few final years alone will disproportionately impact the investors' retirement wealth.

The 90/50 life-cycle exhibits the alternative back-end problem of not investing enough in stock in the last working years. Overall, the 90/50 strategy achieves a relatively flat real exposure to the market from age 45 onwards. But this is done at a cost of too little overall exposure. The life-cycle fund only has a 65% average exposure to the market. Our single-target (88%) strategy achieves a little over 110% exposure, but mitigates risk by achieving better diversification across time.²⁸ ²⁸ The data on average exposure come from Table V. In the case of the leveraged portfolio, the initial 200% exposure ramps down to 88%; it averages 110% because of the greater size of the portfolio in later years.

We can also assess the extent of diversification by measuring the concentration of strategy's exposure to stock market risk. The reciprocal of the Herfindahl-Hirshman Index (HHI) is a heuristic measure of the effective number of diversification years. Just as the inverse of the HHI in antitrust indicates the effective number of equally-sized investors in an industry (Ayres (1989)), the inverse of the HHI here indicates the amount of diversification that could be achieved by investing equal dollar amount in separate years. HHI estimates indicate that the average worker using the 100% stock rule effectively takes advantage of only about 21.1 of her 44 investments years (47.9%). In contrast, the single target strategy takes advantage of 24.7 years (56.2%). Under the 90/50 rule, the worker's exposure to stock market risk is more evenly distributed across years—and the inverse HHI in turn increases to 26.3 years (59.8%). But this increase in effective diversification is achieved by generally limiting exposure to the stock market. Investing nothing in stocks each year likewise would be fully diversified.

B. Comparing the Five Investment Strategies

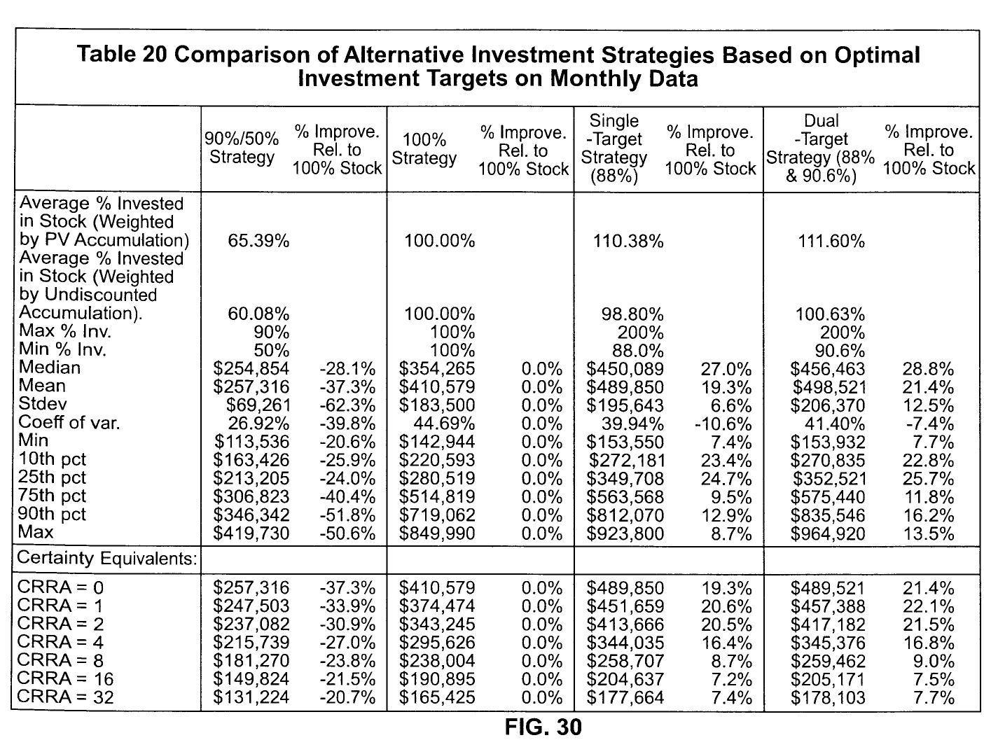

Table 20 (FIG. 30) reports our core results. In it, one can see the distribution of retirement wealth for the 94 worker cohorts under the five investment strategies. The first two columns replicate the basic findings of Shiller (2005a) and PRVW (2005a,b) in showing that a simple strategy of investing 100% of accumulated savings in stock dominates the life-cycle strategy of investing 90% in stock when young, ramping down to 50% at age 65. Average retirement wealth among the 94 cohorts is more than 59% larger with the 100% strategy ($410,578) than with the 90/50 strategy ($257,316) and the certainty-equivalent dollar amounts are uniformly higher for all relative risk aversion measures.

The surprise is how well the leveraged strategies fare relative to the 100% strategy. The dual-target strategy produces a median retirement wealth that is 28.8% higher than the 100%-stock strategy and an increase in the mean return of 21.4%.

The higher returns of leverage do not, however, translate into higher retirement risk. The minimum retirement wealth under the dual-target strategy was 7.7% higher than the minimum return of under the 100% stock strategy—and the 10^{th} percentile was 22.8% higher. Table 20 shows that the mean, median, minimum, maximum, 10^{th}, 25^{th}, 75^{th}, and 90^{th} percentiles for both the dual- and single-target strategies are all higher than those of the 100% stock strategy. Moreover, the lower panel of Table 20 shows that the certainty-equivalent dollar values for retirement wealth are 7% to 22% larger for both the dual-target strategy and the single-target strategy compared to the 100% stock strategy.²⁹ ²⁹ Note that the investment strategy was based on CRRA=2. Thus for the other values of CRRA, the expected utility would have been even higher had the strategy been reoptimized.

As seen in Table 20, a single-target strategy produces substantially similar results as the dual-target. We expect that dual-target strategies will do better when margin costs are important, but empirically most of the benefits of temporal diversification can be achieved with a single target. The single target has the added benefit of simplicity and so, the remainder of the paper will focus on the single-target strategy.

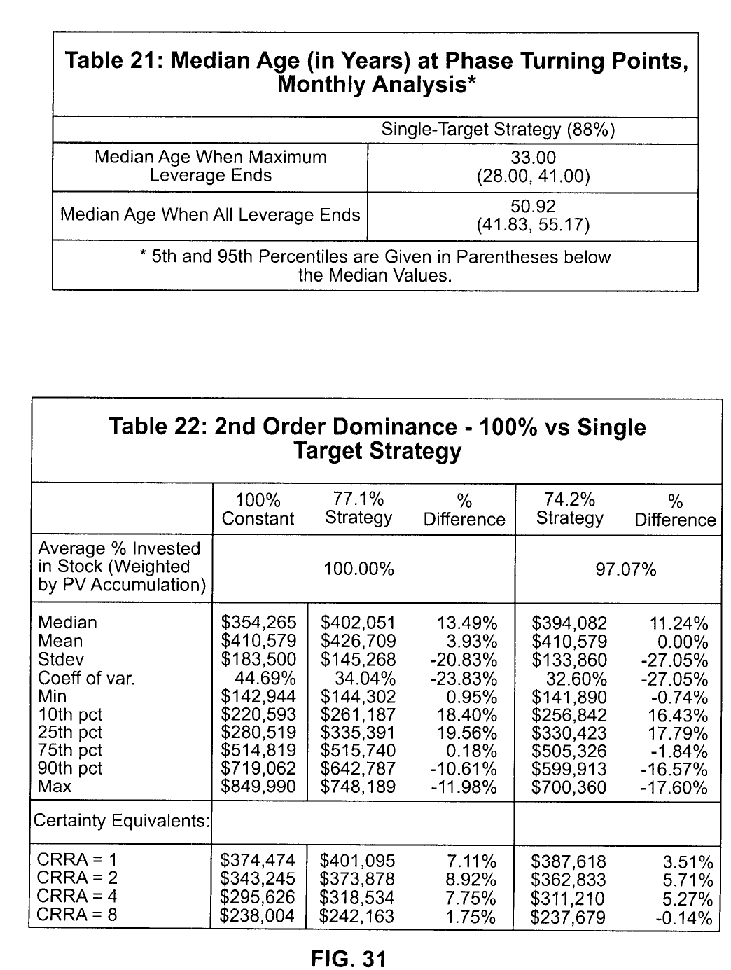

Table 21 (FIG. 31) shows the median length of the different phases. For the single-target (88%) strategy, the investor in the median cohort is maximally leveraged until age 32 and continues to have some degree of leverage until age 51.

Advantages of the single-target strategy are clear. The single-target strategy stochastically dominates the return of both conventional investment strategies.

One concern is that the stochastic dominance of the single target strategy comes from its higher overall exposure to the stock market and not from any diversification advantage. From Table 20, we know that the average percent invested in the stock market (weighted by the present value invested in the market each year) is higher for the 88% strategy than for either of the traditional strategies. Table 22 (FIG. 31) shows that a less aggressive but still leveraged strategy that has the same average exposure to stock will substantially reduce risk. A 77.1% leveraged strategy (which starts at 2:1 leverage and ramps down to 77.1% invested in stock) on average invests the same percent in the stock market as the 100% strategy. Table 22 shows that the 77.1% leveraged strategy is substantially less risky. The minimum and 10^{th} percentile cohort returns increase by 1 and 18 percent respectively relative to the traditional 100% strategy, while the maximum and 9& percentile returns fall by 12 and 11 percent respectively. However, the means were not quite the same due to the timing of historical returns. Thus we further adjusted the leveraged strategy to a target of 74.2% to achieve equal mean returns. Here the minimum was almost the same (just 0.7% lower), the 10^{th}, and 25^{th} percentile results were increased by more than 16%, while the 75^{th}, 90^{th}, and maximum returns were all lower. By spreading investments more evenly over time, we see that a leveraged strategy can (approximately) generate a mean-preserving reduction in spread, or what is known as second-order stochastic dominance.

PRVW (2005b) showed that life-cycle strategies were largely equivalent to investing a constant fraction of current savings in the stock market. But the results from Table 22 show that a single-target strategy that starts with leverage can do a better job of diversifying over time than investing a constant fraction of savings in equities. To get a sense of the magnitude of the reduced risk, the 74.2% target strategy preserves the mean return and reduces the standard deviation by more than 25%.

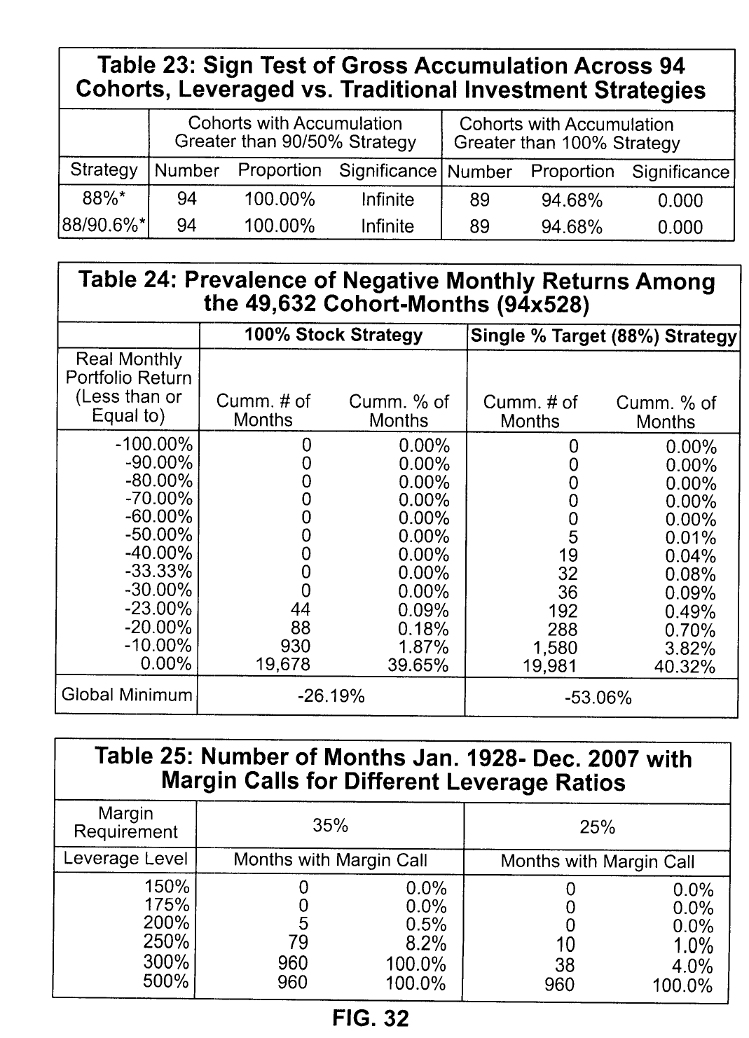

To further demonstrate the reduction in risk, we conducted a paired cohort-by-cohort comparison of temporally diversified and traditional investment strategies. Table 23 (FIG. 32) shows that the single- and dual-target accumulations were higher than the 90/50 strategy in all 94 cohorts and better than the 100% stock strategy in 94.7% (89 out of 94) of the cohorts. A sign test finds these proportions to be statistically different than 50% (p≦0001).

The five cohorts where the 100% strategy beats the single-target strategy all occurred among the most recent retiring cohorts (1998-2001 and 2003). We were initially concerned that we were recommending that people consider a single-target strategy just when it was starting to fare more poorly. A closer investigation of the recent results suggests that the single-target strategy fell behind the 100% strategy because the single-target investors did not invest as aggressively in the stock market during the historic run up in the 1990s (for example, a nominal 32% increase in 1991). The 100% stock dominated the 88% single-target strategy because the latter was more conservative in the investors' later years.³⁰ The relative shortfall of the single-target strategy was not, however, an absolute shortfall. All nine cohorts in which the 100% strategy exceeded the single-target strategy are cohorts where the single-target strategy produced above-average accumulations—just not quite as high as the 100% strategy because of the ramp down in stock allocation during the last phase before retirement. ³⁰ In 2000-2003, the market declined annually 5.5, 13.1, and 20.0 percent, respectively. For investors retiring just after these years it was good not to be heavily invested.

C. Margin Calls and Wipeouts

In our monthly data the stock market has never declined sufficiently to wipe out the preexisting investments of any cohort adopting a temporally diversified (single- or dual-target) strategy. Table 24 (FIG. 32) details the prevalence of negative monthly returns for the 94 cohorts over their 528 months of investment. The worst case arose in October 1929, where the leveraged single-target strategy would have produced negative returns of 53% for young investors who were fully leveraged (2:1). Leveraged strategies expose workers to a much larger probability of incurring a substantial negative monthly return sometime during their working life. Roughly one-quarter of the cohorts (22 out of 94) would have lost more than 40% in at least one month. Table 20 shows, however, that exposure to a risk of a substantial monthly loss does not mean exposure to a risk of substantial loss to accumulated retirement savings.

Even without wipeouts, the prevalence of substantial market declines has a potentially devastating impact on strategies that incorporate leveraged stock purchases. A natural reality check is look at the results for worker cohorts who lived through the Great Depression. The real stock returns on the S&P 500 in 1929, 1930, and 1931 were −8.8%, −16.0%, and −36.5%.³¹ Workers who retired just after the crash were not severely hurt because the targeted strategy had already eliminated their leverage. For example, workers retiring in 1932 following the single-target strategy would have had just 88% of their portfolio invested in the market when the market lost more than a third of its value. Because of the success of their investments in previous years, they would still have a retirement wealth of $277,899, which is still slightly above the average result reported in Table 20 for the conventional 90/50 investment strategy. ³¹ The stock market “crash” in October 1929 had been preceded by sizable increases so that the year-end nominal loss was only 8.8%.

Individuals adopting the single-target strategy who began working just before the depression would have done even better. Those who entered the labor force in 1931 would have immediately experienced an 86.5% loss in their first investment year. But this is a large percentage of a small amount, and the target strategy responds by keeping these workers fully leveraged until they hit the target. By the time of their retirement in 1974, these workers following the single-target strategy would have accumulated $441,636 (in 2006 dollars), well above the median return for the 100% stock strategy.

The single-target strategy produced the lowest accumulations for workers retiring in 1920 ($153,512). For these workers, enduring the double-digit market declines in 1893, 1903, 1907, 1917, and 1920 was more limiting than the more severe, but compact, declines of the depression that others experienced.

These examples (and the analysis underlying Table 20) do not allow for interim margin calls that would occur if there was a substantial decline in the market. We do not believe this is an important factor on two accounts. First, the simplest and least expensive implementation of the leveraged strategy is done via use of deep-in-the-money LEAPs. With LEAPs, there are no margin calls. While the LEAP market was not available during most of our simulation period, it is available going forward. Second, even for the case where stocks are purchased on margin, we find there were at most five months in which margin calls would have led to portfolio liquidation.

Our estimation assumed that all leveraged positions were closed at the end of each month and, if the strategy ordained, releveraged up in the next month. The major stock exchanges (per NYSE Rule 431 and NASD Rule 2520) require a maintenance margin on long positions of 25%. Some brokers require an even higher maintenance margin of 30% or 35% (Fortune (2000)).

If there were no maintenance margin requirement, the stock market would have to drop 50% before the net value in a fully (2:1) leveraged portfolio was extinguished. But with a maintenance margin requirement of 25%, margin calls would force investors to start selling their positions if the market lost a third of its value.³² With 2:1 leverage, margin calls do not greatly affect our analysis. They merely force the investor to deleverage the portfolio by selling some of their stock and retiring some of their debt. Being forced to deleverage in June can reduce your returns if the market rebounds by the end of the year. But being forced to deliver can also increase your returns if the market further deteriorates. ³² Imagine that the investor buys $200 of stock using $100 of capital. Were the market to drop by 33.3%, then the portfolio would be worth $133 and the equity behind it would be $33.3 or 25%.

To analyze the impact of margin calls on retirement accumulation, we took daily S&P returns from 1928-2007 (from Global Financial Data) and calculated the number of months that would have experienced margin calls given the cumulative interim daily returns between our monthly rebalancing of the portfolio. Table 25 (FIG. 32) reports that under the stock exchange 25% margin maintenance requirement, there would be no margin calls for a 2:1 leveraged strategy—and even under the more conservative 35% broker requirement, there would be only 5 months with interim margin calls (October 1929, September 1931, March 1938, May 1940, October 1987). Of course, more leveraged strategies would produce higher numbers of margin calls.

Alternative Margin Caps

While Regulation T prohibits investing more than 200% of portfolio value in stock, absent this regulation, lenders might agree to higher degrees of leverage. Home mortgages are usually much more leveraged and secured by non-callable and less liquid security. In fact, current stock index future contracts require only about an 8% “performance bond” and thereby allow qualified individuals to invest on the order of 1,250% of their equity value. Table 26 (FIG. 33) analyzes the impact of higher margin caps on the single-target (88%) leveraged investment strategy, controlling for the impact of interim margin calls. For the period when daily stock data was available (1928-2007), we made the conservative assumption that an investor receiving a margin call would immediately convert her entire position to cash for the remainder of the month and only then reimplement the desired level of leverage. We further made the conservative assumption that the investor would sell at the lowest daily closing price for the entire month—even if the price was higher on the day the margin call would have occurred. The two left-hand columns of Table 26 report as benchmarks the accumulations from the more traditional 100% stock strategy as well as the single-target strategy for a 200% margin cap (as reported in Table 20) without correcting for margin calls.

The remaining columns of the table report the impact of margin calls on retirement accumulations for various leverage levels. Since a 25% margin maintenance requirement produces no margin calls at 200% leverage, the two 200% leverage columns are identical. But higher degrees of leverage do produce more interim margin calls. For example, a 300% cap produces 397 (out of 49,632) cohort months with margin calls. As leverage caps are increased to 250% or 300%, the single-target strategy still dominates the traditional strategies, but the mean and median accumulations increase by a smaller percentage than under the 200% leverage. For example, the mean retirement accumulation is $439,379 under the 300% cap instead of $489,850 under the 200% cap. Moreover, the certainty equivalents for the 300% cap tend to be lower than for lower caps. The CRRA=2 certainty equivalent is $377,144 for an investment strategy with a 300% cap but $413,666 for investments with a 200% cap—a reduction of 8.8%.

In this simulation, high leverage increases the minimum observed calculation even after taking account of margin calls. The minimum accumulation with a 300% cap is $156,980, while with a 200% cap it is only $153,550. These results, combined with the Table 17 estimates of the high implicit marginal interest rates associated with increased leverage suggest that it is not likely to be cost effective to temporally diversify with leverage beyond 2:1. The take-home lesson of Tables 25 and 26 is that the existence of substantial short term risk—even the risk of losing everything—does not undermine the expected gain from a disciplined, 2:1 leveraged investment strategy.

Robustness

This section considers alternative assumptions to test the robustness of the advantages of leveraged investing. We consider higher margin costs, as well as lower stock returns. We consider simulations based on foreign stock returns. We also redo our analysis using Monte Carlo simulations where investors can experience any random collection of 44 years of returns (with replacement). The consistent message is that our results are robust to a variety of assumptions. This is foreshadowed by our summary statistics in Table 18. From 1871 to 2006, the average premium on stocks over the margin rate was 4 percent—9% vs. 5%. As long as the expected return on stock exceeds the net cost of maintaining a margin position, it will be optimal to employ leverage early in life. As the premium narrows, the scale and value of leverage declines.

A. Higher Margin Rates

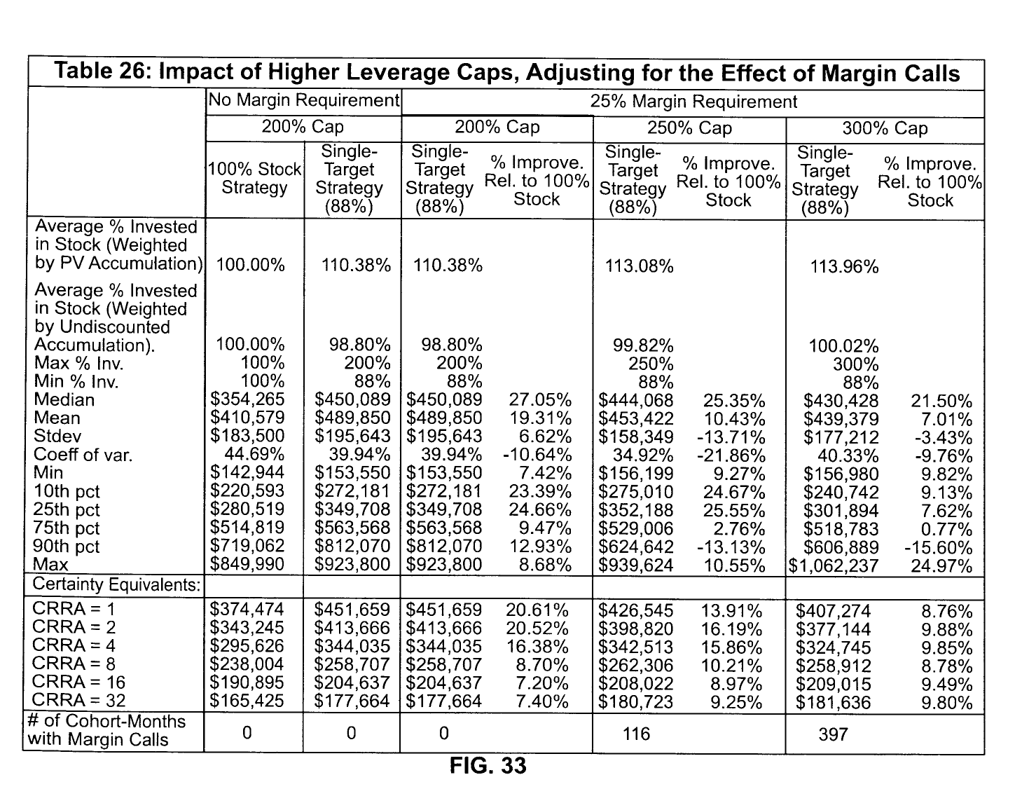

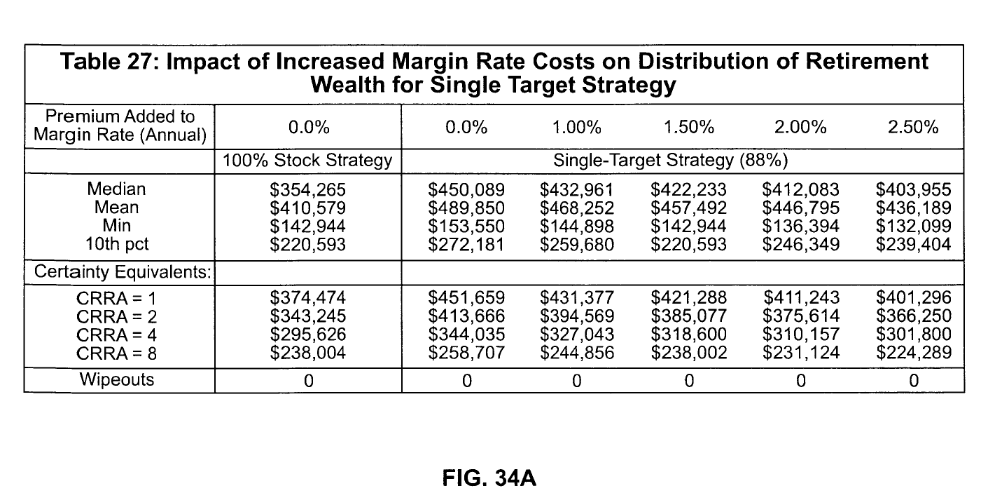

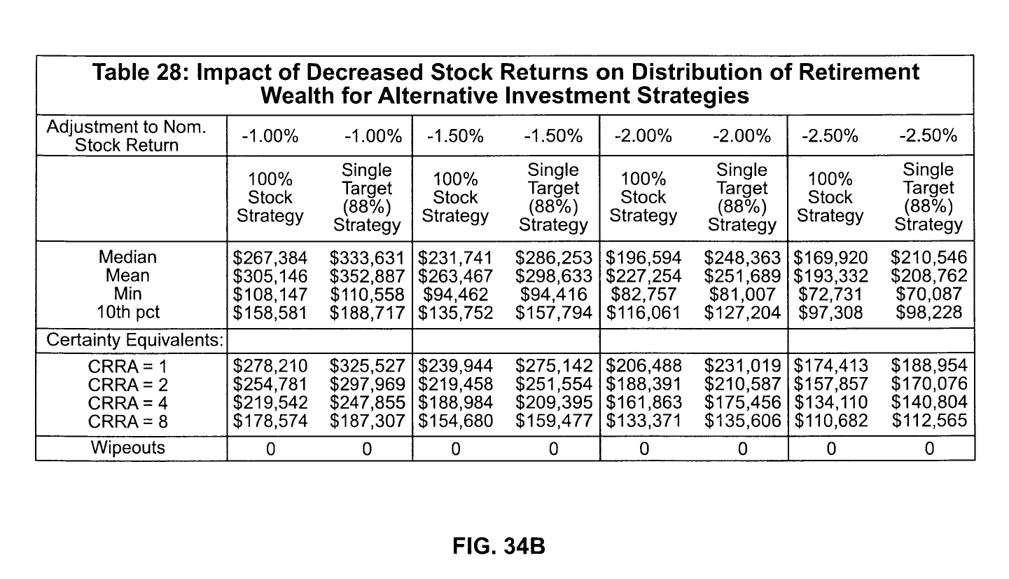

Higher margin rates narrow the equity premium when buying stock on margin and thus reduce the value of leverage. We have assumed the margin rate averaged just 20 basis point above the return on government bonds (5.0% vs. 4.8%, as shown in Table 18). Table 27 (see FIG. 34) reports the impact of increasing the historic margin rates. The two left-hand columns of Table 27 report the benchmark accumulations accruing to the 100% and single-target strategies. The next four columns report the statistics for the single-target strategy where the margin loan rate is raised by 1% to 2.5%.

Table 27 shows that the median and mean returns increase substantially even with 250 basis points added to the historic margin rates used in Table 20. The optimal percentage target is a function of both the individual's risk aversion and the expected risk of stock investment—including the risk of leveraged investments in stock. As the cost of leverage increases, the optimal percentage target for any given CRRA would decrease. But Table 27 shows that, even without adjusting down the target percentage to account for the higher cost of leverage, it is still possible to produce superior accumulations. As the margin rates increase by 200 basis points, however, the (non-optimized) 88% strategy produces no expected utility benefit relative to the unleveraged 100% stock strategy for very risk-averse investors (CRRA=8 or above).

As theory would predict, the diversification advantage of leveraged investment strategies is contingent on the cost of borrowing. Yet Table 27 shows that even an invariant leveraged strategy dominates the 100% stock strategy for margin rates up to and including 200 basis points above the bond rate. The effective cost of leveraging through stock index contracts is well below this cutoff.

B. Lower Stock Returns

Leveraged strategies will also be less attractive if the expected return on stocks is lower. Shiller (2005a) has suggested several reasons why the success of U.S. stocks in the 20th century will not be replicated in the 21^{st}. He shows that the returns on stock in other countries has been 2.2% lower than the stock returns in the U.S. Jorion and Goetzmann (1999) find an even larger shortfall. Moreover, a 2005 Wall St. Journal survey of prominent economists at Wall Street brokerages reports an expected real stock return of just 4.6%, which is 2.2% lower than the return found in the historic (1871-2007) data.

Unlike higher margin costs which just impact the expected return of leveraged strategies, the possibility of lower stock returns also impacts the expected accumulation of unleveraged investment strategies. Accordingly, Table 28 (see FIG. 34) reports the results of reducing the nominal annual stock return by various percentage points for both the 100% stock strategy and single-target strategy.

Table 28 shows that the single-target (88%) strategy produces higher means and medians even with lower stock returns. With 1.5 percentage points subtracted from stock returns, the median retirement accumulation is 23.5% higher ($286,253 vs. $231,741) and with a 2.5 percentage point reduction, the median accumulation is 23.9% higher ($210,546 vs. $169,920). The single-target strategy produces a slightly lower minimum return (3.6%) than the 100% stock strategy when 2.5% is subtracted from the annual stock returns. However, for relative risk aversions of 2, 4, and 8, the certainty equivalent for the single-target strategy is still 1.7% to 7.7% higher than that for the 100% strategy—even when 250 basis points is subtracted from the stock returns. As with increased margin rates, the optimal percentage target would decline with lower expected stock premia. But Table 28 shows that, even without re-optimizing, the advantages of the leveraged 88% investment strategy are robust to a substantial fall in the equity premium.

C. Foreign Returns

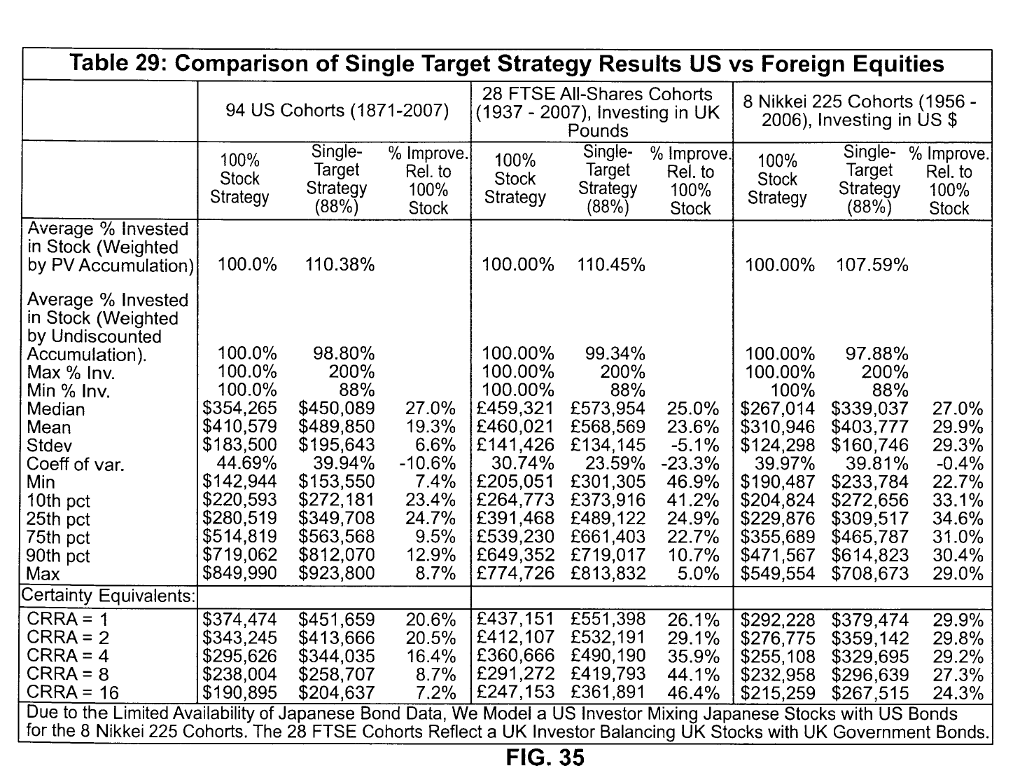

We also investigated how the single-target (88%) strategy would have fared in other parts of the world relative to the traditional 100% strategy. Table 29 (see FIG. 35) reports the results of an analogous cohort exercise using monthly returns on the FTSE (1937-2007) and Nikkei (1956-2006). For the FTSE All-Shares Index, we find that across the 28 cohorts, the single-target strategy produced mean and median returns that were 23.6 and 25.0 percent higher than the traditional 100% strategy and a minimum return that was 46.9% higher. For the Nikkei 225 Index, the advantage of the leveraged strategy was even larger—the mean return and median increase in returns were 29.9% and 27.0% respectively. Even without re-optimizing the single-target percentage for the Nikkei return distribution, we were able to produce substantially higher certainty equivalents.

D. Monte Carlo Simulations

An advantage of the cohort simulations is that they tell what actual investors might have achieved in the past if they had pursued our proposed investment strategies. But the 94 cohorts analyzed in Table 20 are clearly not independent of each other. The returns of any two adjacent cohorts massively overlap—so that our effective number of independent observations is closer to 3 [≈(2007-1871)/44]. An alternative approach to estimation pursued by PRVW (2005b) is to use the historic returns as the basis for a Monte Carlo simulation in which workers randomly draw returns with replacement from an urn of the yearly returns. We estimate the distribution of returns from 10,000 trials, each time picking 44 years at random from Shiller's annual data with replacement.³³ This approach produces returns that are independent and identically distributed—even though it is not clear that the stock returns are in fact independently distributed across time (Poterba and Summers (1988)). One thing is clear: leverage strategies no longer produce first-order stochastic dominance. The reason is that with a large enough sample, some workers will draw the 1931 return 44 years in a row. If nature draws depression many times in an investor's life, unleveraged strategies will do better. ³³ Monte Carlo with replacement subjects investors to riskier i.i.d. returns. Like the cohort analysis, the draws from Monte Carlo simulations without replacement are not i.i.d. Once an investor has drawn 1929, she never has to worry about hitting it again.

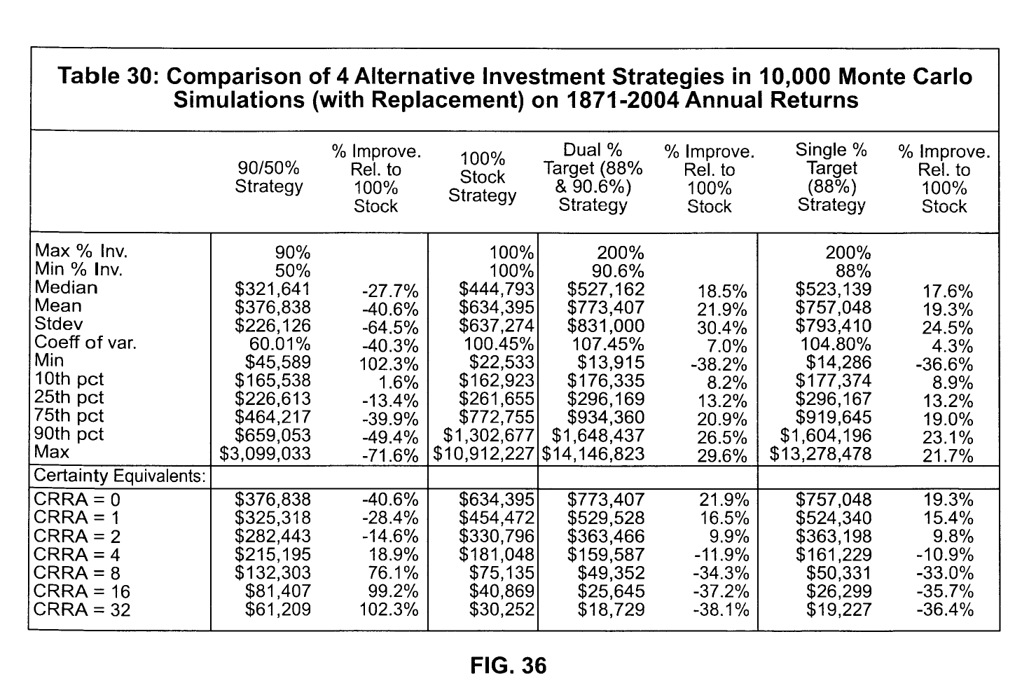

The results of the Monte Carlo simulations are reported in Table 30 (see FIG. 36). The leveraged single- and dual-target strategies continue to produce higher mean and median returns than either of the traditional investment strategies.

As predicted, the absolute minimum return was substantially lower for Monte Carlo with replacement than with the cohort analysis. For the 10,000 simulations, the minimum return came from a draw that in quick succession had three depression years: two 1930's and one 1929. Even the presence of this rare event did not cause the CRRA=2 certainty equivalents (or the 10^{th} percentile returns) for the single-target strategy to be lower than the traditional strategies.

But Table 30 also shows that the CRRA-invariant leveraged strategies do not produce uniformly higher certainty equivalents. For CRRAs equal to 4 and above, the traditional, unleveraged strategies produce higher certainty equivalents. The 88% strategy, however, was optimized for an investor CRRA equal to 2. Table 20 showed that, for the historical data, invariant percentage targets still produced higher certainty equivalents than the traditional investment strategies, even for very high levels of risk aversion. In contrast, Table 30 shows that under Monte Carlo simulation, the certainty equivalents for invariant targets can become substantially lower than the traditional strategies when risk aversion rises. Investors with higher levels of risk aversion should pursue leveraged strategies with lower targets.

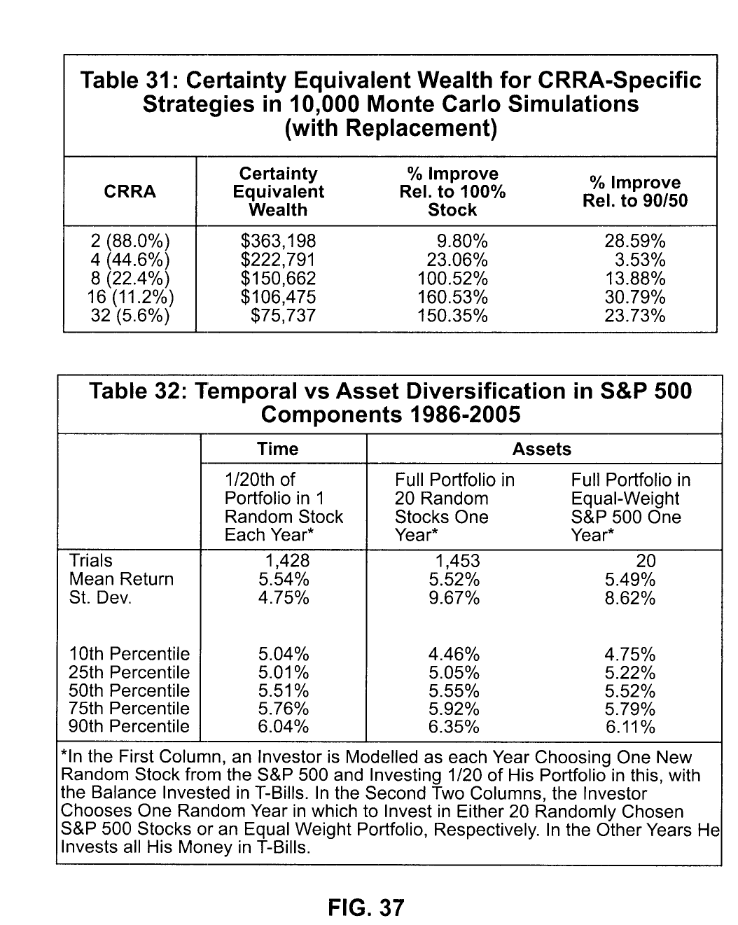

To investigate the impact of higher degrees of risk aversion, we reanalyzed the relative returns using the single percent targets (reported in Table 19) that are re-optimized for particular degrees of risk aversion. Table 31 (see FIG. 37) reports the certainty equivalents for these optimized percent targets. We see that for CRRA=2, the optimal single percent target remains at 88.0%. But, for higher levels of risk-aversion, the optimal percent target decreases. Table 31 shows that using CRRA-specific targets once again produces certainty equivalents that substantially exceed those of both the traditional 90/50 and 100% strategies. In the historic data, the benefits of temporal diversification were so great that the CRRA-invariant targets were sufficient to generate gains. With Monte Carlo simulations, temporal diversification still produces benefits but CRRA-specific targets must be used.

Diversifying Across Time Versus Stocks

From a dynamic perspective, investing on margin reduces risk because it allows the investor to better diversify risk across time. Diversifying across time and across assets are the only two dimensions on which diversification is possible. Indeed, temporal diversification is more important because returns across different years tend to be less correlated than returns across different stocks within any given year. If only one type of diversification were possible, diversification across time lowers risk more than across stocks.

Table 32 (see FIG. 37) shows the comparative strength of asset and temporal diversification by comparing the distribution of returns from full asset diversification for a single random year out of 20 years to the return distribution from investing 1/20^{th} of your portfolio each year in a single stock. The mean returns are nearly identical, but the temporal diversification produces substantially less variation in returns.

### APPENDIX

Under constant relative risk aversion, a constant investment opportunity set, and a constraint on leverage, the optimal equity allocation consists of four phases:

In phase 1: λ<λ(rₘ). All liquid wealth is invested at maximum leverage.

In phase 2: λ=λ(rₘ). The investor deleverages until λ=λ(rₘ) is achieved without leverage.

In phase 3: λ(rₘ)<λ<λ(r_{f}). The investor puts all liquid wealth into equities.

In phase 4: λ=λ(r_{f}). The investor maintains the optimal Samuelson-Merton allocation.

The above can be demonstrated as follows: We allow the investor to borrow in order to buy stocks on margin. The margin coverage requirement is denoted by m.³⁴ For each dollar in stocks, the investor must put up m dollars in cash. Thus the maximum fraction of wealth that can be invested in stocks is λ/m, where λ is the unleveraged share of wealth invested in stocks. Without loss of generality, we assume that the person maximizes her ability to borrow stocks on margin. To the extent that the person doesn't want to borrow money to buy stocks on margin, the person “invests” that money back in a bond that pays the margin rate of interest, rₘ. In essence, when the person invests in bonds that pay the margin rate of interest, it is as if she is borrowing less. If the fraction of wealth invested in stocks falls below 1, then the residual is invested in government bonds paying the risk-free rate r_{f}≦rₘ. ³⁴ The coverage rate is determined by regulation and brokerage firms. It is not a choice variable. If the coverage requirement were 40% and the investor were to put 60% of her cash into stocks, that would allow her to buy stocks worth 60/40=150% of her initial cash. In practice, the initial margin coverage is larger than the maintenance coverage level and we control for this complication in our simulation.

Let z be the return on equities. The overall return to the portfolio, R, is:

$$R = \frac{λ}{m} * z - max [ \frac{λ}{m} - 1 , 0 ] * ( 1 + {r}_{m} ) + max [ 1 - \frac{λ}{m} , 0 ] * ( 1 + {r}_{f} ) . \qquad ( 1 )$$

There is a discontinuity in the relevant interest rate at λ=m. Until that point, the opportunity cost to buy additional stock is 1+r_{f}. Once λ=m, the investor is buying stock on margin and thus faces an opportunity cost of 1+r_{f}.

The single-period utility maximization problem can be solved by considering a related pair of problems. Consider first λₐ, the solution to the maximization problem where the return is:

$${R}_{a} = \frac{λ}{m} * {z}_{i} - [ \frac{λ}{m} - 1 ] * ( 1 + {r}_{m} ) \qquad ( 2 )$$

Consider next λ_{b}, the solution to the maximization problem where the return is:

$${R}_{b} = \frac{λ}{m} * z - [ 1 - \frac{λ}{m} ] * ( 1 + {r}_{f} ) \qquad ( 3 )$$

Let λ′ maximize

$$EU = \frac{E [ {R}^{1 - γ} ]}{1 - γ} .$$

Then λ′=λₐ if λₐ≧m; λ′=λ_{b} if λ_{b}≦m; λ′=m otherwise.

First note that Rₐ≧R for all λ, with equality for λ≧m. Investing with return Rₐ is at least as good as under R. Under Rₐ, it is as if the investor can invest in bonds paying the margin rate, which is at least as good as the regular bond rate. Thus, if the optimal allocation under Rₐ is λₐ≧m, then since this coincides with the return under R, λₐ must also maximize utility under R. Similarly, R_{b}≧R with equality for λ_{b}≦m. Here the investor has the ability to borrow at the bond rate. Thus if utility is maximized at λ_{b}≦m, then this is also attainable under R and so it follows that λ′=λ_{b}.

Our final case considers the result when λₐ<m and λ_{b}>m. For γ>0, differentiation of EU shows that the maximization problem is concave for both Rₐ and R_{b}. That implies expected utility is increasing in λ_{b} in R_{b} for λ≦m. Similarly, expected utility is decreasing in λₐ in Rₐ for λ≧m. Since Rₐ equals R for λ≧m and R_{b}=R for λ≦m, this tells us that the maximum expected utility under R occurs at λ′=m.

To complete the discussion, we connect the portfolio allocation to consumption and the liquidity constraint. Consumption choice is solved via backward induction and follows exactly as in Samuelson. Each period, consumption is a proportion of remaining wealth, where that proportion depends on the discount rate, the number of periods remaining, the risk aversion, and the distribution of returns. Because consumption is always proportional to wealth, with constant relative risk aversion, period i's investment returns enter the utility function multiplicatively for each subsequent consumption. Thus the optimal investment allocation is the same as for the one-period problem.

Turning to the liquidity constraint, recall that income flows are nonstochastic. In period i, the investor anticipates earning wᵢ. For example, in a two-period model, the constraint on consumption is:

(w₁−c₁)*R₁+w₂−c₂=0. (4)

The amount w₁−c₁ is the savings from the first period, which become amplified by the first-period returns. This amount, plus second period earnings determine consumption in the second and final period.

Consider how we could adjust w₁ and w₂ so as to preserve consumption and utility. Assume (hypothetically) that the investor is able to borrow or save at the risk-free rate, r_{f}. In that case, if we reduce second period earnings by 1+r_{f} and increase first-period earnings by 1, the constraint set is unaltered. In essence, all we have done is reduce the individual's bond holdings by $1. The person is free to buy one more dollar of bonds and thereby undo our deviation.

Thus if the investor is unconstrained in her ability to borrow or lend at the risk-free rate r_{f}, then if we discount all future earnings at r_{f}, the optimization problem will be unchanged. Hence we can reframe the problem as one where present wealth is current savings plus the discounted value of all future earnings, discounted at the risk-free interest rate. Define

$${W}_{t} ( r ) = {S}_{t} + {\sum }_{i = t + 1}^{T} {{w}_{i} ( 1 + r )}^{- i} , \qquad ( 5 )$$

where Sₜ is savings at time t.

The issue is that our investor can't borrow freely at the risk-free rate. To borrow requires using the margin rate. What this tells us, however, is that once the investor chooses to place some investments in government bonds paying r_{f}, then the constraint on borrowing is not binding and the adjustments do not change behavior. If it was optimal to hold some positive amount of government bonds today when income comes in the future, then reducing next year's income by (1+r_{f}) dollars and increasing present income by one dollar will just lead the investor to hold more government bonds today.

The amount the investor actually has to invest (without borrowing) is equal to her savings, Sₜ. Starting with no initial endowment, S₁=w₁−c₁ and

Sₜ₊₁=S₁*Rₜ+wₜ−cₜ (6)

Note that this is the return on the actual portfolio, not the portfolio based on having all wealth upfront. Thus if savings are $70 while wealth is $100 and the optimal allocation is 88% of wealth into equities, that would imply an actual portfolio with $88 of equities and $18 of margin debt. Note further that in this case, the $30 value of future earnings is based on the margin rate as a discount factor.

Using backward induction, we solve for the four investment phases in reverse order. We first examine the optimal investment late in life when the constraint on borrowing is irrelevant. We then work backward to determine each of the prior three phases.

Recall that R_{b} is the return when the investor can borrow (or lend) at the risk-free rate and that λ_{b} is the resulting optimal portfolio allocation. There will be some first time period for which

$$( \frac{{λ}_{b}}{m} ) * {W}_{t} ( {r}_{f} ) \leq {S}_{t}^{35} . \qquad ( 7 )$$

At this juncture, the investor has enough savings to purchase all the equities she wants using her current savings. Thus she puts

$$[ 1 - ( \frac{{λ}_{b}}{m} ) ] * {W}_{t}$$

into government bonds. Because those bonds pay the interest rate (r_{f}) at which we have discounted her future income, it is just as if she is getting the future income in each of the future periods.

This is the fourth phase. Say, for example, that

$$( \frac{{λ}_{b}}{m} ) = 70 \% .$$

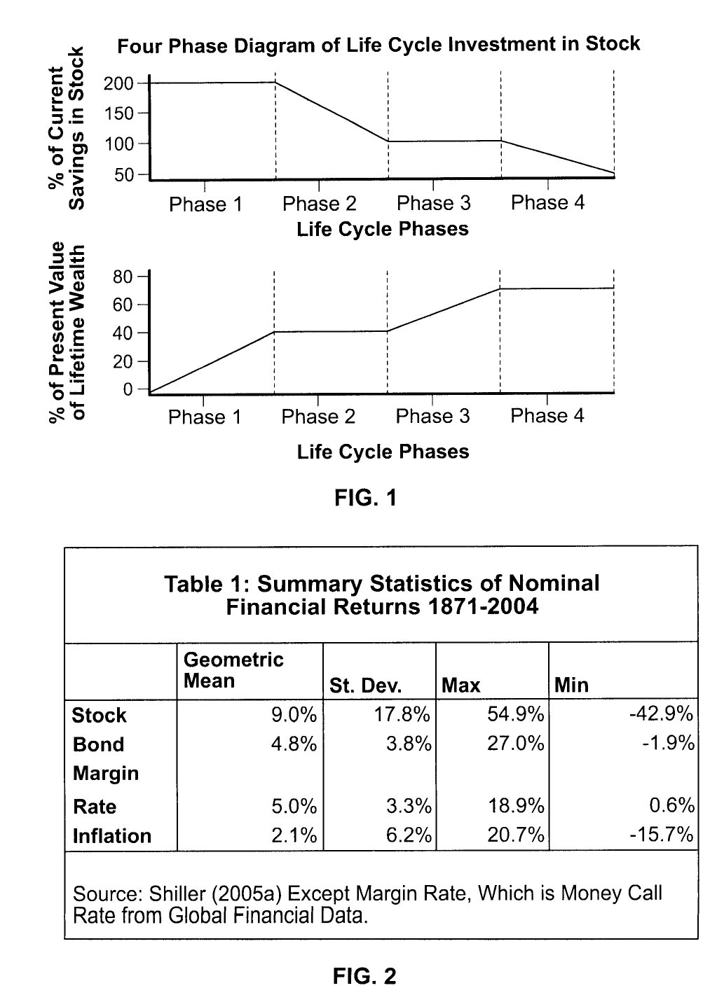

Then the investor would want to keep 70% of the present value of her (current and future) wealth in equities. Over time the present value of future wealth will eventually decline. While the share of wealth invested in equities will remain at 70%, the percent of liquid savings invested in equities will decline in this phase (as shown in FIG. 1). If there is a period in which returns are very low (Rₜ<1) then it is possible that the investor will be liquidity constrained. This naturally brings us to phase 3.

Phase 3 is defined as the period for which

$$( \frac{{λ}_{b}}{m} ) * {W}_{t} ( {r}_{f} ) > {S}_{t} \\ and \\ ( \frac{{λ}_{a}}{m} ) * {W}_{t} ( {r}_{m} ) < {S}_{t} . \qquad ( 8 )$$

Here, when the allocation between equities and bonds is done using the risk-free rate, the person wants to invest more in stocks than she has in liquid savings. Thus she would have to borrow to make this level of investment. However, when she applies the margin interest rate as the opportunity cost, then the investor would like to invest less than she has in liquid savings.

The solution is at the corner. During phase 3, the investor puts all of her liquid savings into equities. She is 100% invested in the market when it comes to her liquid assets. However, she has zero leverage. By the second inequality, her liquid savings are more than enough to cover 100% of her desired equity investment at the margin rate. She continues investing 100% of her liquid assets until they grow (or her future wealth shrinks) to the point where she now has enough liquid assets to fully invest under the Phase 4 level. Alternatively, the returns may be sufficiently poor that she is forced to return to the second phase where she is investing with leverage.

In phase 2,

$$( \frac{{λ}_{a}}{m} ) * {W}_{t} ( {r}_{m} ) \geq {S}_{t} \\ and \\ ( {λ}_{a} ) * {W}_{t} ( {r}_{m} ) < {S}_{t} . \qquad ( 9 )$$

The first inequality tells us that when the opportunity cost of borrowing is the margin rate, the investor wants to invest more than her current savings. Thus she will be borrowing on the margin. The amount she will borrow is what she needs to get her up to

$$( \frac{{λ}_{a}}{m} ) * {W}_{t} ( {r}_{m} ) .$$

We know that it is possible for her to reach this goal as the current cash needed to support the margin loans is (λₐ)*Wₜ(rₘ), which is within her liquid assets by the second inequality.

For illustration, assume that

$$( \frac{{λ}_{a}}{m} ) is 40 \% .$$

Then we can say that during this second phase, the investor is borrowing on margin with the goal of having 40% of her savings plus expected future wealth (discounted at the margin rate) invested in stocks. We discount future earning at rₘ—if the investor were to shift 1+rₘ dollars of next period income to the present, all of that extra cash would go to lowering her margin loan, leaving her with exactly the same wealth and utility.

In the first phase, the investor has so little savings that

(λₐ)*Wₜ(rₘ)≧Sₜ. (10)

Here she doesn't have enough cash to be able to invest to the point where, fully leveraged, she would achieve her optimal equity position. Since the maximization problem is concave, the optimal strategy is to invest as much as she can: she puts Sₜ into stocks.

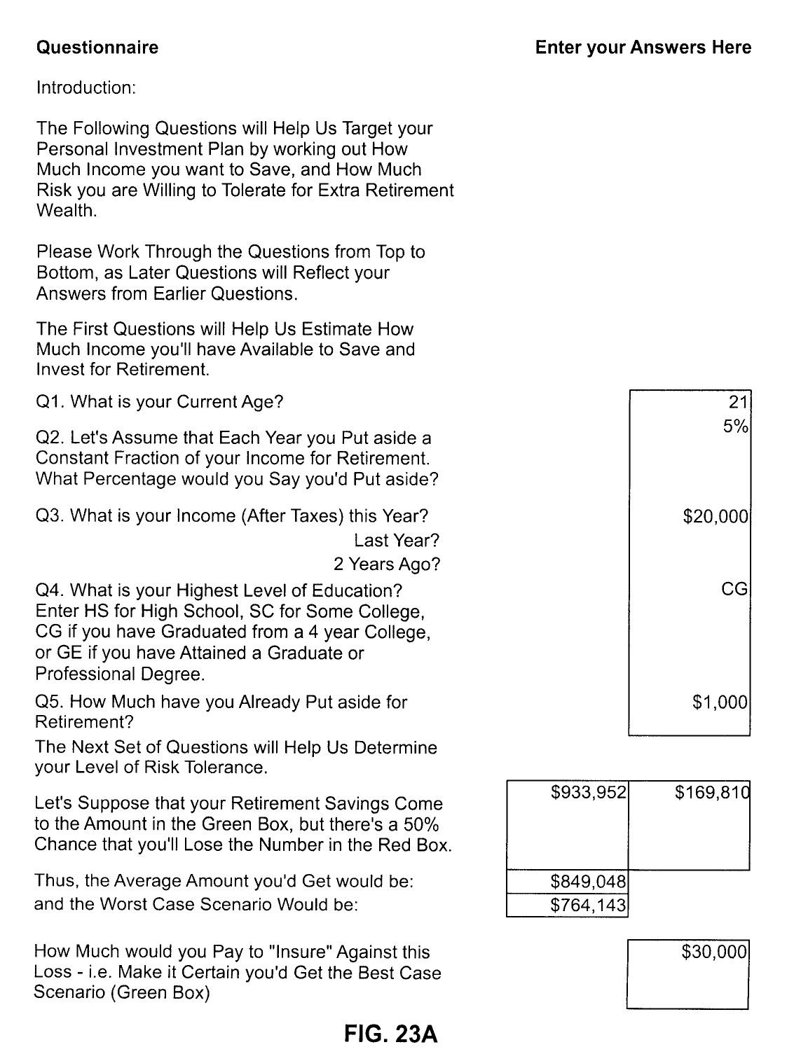

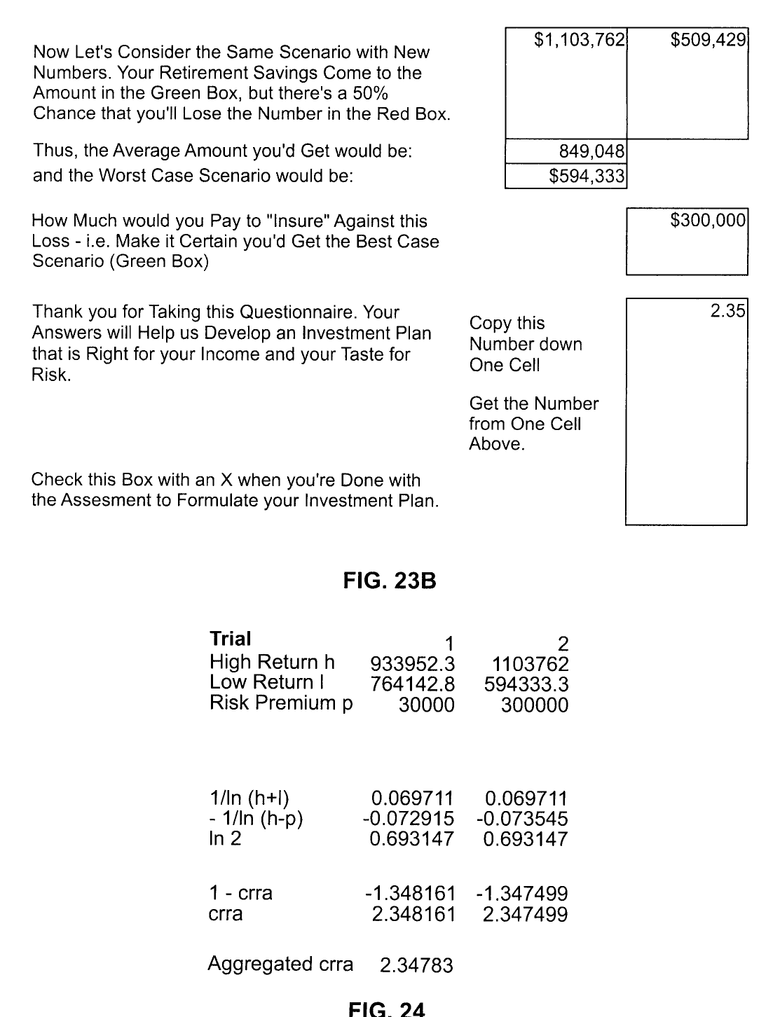

The questionnaire and spreadsheets in FIGS. 23-27 illustrate an exemplary implementation of the single target from the investment questionnaire through to predicted retirement wealth. The spreadsheets further illustrate and enable exemplary functionality of software, computer systems, and methods covered by the present invention and the appended claims.

The questionnaire “Front End” (FIG. 23) asks an investor a series of questions to help predict risk tolerance and lifetime savings contributions.

The sheet “CRRA calculation” (FIG. 24) uses the risk tolerance answers from the questionnaire to find the parameters for a utility function.

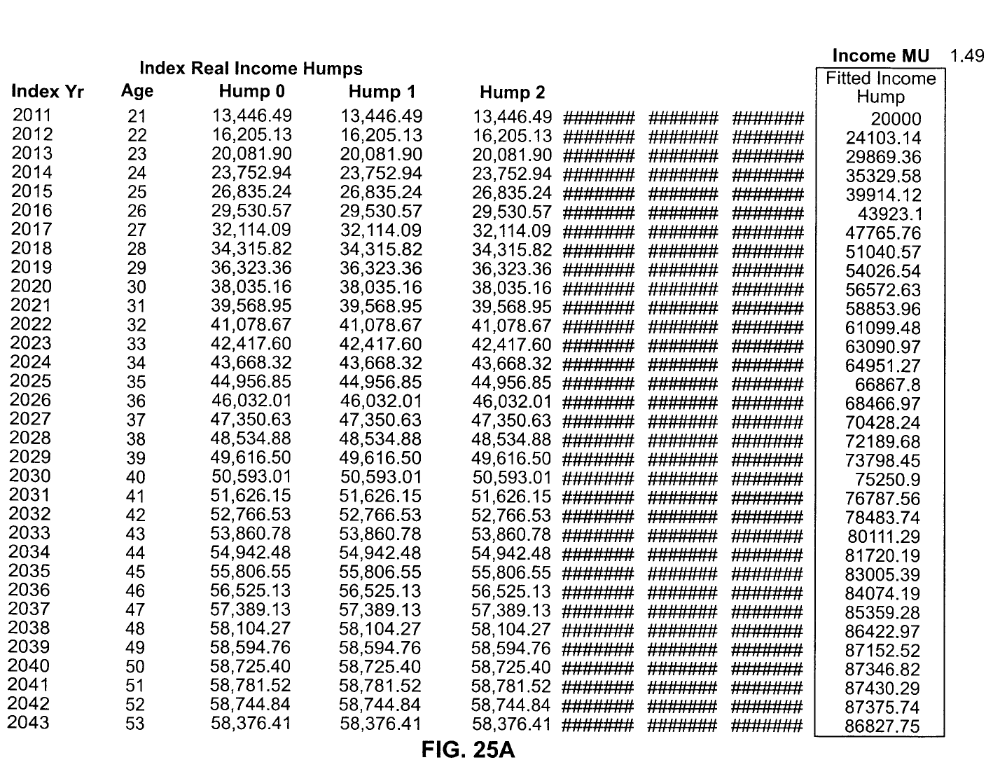

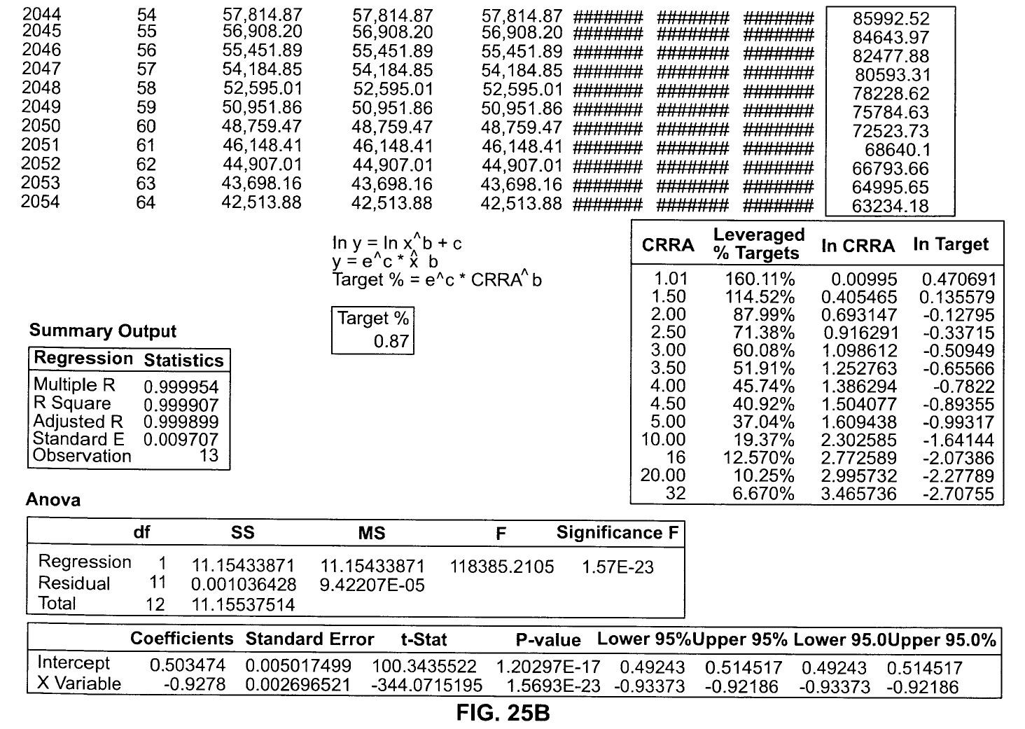

The bottom section of the sheet “Fit” (FIG. 25) uses a regression formula to calculate a percentage target based on the utility function. The top section uses the personal information from the investment questionnaire to generate a year by year predicted income.

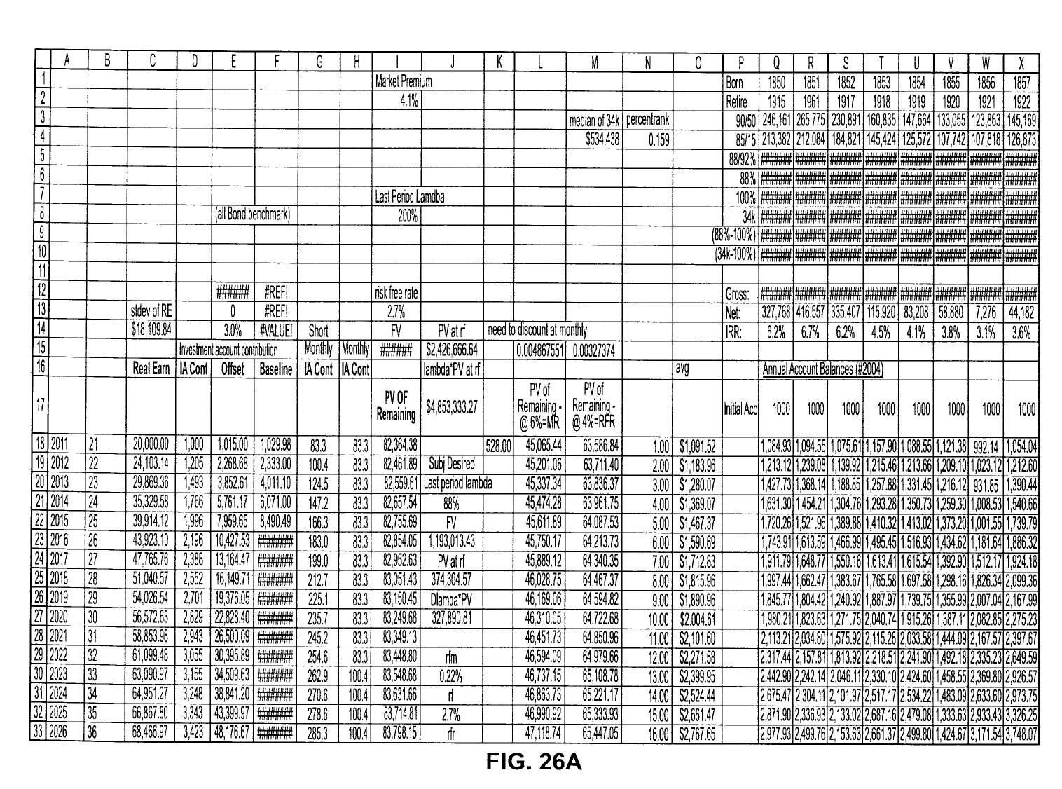

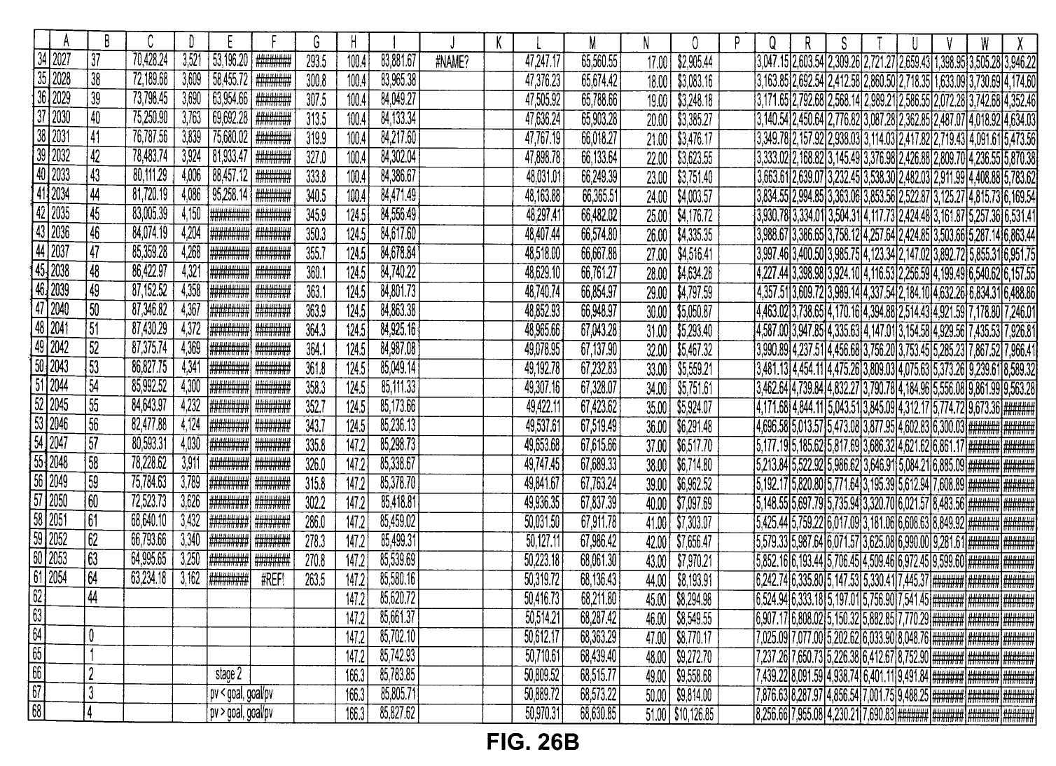

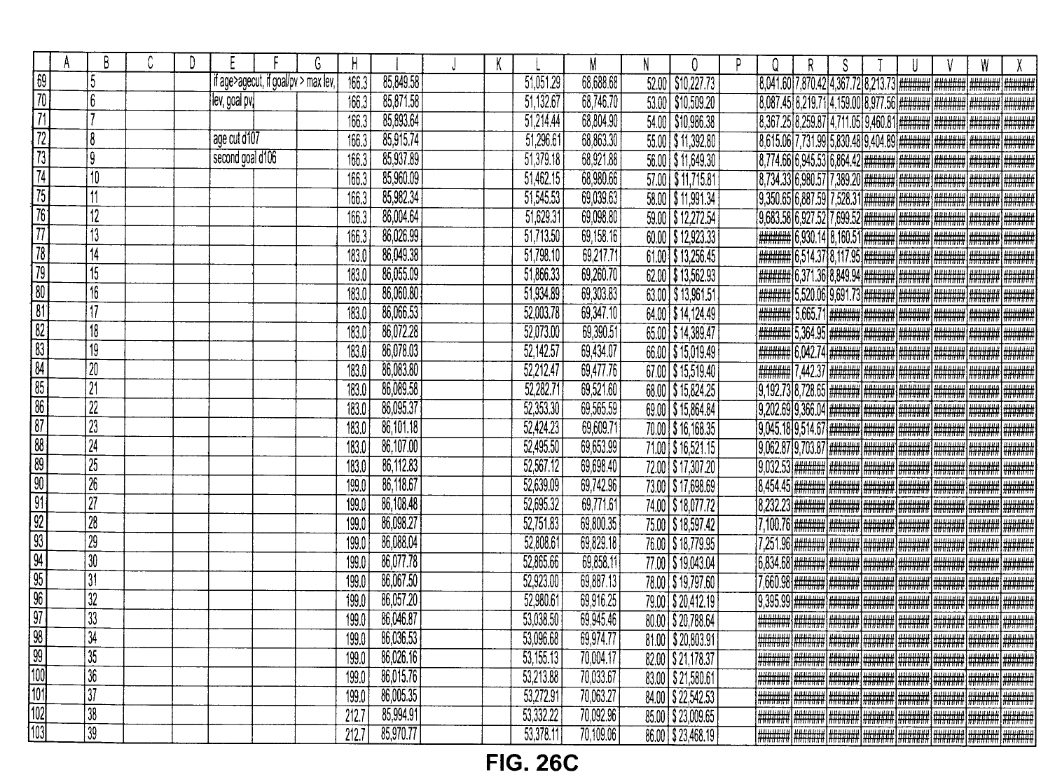

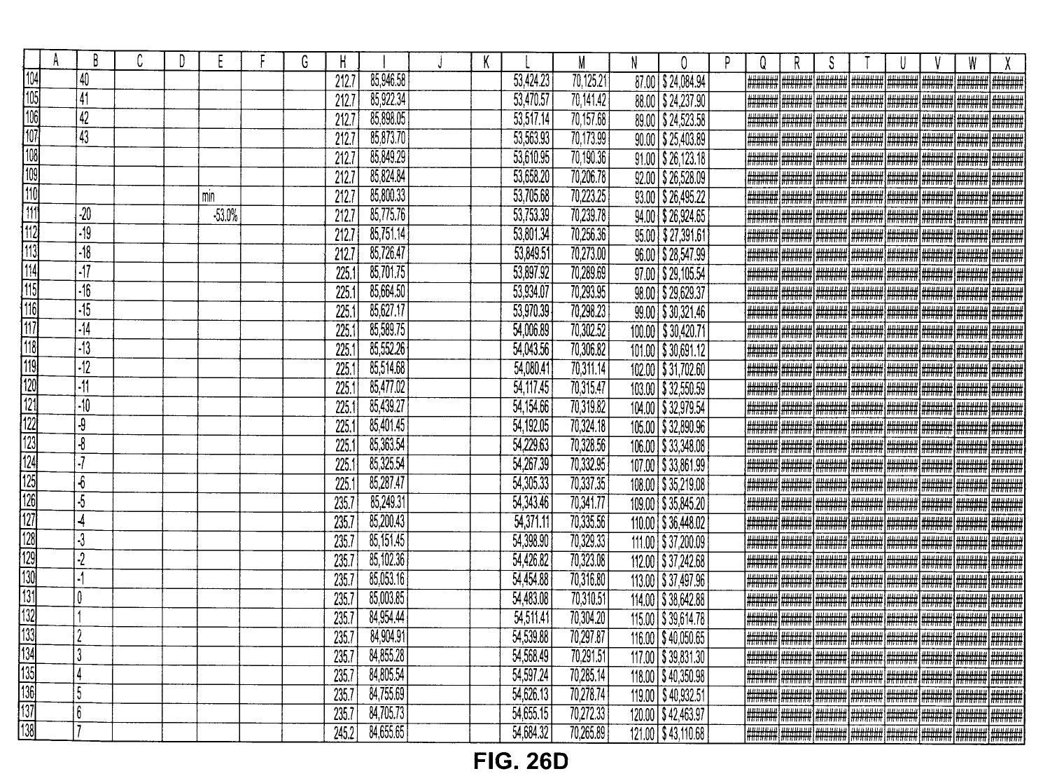

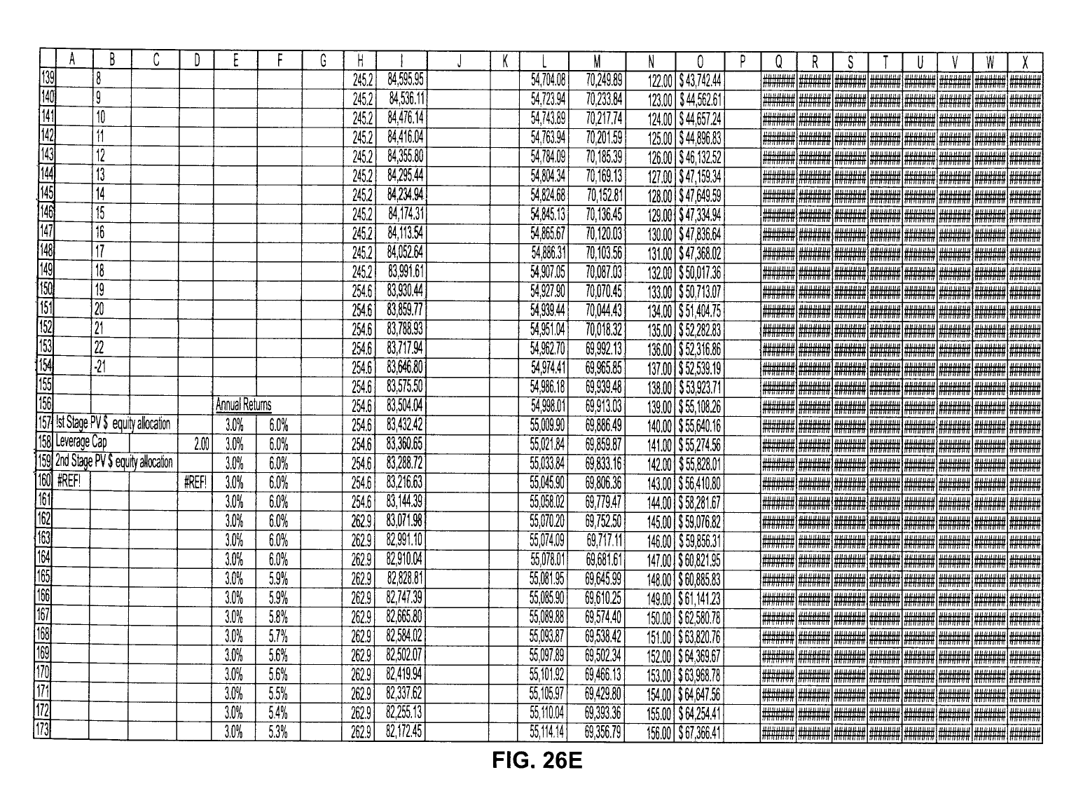

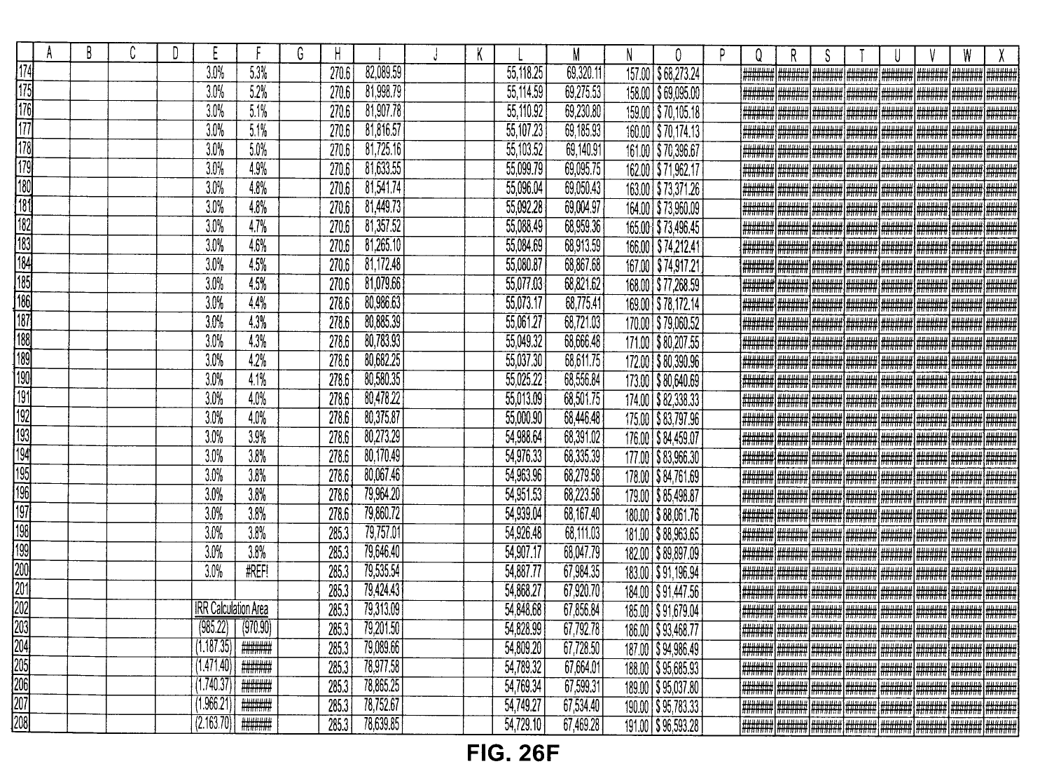

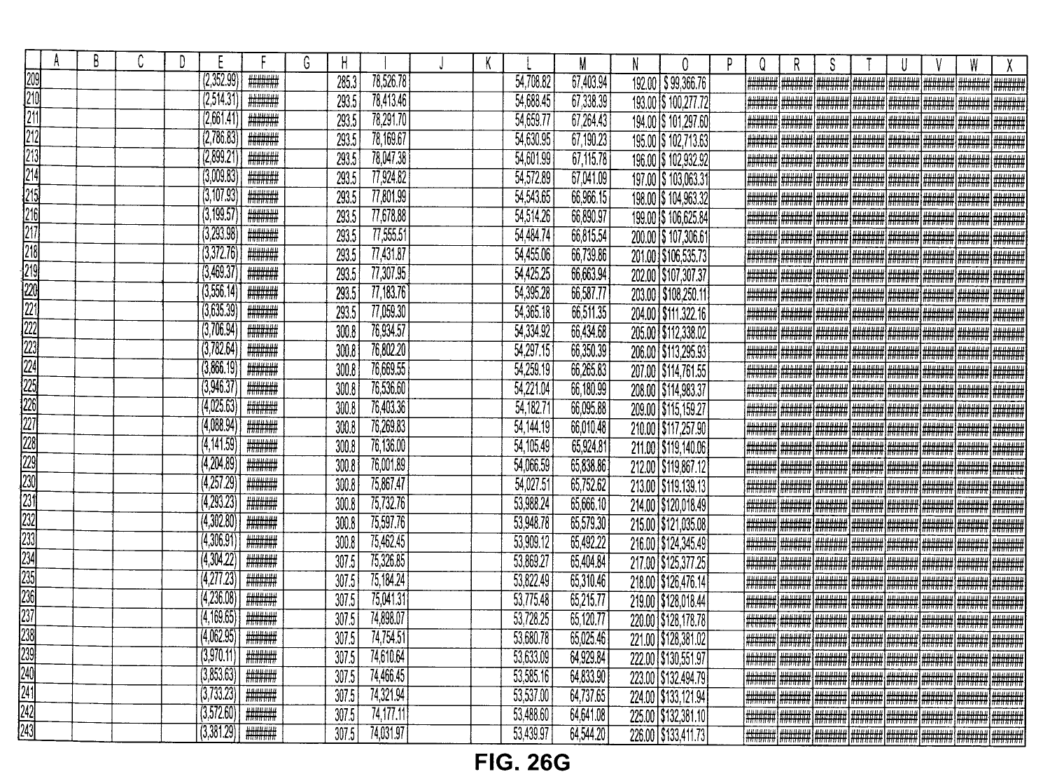

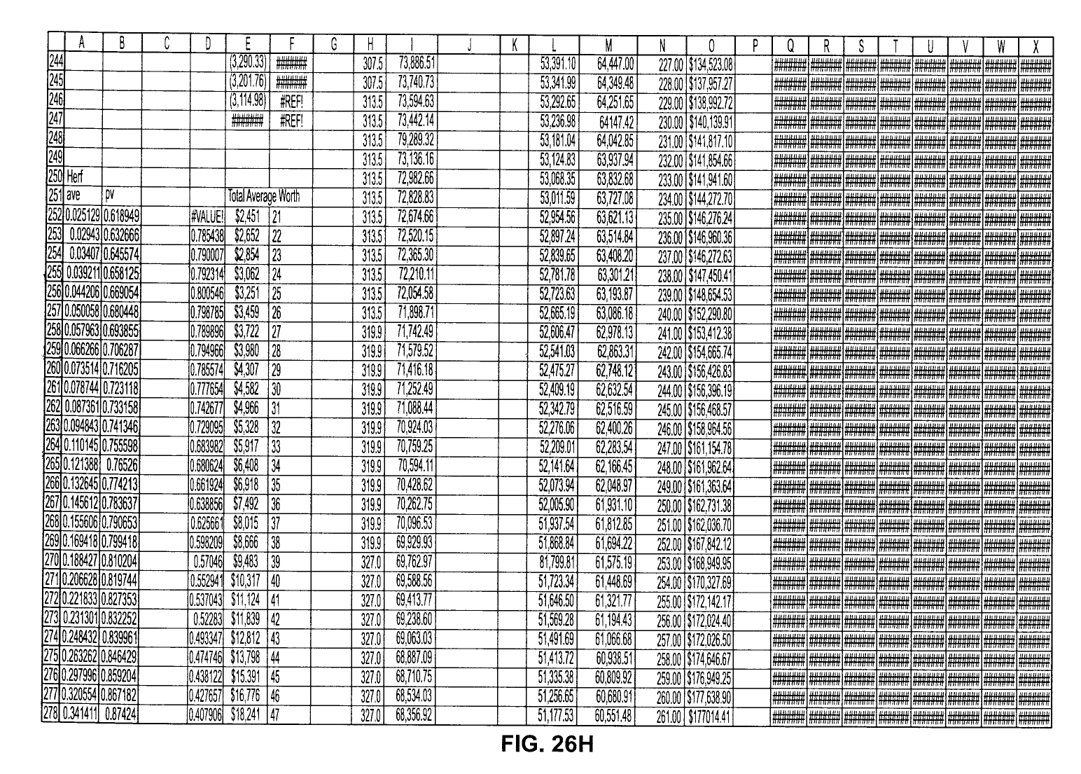

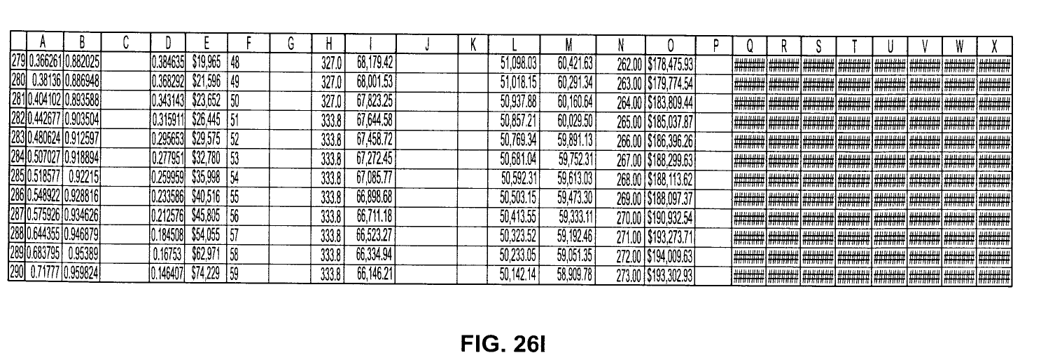

The “Work” (FIG. 26) sheet performs a simulation of this percentage target based on historical data.

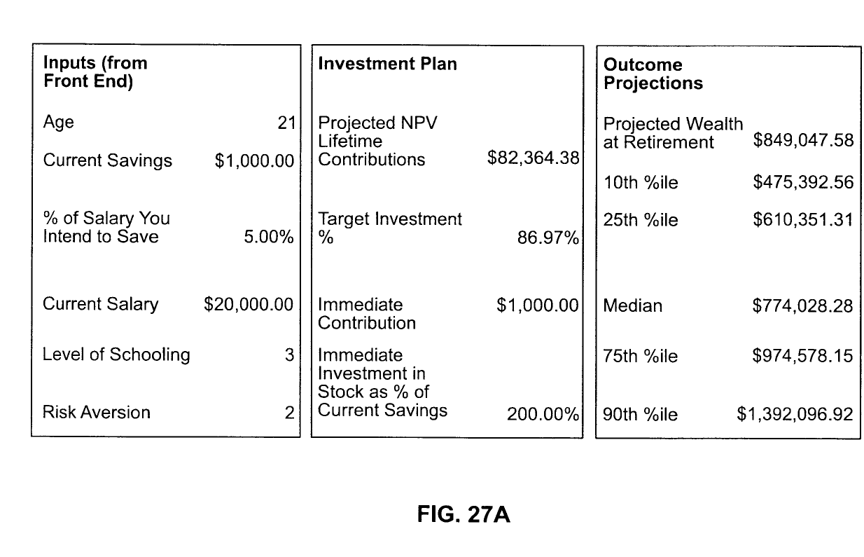

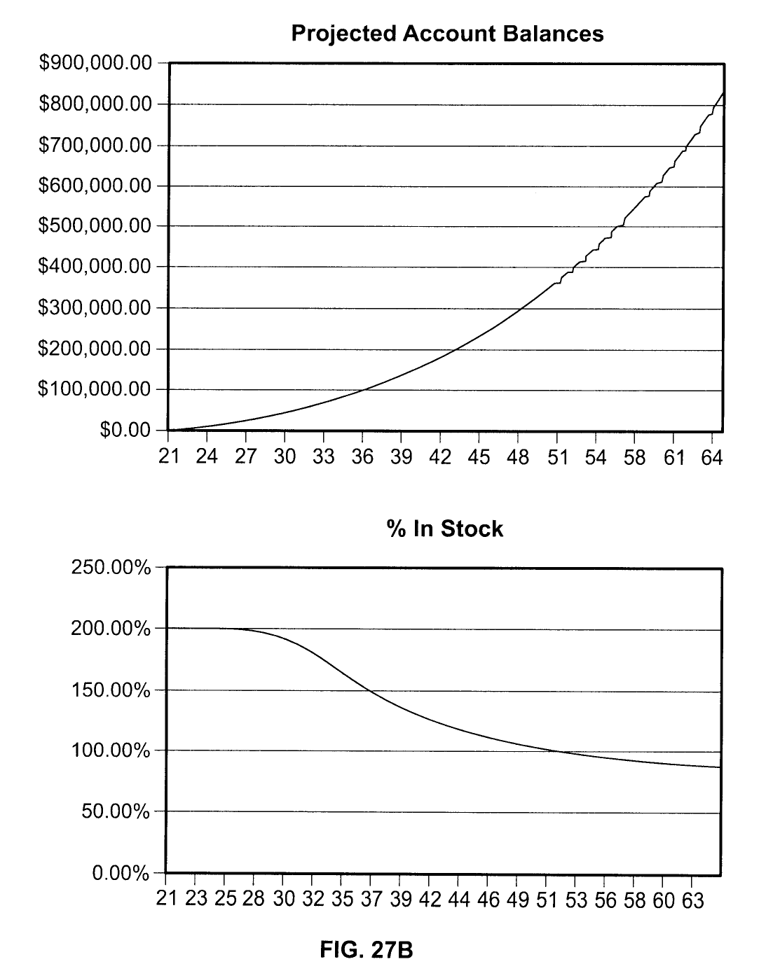

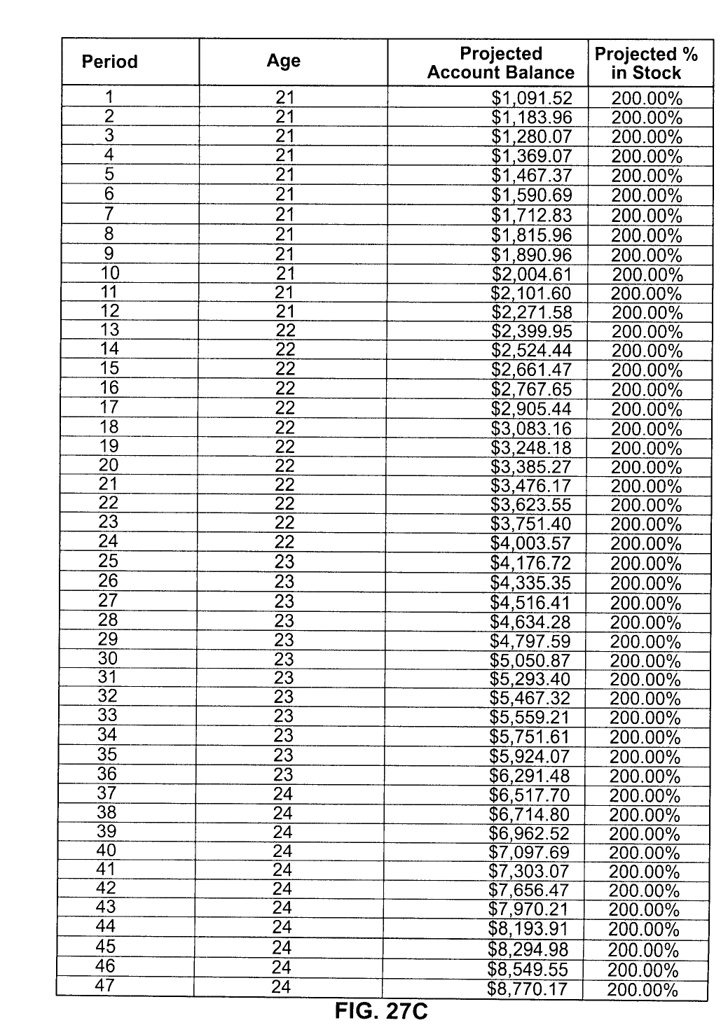

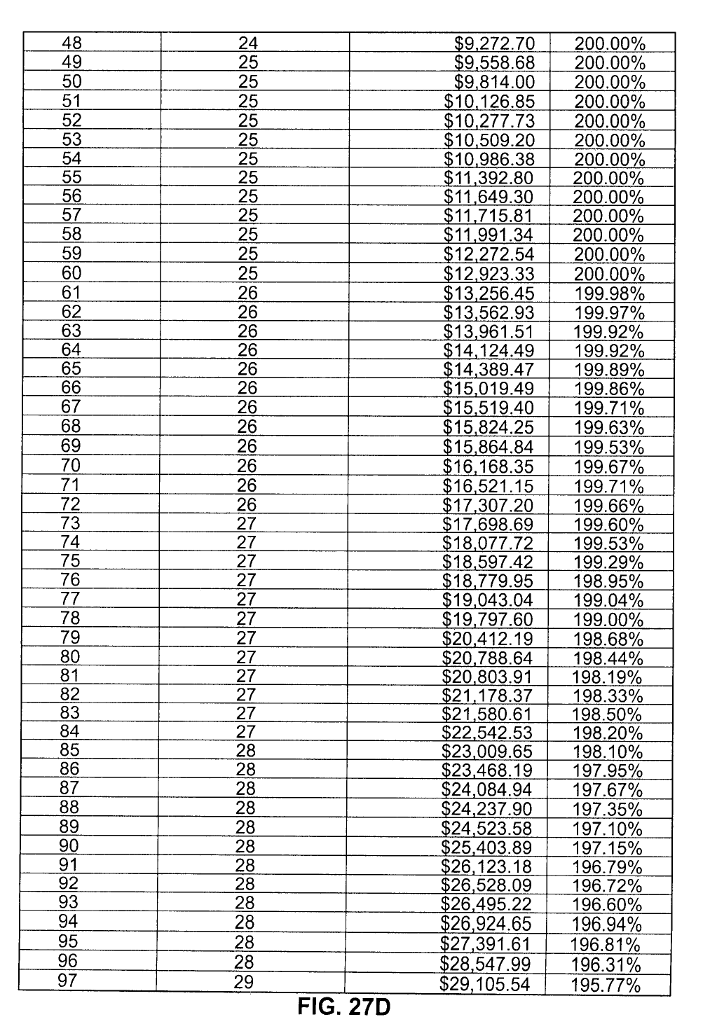

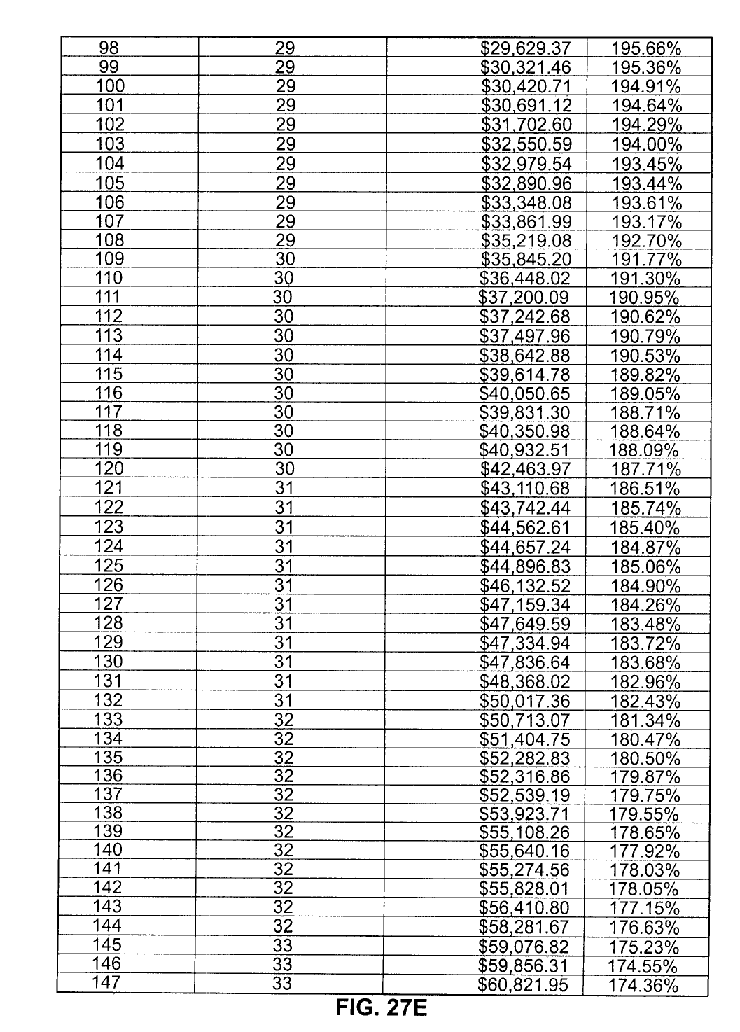

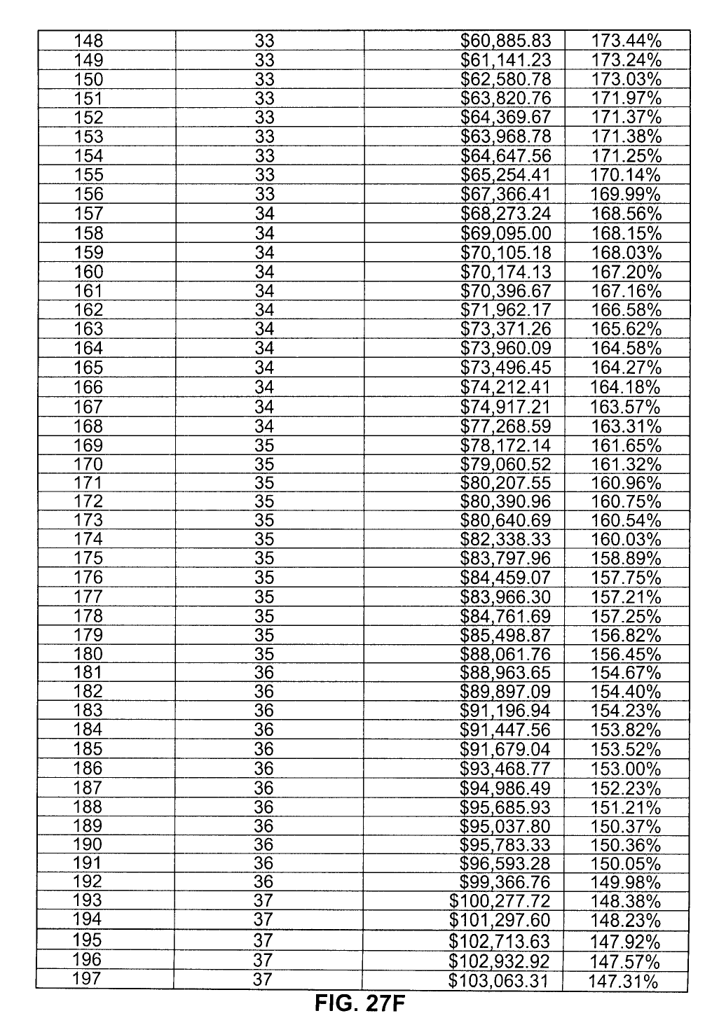

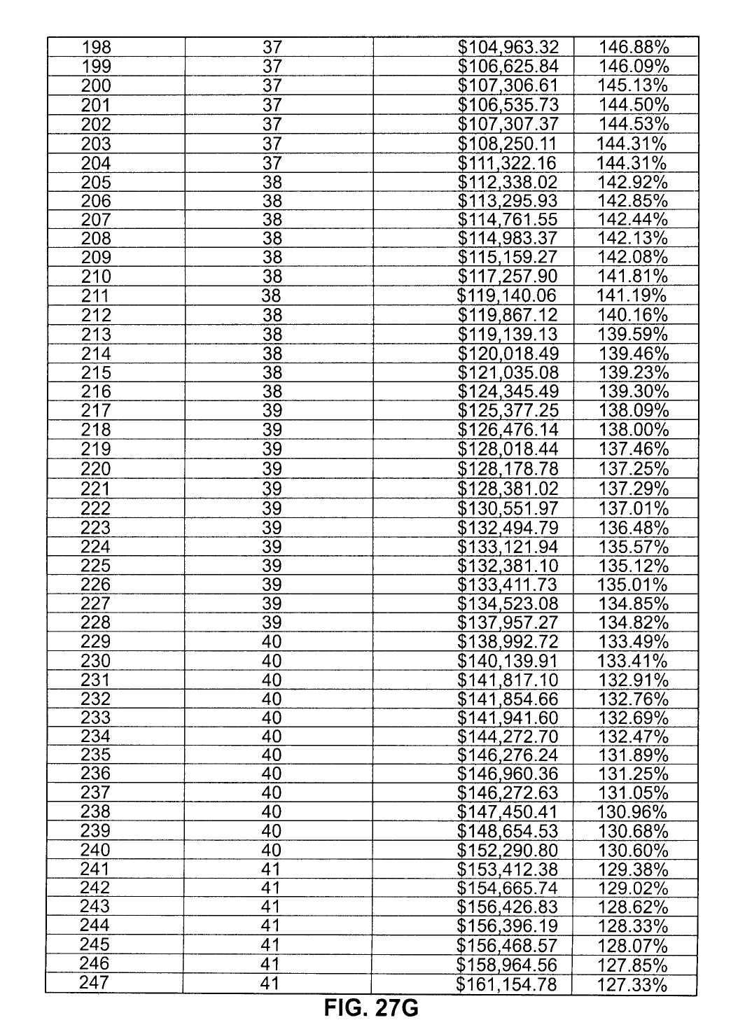

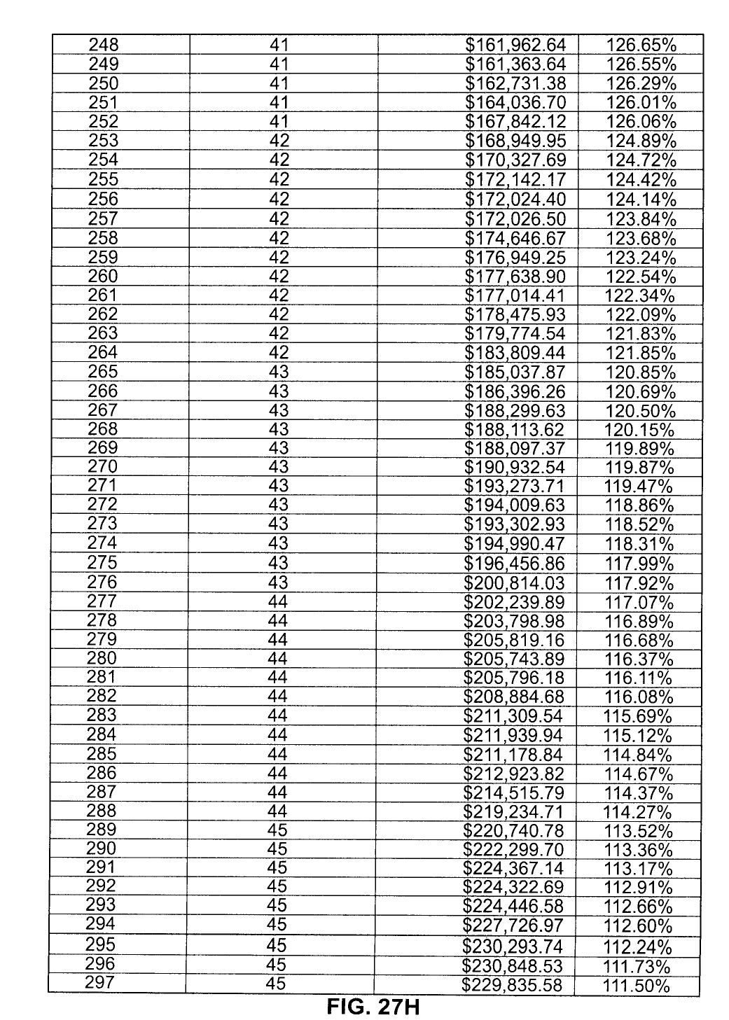

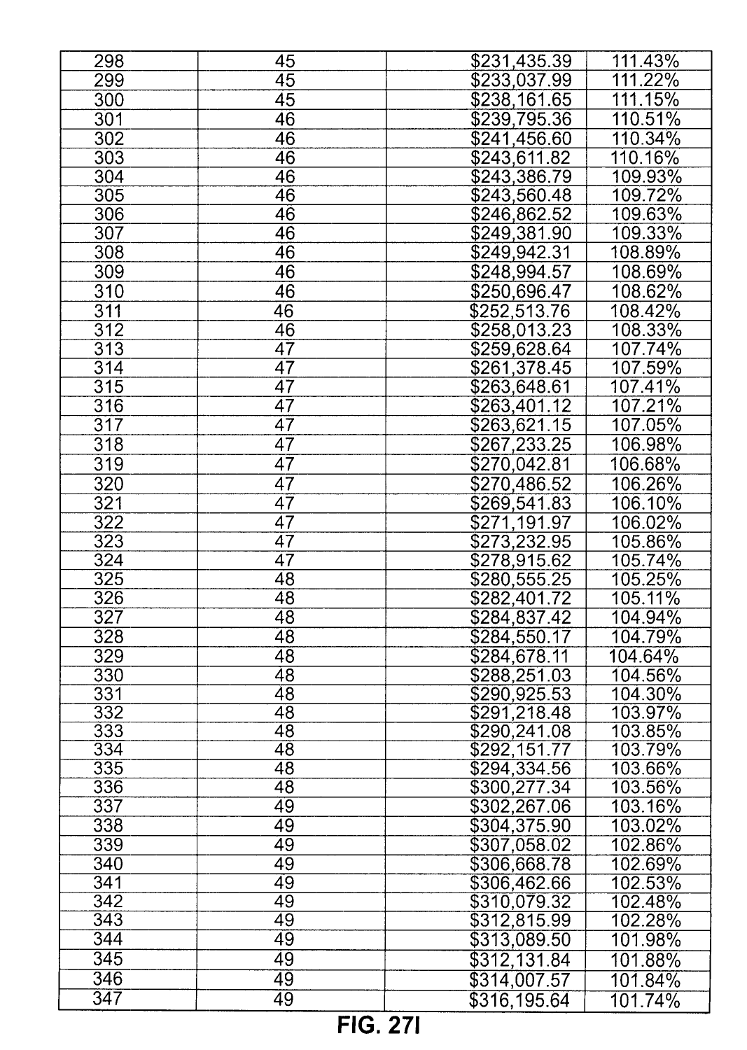

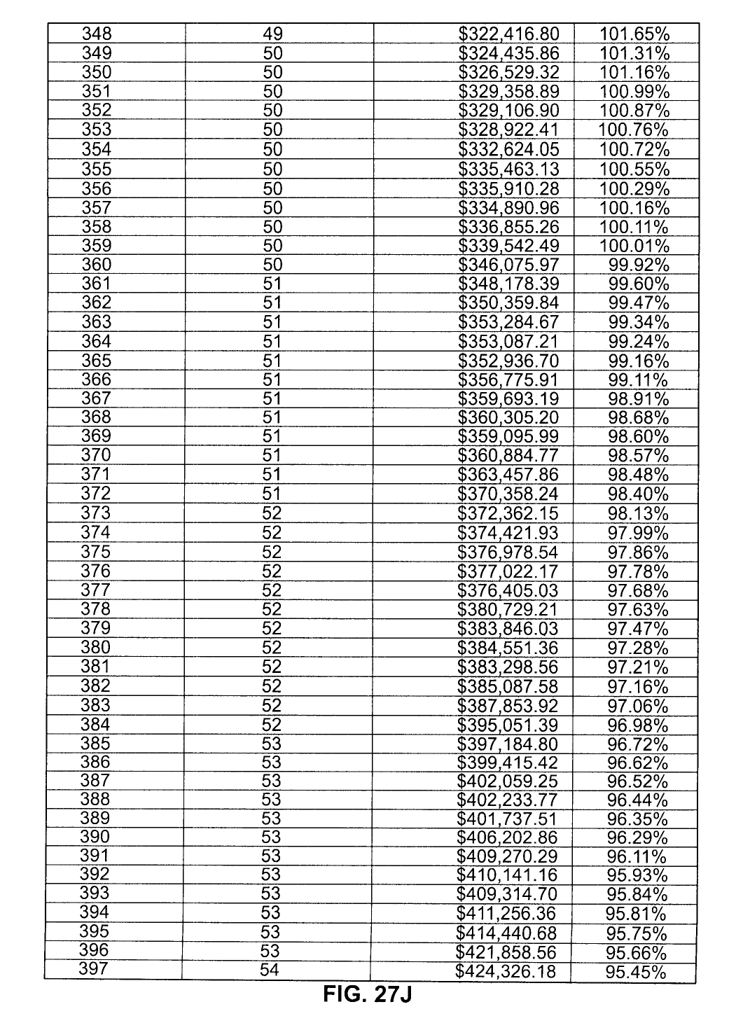

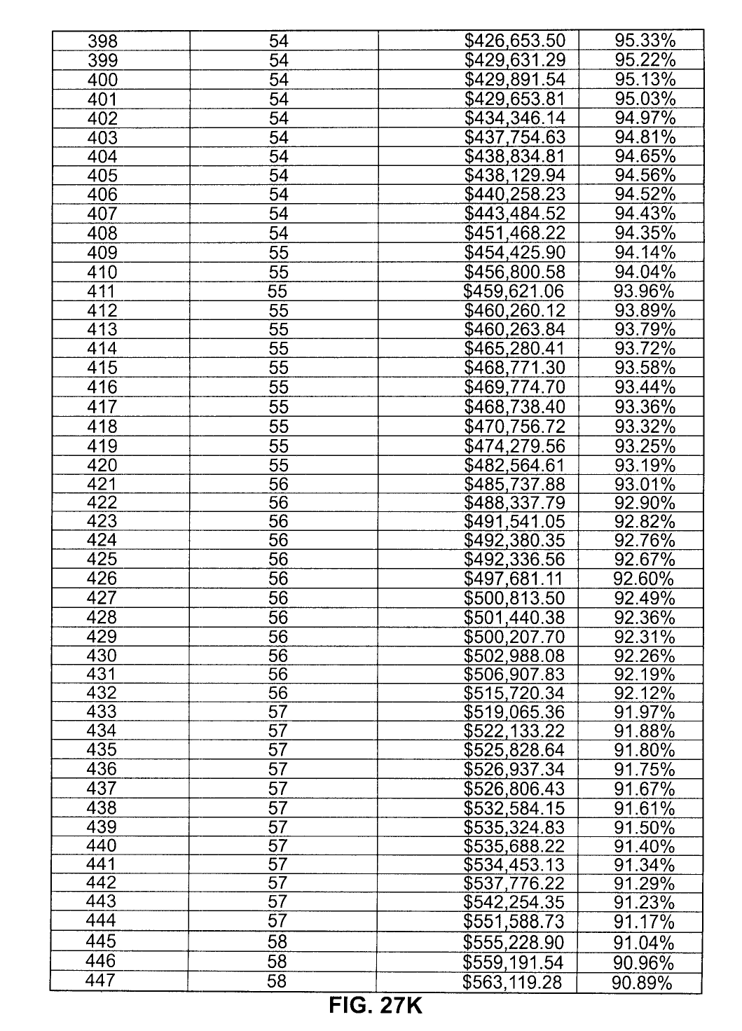

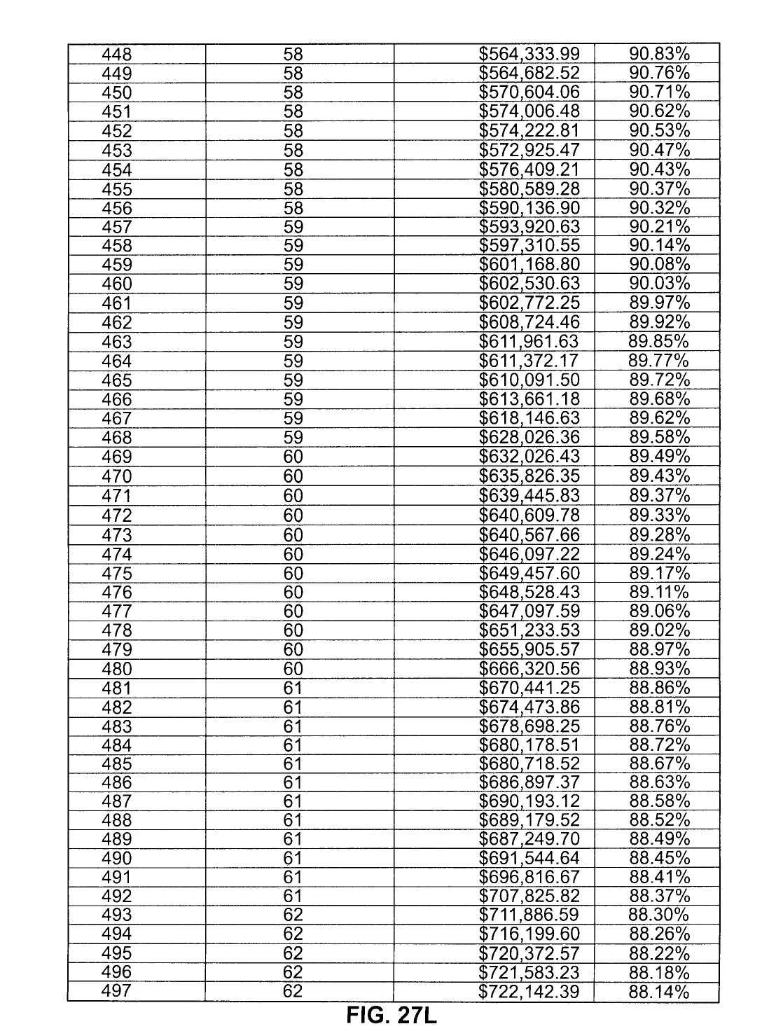

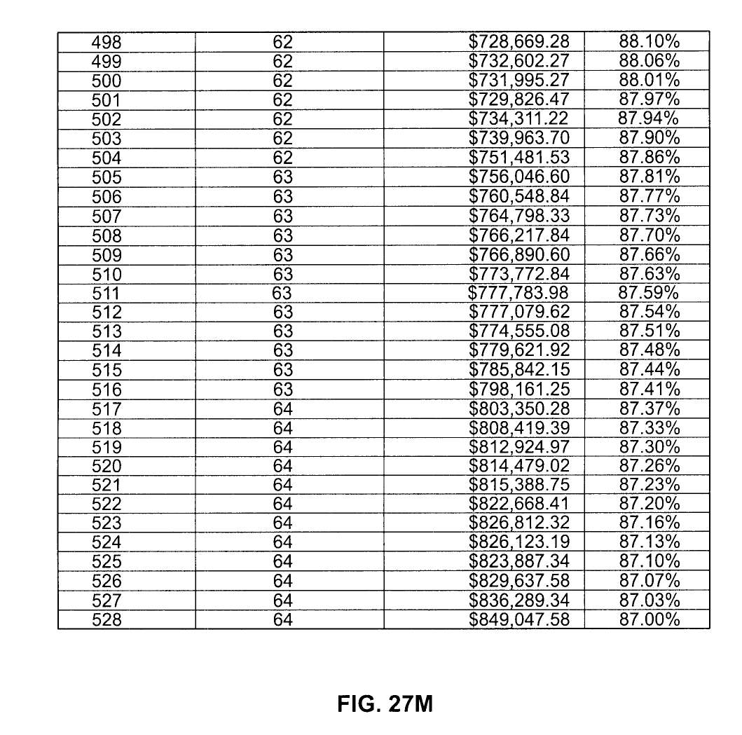

The “Summary” sheet (FIG. 27) displays predictions of investor wealth and portfolio balances based on the simulation.

### REFERENCES

Ayres, Ian. 1989. A Private Revolution: Markovits and Markets. Chicago-Kent Law Review 64, 861-75.
Ayres, Ian, and Barry Nalebuff. 2005. Mortgage Your Retirement. Forbes, November 14.
Barberis, Nicholas. 2000. Investing for the Long Run when Returns Are Predictable. Journal of Finance 55, 225-64.
Benzoni, Luca, Pierre Collin-Dufresne, and Robert S. Goldstein. 2004. Portfolio Choice over the Life-Cycle in the Presence of Trickle-Down Labor Income. Unpublished paper, University of California, Berkeley.
Bodie, Zvi, Robert C. Merton, and William F. Samuelson. 1992. Labor Supply Flexibility and Portfolio Choice in a Life-Cycle Model. Journal of Economic Dynamics and Control 16, 427-49.
Brown, Stephen J., William N. Goetzmann, and Stephen A. Ross. 1995. Survival. Journal of Finance 50(3), 853-73.
Campbell, John Y., and Luis Viceira. 2002. Strategic Asset Allocation: Portfolio Choice for Long-Term Investors. Oxford: Oxford University Press.
Clingman, Michael, and Orlo Nichols. 2004. Scaled Factors for Hypothetical Earnings under the 2004 Trustees Report Assumptions. Actuarial Note Number 2004.3 Office of the Chief Actuary, U.S. Social Security Administration, Baltimore Md.
Constantinides, George, John Donaldson, and Rajnish Mehra. 2002. “Junior Can't Borrow: A New Perspective on the Equity Premium Puzzle. Quarterly Journal of Economics 117, 269-296.
Fontaine, Thomas. 2005. Target-Date Retirement Funds: A Blueprint for Effective Portfolio Construction. AllianceBernstein.
Heaton, John, and Deborah Lucas. 1997. Market Frictions, Savings Behavior, and Portfolio Choice. Macroeconomic Dynamics 1, 76-101.
Heaton, John, and Deborah Lucas. 2000. Portfolio Choice in the Presence of Background Risk. The Economic Journal 110, 1-26.
Ibbotson Associates. 2003. Stocks, Bonds, Bills, and Inflation: 2003 Yearbook: Market Results for 1926-2002. Chicago: Ibbotson Associates.
Jorion, Philippe, and William N. Goetzmann. 1999. Global Stock Markets in the Twentieth Century, Journal of Finance 54, 953-80.
Lynch, Anthony, and Sinan Tan. 2004. Labor Income Dynamics at Business-Cycle Frequencies: Implications for Portfolio Choice. NBER Working Paper 11010.
Malkiel, Burton. 2003. A Random Walk Down Wall Street. Rev. ed. New York: W.W. Norton.
Marquez, Jessica. 2005. Lifecycle Funds Can Help Companies Mitigate Risk and Boost Employee Savings. Workforce Management, April.
Merton, Robert. 1969. Lifetime Portfolio Selection under Uncertainty: The Continuous-Time Case. Review of Economics and Statistics 51, 247-257.
Merton, Robert. 1971. Optimum Consumption and Portfolio Rules in a Continuous Time Model. Journal of Economic Theory 3, 373-413.
Office of the Press Secretary, The White House. 2005. Background Press Briefing on Social Security, February 2.
Strengthening Social Security for the 21st Century, February 2005. President's Commission to Strengthen Social Security, Strengthening Social Security and Creating Personal Wealth for All Americans, 2001.
Poterba, James. 2005. Individual Decision-Making and Risk in Defined Contribution Pension Plans. Elder Law Journal 13, 285-308.
Poterba, James, Joshua Rauh, Steven Venti, and David Wise. 2005a. Utility Evaluation of Risk in Retirement Savings Accounts. In Analyses in the Economics of Aging, ed. D. Wise, 13-58. Chicago: University of Chicago Press.
Poterba, James, Joshua Rauh, Steven Venti, and David Wise. 2005b. Lifecycle Asset Allocation Strategies and the Distribution of 401(k) Retirement Wealth. NBER Working Paper 11974.
Poterba, James, and Andrew Samwick. 2001. Household Portfolio Allocations Over the Life Cycle. In Aging Issues in the United States and Japan, ed. S. Ogura, T. Tachibanaki, and D. Wise, 65-0.103. Chicago: University of Chicago Press.
Poterba, James M., and Lawrence Summers. 1988. Mean Reversion in Stock Prices: Evidence and Implications. Journal of Financial Economics 22, 27-59.
Poterba, James, Steven Venti, and David Wise. 2000. Saver Behavior and 401(k) Retirement Wealth. American Economic Review 90, 297-302.
Samuelson, Paul A. 1969. Lifetime Portfolio Selection by Dynamic Stochastic Programming. Review of Economics and Statistics 51, 239-46. Reprinted in The Collected Scientific Papers of Paul A. Samuelson, Volume 3, ed. J. Stiglitz, 883-90. Cambridge, Mass.: MIT Press.
Shiller, Robert. 1989. Market Volatility. Cambridge Mass.: MIT Press.
Shiller, Robert. 2005a. The Life-Cycle Personal Accounts Proposal for Social Security: An Evaluation. Cowles Foundation Discussion Paper 1504.
Shiller, Robert. 2005b. American Casino: The Promise and Perils of Bush's ‘Ownership Society’. The Atlantic Monthly, March.
Shiller, Robert. 2005c. Irrational Exuberance. 2nd ed. Princeton N.J.: Princeton University Press.
Viceira, Luis. 2001. Optimal Portfolio Choice for Long-Horizon Investors with Nontradable Labor Income. Journal of Finance 56: 433-70.
Willen, Paul, and Felix Kubler. 2006. Collateralized Borrowing and Life-Cycle Portfolio Choice. NBER Working Paper 12309.

The references listed herein are provided for informational purposes only. Such listing is not intended to be an admission or concession that any of the references is prior art to the invention.

While the present invention has been illustrated and described above regarding various embodiments, it is not intended to be limited to the details shown, since various modifications and structural changes may be made without departing in any way from the spirit of the present invention.

Embodiments of the present invention comprise computer components and computer-implemented steps that will be apparent to those skilled in the art. For ease of exposition, not every step or element of the present invention is explicitly described herein as part of a computer system, but those skilled in the art will recognize that each step or element may have a corresponding computer system or software component. Such computer system and/or software components are enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably are stored in one or more electronic databases.

Note that use of the term “preferably” herein is not in any case intended to limit either the description of the invention or the claims. “Preferably” does not mean “exclusively.”

What is claimed as new and desired to be protected by letters patent is set forth in the appended claims. It should be noted that limitations directed to various separately-listed “computer components” in the claims are not intended to require the components themselves to be separate. Those skilled in the art will understand that one actual component could perform some or all of the tasks required of separately-listed components in the claims, and would nevertheless be covered by the claims.

Also, the term “person” should be understood in the legal sense, to cover more than one person (e.g., married or unmarried couple, or other family unit), and other entities (e.g., partnership, corporation, trust, or mutual fund).

We claim:

1. A computer system comprising:
a computer component that receives data identifying a person's investing goals, current savings, and risk tolerance;
a database that stores said data identifying a person's investing goals, current savings, and risk tolerance and further stores data describing margin rates, stock returns, and bond returns;
a computer component that calculates a utility function and identifies a probability distribution of returns that is most optimal for said person, based on said data identifying said person's investing goals and risk tolerance; and
a computer component that calculates one or more investment targets for said person based on application of said utility function to said data describing margin rates, stock returns, and bond returns.

2. A computer system as in claim 1, wherein said one or more investment targets comprises a percentage target that specifies a proportion of current and future discounted savings contributions that said person should strive to invest in stock.

3. A computer system as in claim 1, wherein said computer component that calculates one or more investment targets does so based on maximization of said utility function.

4. A computer system as in claim 1, wherein said computer component that calculates one or more investment targets calculates a low target and a high target.

5. A computer system as in claim 2, wherein said computer component that calculates one or more investment targets calculates a low percentage target and a high percentage target.

6. A computer system as in claim 4, wherein said high target is set equal to said low target.

7. A computer system as in claim 1, wherein at least one of said one or more investment targets is expressed as a dollar amount to be invested in stock after, before, or during a specified period of time.

8. A computer system as in claim 7, wherein said computer component that calculates one or more investment targets calculates a low dollar target and a high dollar target.

9. A computer system as in claim 1, further comprising:
a computer component that receives data identifying said person's future saving prospects; and
a computer component operable to calculate a present value of current and future savings for said person based on said data identifying said person's future saving prospects and said data identifying said person's current savings.

10. A computer system as in claim 1, wherein said one or more investment targets comprise four phases.

11. A computer system as in claim 10, wherein said four phases are as follows:
(i) a first phase wherein all liquid wealth of said person is invested at maximum leverage;
(ii) a second phase wherein said person deleverages investments from maximum leverage to no leverage;
(iii) a third phase wherein all liquid wealth of said person is invested in equities; and
(iv) a fourth phase wherein said person maintains investments at an optimal allocation based on said person's wealth and the available risk-free rate of return.

12. A computer system as in claim 1, wherein said utility function is proportional to
$$\frac{E [ {R}^{1 - γ} ]}{1 - γ} ,$$
where R is resulting blended return and γ is relative risk aversion of said person.

13. A computer system as in claim 1, wherein at least one of said one or more investment targets is calculated based on minimizing risk while holding expected return constant.

14. A computer system as in claim 1, wherein at least one of said one or more investment targets is calculated based on maximizing certainty equivalent.

15. A computer system as in claim 1, wherein at least one of said one or more investment targets is calculated based on setting an initial equity percentage target at a lower percentage during periods of leveraged investment than during periods of unleveraged investment.

16. A computer system as in claim 1, wherein at least one of said one or more investment targets is calculated based on setting an equity percentage target at a constant percentage of discounted savings of said person.

17. A computer system as in claim 16, wherein at least one of said one or more investment targets is calculated based on maintaining investments on a fully leveraged basis until stock investments exceed said equity percentage target.

18. A computer system as in claim 16, wherein after said stock investments exceed said equity percentage target, said person is advised to invest on a partially leveraged or unleveraged basis.

19. A computer system as in claim 1, wherein at least one of said one or more investment targets is calculated based on a constant present value dollar amount of stock investment.

20. A computer system as in claim 2, further comprising:
a computer component that receives data identifying said person's future saving prospects; and
a computer component operable to calculate a present value of current and future savings for said person based on said data identifying said person's future saving prospects and said data identifying said person's current savings.

21. A computer system as in claim 20, further comprising a computer component that calculates a dollar amount to be invested during a specified period of time based the multiplicative product of said percentage target and said present value of current and future savings.
